(19) United States
(12) Patent Application Publication
(10) Pub. No.: US 2026/0300582 A1
(43) Pub. Date: Oct. 1, 2026

(54) System, Method, and Computer Program Product for Two-Stage Robust Optimization With Decision Dependent Uncertainty

(71) Applicant: University of Pittsburgh - Of the Commonwealth System of Higher Education, Pittsburgh, PA (US)

(72) Inventors: Bo Zeng, Allison Park, PA (US); Wei Wang, Eugene, OR (US)

(21) Appl. No.: 19/166,105

(22) PCT Filed: Mar. 28, 2024
(86) PCT No.: PCT/US24/22020

§ 371 Date: Sep. 17, 2025

Related U.S. Application Data
(60) Provisional application No. 63/492,909, filed on Mar. 29, 2023.

(51) Int. Cl. G06F 30/27; G06F 111/04; G06F 113/04

(52) U.S. Cl. CPC G06F 30/27; G06F 2111/04; G06F 2113/04

(57) ABSTRACT

Systems, methods, and computer program products are provided two-stage robust optimization (“RO”) with decision dependent uncertainty (“DDU”) for decision-making, generating a first-stage decision before providing one or more uncertain parameters, adjusting a second-stage problem according to received information comprising the one or more uncertain parameters from the first-stage decision, wherein the one or more uncertain parameters are modeled as a plurality of possible scenarios in the second-stage problem, such that the first-stage decision is optimized against the plurality of possible scenarios, and generating a feasible region for the first-stage decision and based on the one or more uncertain parameters that define a space of possible solutions for the first-stage decision.

### CROSS REFERENCE TO RELATED APPLICATION

This application claims the benefit of U.S. Provisional Application No. 63/492,909, filed on Mar. 29, 2023, the disclosure of which is hereby incorporated by reference in its entirety.

### STATEMENT REGARDING FEDERAL FUNDING

This invention was made with government support under Grant Nos. 1635472 and 1931794 awarded by the National Science Foundation. The government has certain rights in the invention.

### BACKGROUND

### 1. Field

This disclosure relates generally to optimization of complex systems under uncertainty, and more specifically, to data-driven two-stage robust optimization (“RO”) of complex systems with decision dependent uncertainty (“DDU”), for example in view of optimal resource allocation of pre-emergency planning and power grid resilience taking uncertainty into consideration.

### 2. Technical Considerations

There are many challenges associated with decision-making in complex systems with uncertainty in one or more system parameters across various disciplines. These uncertain parameters can include factors such as usage, demand, or forecasting, where data about these parameters is typically collected periodically by sensors or meters. Many real-world systems have uncertain parameters that can make decision-making difficult for existing optimization models, where limitations exist in their ability to account for these uncertain parameters.

Some of the limitations of existing optimization models that are used to address this uncertainty include RO models which use collected usage data as support information for uncertain parameters, and can result in overly conservative models, distributional RO systems that are limited to constructing distributional uncertainty sets based on moments of observed data in restrictive classes of objective functions and constraints, or stochastic optimization models that require highly accurate knowledge of the distribution of uncertain parameters, which can be difficult to obtain in large-scale systems.

In some cases, inappropriate or insufficient handling of uncertainties can result in infeasible or poor-performing decisions. To address this, various research efforts have been devoted to characterizing uncertainties, extending deterministic decision-making models, and developing efficient solution methodologies. Schemes have been widely adopted in different applications based on the decision-making context and the nature of underlying uncertainty.

Moreover, static uncertainty assumes that the distribution or uncertainty set is fixed and independent of the decision-making process. Such an approach is appropriate for random factors in the natural world or societal systems where the decision-maker has little control. Static uncertainty can be relatively easy to deal with because the decision-maker can assume a fixed distribution or uncertainty set and incorporate it into their decision-making model. However, dependent uncertainty includes some random uncertainty which relies on the decision-maker with control over the uncertain factor, and their decision-making can influence the uncertainty and increase the complexity of optimizing such decisions.

### SUMMARY

Accordingly, provided are improved systems, methods, and computer program products for two-stage robust optimization with decision dependent uncertainty.

According to non-limiting embodiments or aspects, provided is a computer-implemented method, comprising: a computer-implemented method for two-stage robust optimization (“RO”) with decision dependent uncertainty (“DDU”) decision-making, comprising: generating a first-stage decision before determining one or more uncertain parameters of the first-stage decision; adjusting a second-stage problem according to the one or more uncertain parameters, wherein the one or more uncertain parameters may be combined to represent a plurality of outcomes modeled as one or more possible scenarios in the second-stage problem, and the first-stage decision is optimized based on the one or more possible scenarios in the second-stage problem; generating a feasible region in the first-stage decision based on at least one possible scenario of the one or more possible scenarios in the second-stage problem, the feasible region forming a boundary for the first-stage decision; and providing a cutting set to narrow the feasible region of the first-stage decision to obtain an optimal solution that performs under a worst-case scenario.

In some non-limiting embodiments or aspects, a two-stage RO formulation is represented by a set of mixed integer linear programs (“MILP”), and further comprises: determining the one or more uncertain parameters associated with the first-stage decision by solving a deterministic MILP; determining a plurality of second-stage parameters by solving a set of MILPs, each MILP of the set of MILPs corresponding to at least one of the one or more possible scenarios in the second-stage problem, wherein an objective function of the two-stage RO formulation comprises a cost of the first-stage decision and a cost of a worst-case scenario from the second-stage problem; and optimizing a solution to the second-stage problem with decision-dependent uncertainty that minimizes a worst-case cost over all possible realizations of the uncertain parameters.

In some non-limiting embodiments or aspects, the computer-implemented method further includes generating one or more columns and one or more constraints for solving two-stage RO problems based on the one or more possible scenarios, each scenario of the one or more possible scenarios generated separately at runtime during optimization, comprising: combining the one or more columns at runtime by iteratively adding a plurality of new columns corresponding to a new scenario of the one or more possible scenarios of the second-stage problem; generating one or more new constraints for adding to the first-stage decision to further optimize; determining a candidate solution based on the new scenario by solving the second-stage problem to determine the candidate solution for the worst-case cost of the new scenario of the second-stage problem; determining the candidate solution violates at least one of the one or more possible scenarios; and in response to determining the candidate solution violates at least one of the one or more possible scenarios, generating new columns and constraints in the first-stage decision to improve the candidate solution.

In some non-limiting embodiments or aspects, generating the new columns and constraints may be computationally infeasible to precompute for the one or more possible scenarios, such that a solution is optimized to eliminate or reduce a use of computational resources, wherein the second-stage problem is associated with a scenario of the one or more possible scenarios.

In some non-limiting embodiments or aspects, the computer-implemented method further includes solving the two-stage RO formulation based on the column and constraint for a specific problem being addressed, a number of scenarios, or an amount of available computational resources.

In some non-limiting embodiments or aspects, the solution for the second-stage problem is associated with at least one of: a supply chain management system, a transportation planning system, or an energy system, wherein the solution to a second-stage RO problem includes a set of constraints which depend on one or more uncertainty parameters of the first-stage decision, and wherein the solution for a second-stage problem comprises a plurality of feasible regions associated with the second-stage problem that depend on a plurality of parameters associated with the first-stage decision and one or more values of the uncertain parameters, wherein combining the feasible region representing the first-stage decision with one or more feasible regions associated with the one or more possible scenarios in the second-stage problem generates a plurality of linear constraints, non-linear constraints, and an iteration that may be added to the feasible region to adjust the solution to the first-stage decision.

In some non-limiting embodiments or aspects, comprises estimating an expected value and a variability of a plurality of uncertain parameters for one or more different scenarios of the first-stage decision, and optimizing a solution to the first-stage decision that minimizes a worst-case cost over each of the possible realizations of the uncertain parameters in the second-stage problem.

In some non-limiting embodiments or aspects, characterizing the feasible region, further comprises determining which decisions are feasible or possible and which are not feasible or not possible, given one or more constraints for determining an optimal decision that minimizes a cost and satisfies the one or more constraints of the first-stage decision, wherein determining the feasible region identifies an infeasibility to be addressed in order to obtain a feasible solution.

In some non-limiting embodiments or aspects, the one or more feasible solutions for the first-stage decision satisfies the one or more constraints within a range based on feedback received, and further comprises determining a set of possible actions; and determining an optimal action of the set of possible actions to perform based on a decision-dependent uncertainty and the feedback received.

In some non-limiting embodiments or aspects, the feasible region comprises all possible solutions that satisfy the one or more constraints of the first-stage decision.

In some non-limiting embodiments or aspects, the computer-implemented method further includes identifying the feasible region; and in response to determining the feasible region is empty, determining an optimization problem is infeasible when no feasible solution exists to satisfy the one or more constraints.

In some non-limiting embodiments or aspects, the computer-implemented method further includes modifying a plurality of columns and a plurality of constraints to incorporate a dependence structure associated with the uncertain parameters; and solving a replicate of a recourse problem iteratively for each identified critical scenario, wherein a critical scenario includes one or more scenarios for which the first-stage decision changes due to a dependence of the uncertain parameters on the first-stage decision, wherein generating one or more optimality conditions parametrically provides the one or more optimality conditions as a function of a parameter.

In some non-limiting embodiments or aspects, the computer-implemented method further includes parameterizing one or more scenarios in the second-stage problem based on a finite set of parameters to construct a solution for each value of a plurality of parameters; identifying trade-offs involved in decision-making by adjusting the solution to a specific structure of the first-stage decision; and providing available data for the specific structure of the first-stage decision.

In some non-limiting embodiments or aspects, determining the solution to the first-stage decision is configured to determine a particular tolerance level of an optimal solution, comprises in response to determining an infeasible solution in the first-stage decision, adding cutting planes to one or more linear constraints associated with the first-stage decision until a feasible solution is obtained, such that the solution to the first-stage decision is further defined by the plurality of cutting planes determined during an iteration of the second-stage problem, wherein the one or more cutting planes are parametric column-and-constraint generation (“C&CG”) cuts added to the first-stage decision.

In some non-limiting embodiments or aspects, a parameter space is continuous.

In some non-limiting embodiments or aspects, after the iteration of the second-stage problem, the first-stage decision and the second-stage problem converge toward a respective optimal solution.

According to non-limiting embodiments or aspects, provided is a system, comprising: at least one processor configured to generate a first-stage decision before determining one or more uncertain parameters of the first-stage decision; adjust a second-stage problem according to the one or more uncertain parameters, wherein the one or more uncertain parameters may be combined to represent a plurality of outcomes modeled as one or more possible scenarios in the second-stage problem, and the first-stage decision is optimized based on the one or more possible scenarios in the second-stage problem; generate a feasible region in the first-stage decision based on at least one possible scenario of the one or more possible scenarios in the second-stage problem, the feasible region forming a boundary for the first-stage decision; and provide a cutting set to narrow the feasible region of the first-stage decision to obtain an optimal solution that performs under a worst case scenario.

In some non-limiting embodiments or aspects, the at least one processor is further configured to determine the one or more uncertain parameters associated with the first-stage decision by solving a deterministic mixed integer linear program (“MILP”); determine a plurality of second-stage parameters by solving a set of MILPs, each MILP of the set of MILPs corresponding to at least one of the one or more possible scenarios in the second-stage problem, wherein an objective function of the two-stage RO formulation comprises a cost of the first-stage decision and a value of the uncertain parameters of a worst-case scenario; and optimize a solution to the second-stage problem with decision-dependent uncertainty that minimizes a worst-case cost over all possible realizations of the uncertain parameters.

In some non-limiting embodiments or aspects, the at least one processor is further configured to: generate one or more columns and one or more constraints for solving two-stage RO problems based on the one or more possible scenarios, each scenario of the one or more possible scenarios generated separately at runtime during optimization, comprising: combine the one or more columns at runtime by iteratively adding a plurality of new columns corresponding to a new scenario of the one or more possible scenarios of the second-stage problem; generate one or more new constraints for adding to the first-stage decision to further optimize; determine a candidate solution based on the new scenario by solving the second-stage problem to determine the candidate solution for the worst-case cost of the new scenario of the second-stage problem; determine the candidate solution violates at least one of the one or more possible scenarios; and in response to determining the candidate solution violates at least one of the one or more possible scenarios, the at least one processor is further configured to generate new columns and constraints in the first-stage decision to improve candidate solution.

According to non-limiting embodiments or aspects, provided is a computer program product comprising at least one non-transitory computer-readable medium including one or more instructions that, when executed by at least one processor, cause at least one processor to: generate a first-stage decision before determining one or more uncertain parameters of the first-stage decision; adjust a second-stage problem according to the one or more uncertain parameters, wherein the one or more uncertain parameters may be combined to represent a plurality of outcomes modeled as one or more possible scenarios in the second-stage problem, and the first-stage decision is optimized based on the one or more possible scenarios in the second-stage problem; generate a feasible region in the first-stage decision based on at least one possible scenario of the one or more possible scenarios in the second-stage problem, the feasible region forming a boundary for the first-stage decision; and provide a cutting set to narrow the feasible region of the first-stage decision to obtain an optimal solution that performs under a worst case scenario.

Further non-limiting embodiments or aspects are set forth in the following numbered clauses:
Clause 1 A computer-implemented method, comprising: a computer-implemented method for two-stage robust optimization (“RO”) with decision dependent uncertainty (“DDU”) decision-making, comprising: generating a first-stage decision before determining one or more uncertain parameters of the first-stage decision; adjusting a second-stage problem according to the one or more uncertain parameters, wherein the one or more uncertain parameters may be combined to represent a plurality of outcomes modeled as one or more possible scenarios in the second-stage problem, and the first-stage decision is optimized based on the one or more possible scenarios in the second-stage problem; generating a feasible region in the first-stage decision based on at least one possible scenario of the one or more possible scenarios in the second-stage problem, the feasible region forming a boundary for the first-stage decision; and providing a cutting set to narrow the feasible region of the first-stage decision to obtain an optimal solution that performs under a worst-case scenario.
Clause 2: The computer-implemented method of clause 1, wherein a two-stage RO formulation is represented by a set of mixed integer linear programs (“MILP”), and further comprises: determining the one or more uncertain parameters associated with the first-stage decision by solving a deterministic MILP; determining a plurality of second-stage parameters by solving a set of MILPs, each MILP of the set of MILPs corresponding to at least one of the one or more possible scenarios in the second-stage problem, wherein an objective function of the two-stage RO formulation comprises a cost of the first-stage decision and a cost of a worst-case scenario from the second-stage problem; and optimizing a solution to the second-stage problem with decision-dependent uncertainty that minimizes a worst-case cost over all possible realizations of the uncertain parameters.
Clause 3: The computer-implemented method of clauses 1 or 2, comprising: generating one or more columns and one or more constraints for solving two-stage RO problems based on the one or more possible scenarios, each scenario of the one or more possible scenarios generated separately at runtime during optimization, comprising: combining the one or more columns at runtime by iteratively adding a plurality of new columns corresponding to a new scenario of the one or more possible scenarios of the second-stage problem; generating one or more new constraints for adding to the first-stage decision to further optimize; determining a candidate solution based on the new scenario by solving the second-stage problem to determine the candidate solution for the worst-case cost of the new scenario of the second-stage problem; determining the candidate solution violates at least one of the one or more possible scenarios; and in response to determining the candidate solution violates at least one of the one or more possible scenarios, generating new columns and constraints in the first-stage decision to improve the candidate solution.
Clause 4: The computer-implemented method of any of clauses 1-3, comprising: wherein generating the new columns and constraints may be computationally infeasible to precompute for the one or more possible scenarios, such that a solution is optimized to eliminate or reduce a use of computational resources, wherein the second-stage problem is associated with a scenario of the one or more possible scenarios.
Clause 5: The computer-implemented method of any of clauses 1-4, comprising: solving the two-stage RO formulation based on the column and constraint for a specific problem being addressed, a number of scenarios, or an amount of available computational resources.
Clause 6: The computer-implemented method of any of clauses 1-5, wherein the solution for the second-stage problem is associated with at least one of: a supply chain management system, a transportation planning system, or an energy system, wherein the solution to a second-stage RO problem includes a set of constraints which depend on one or more uncertainty parameters of the first-stage decision, and wherein the solution for a second-stage problem comprises a plurality of feasible regions associated with the second-stage problem that depend on a plurality of parameters associated with the first-stage decision and one or more values of the uncertain parameters, wherein combining the feasible region representing the first-stage decision with one or more feasible regions associated with the one or more possible scenarios in the second-stage problem generates a plurality of linear constraints, non-linear constraints, and an iteration that may be added to the feasible region to adjust the solution to the first-stage decision.
Clause 7: The computer-implemented method of any of clauses 1-6, comprising: estimating an expected value and a variability of a plurality of uncertain parameters for one or more different scenarios of the first-stage decision; and optimizing a solution to the first-stage decision that minimizes a worst-case cost over each of the possible realizations of the uncertain parameters in the second-stage problem.
Clause 8: The computer-implemented method of any of clauses 1-7, wherein characterizing the feasible region, further comprises: determining which decisions are feasible or possible and which are not feasible or not possible, given one or more constraints for determining an optimal decision that minimizes a cost and satisfies the one or more constraints of the first-stage decision, wherein determining the feasible region identifies an infeasibility to be addressed in order to obtain a feasible solution.
Clause 9: The computer-implemented method of any of clauses 1-8, wherein one or more feasible solutions for the first-stage decision satisfies the one or more constraints within a range based on feedback received, and further comprises: determining a set of possible actions; and determining an optimal action of the set of possible actions to perform based on a decision-dependent uncertainty and the feedback received.
Clause 10: The computer-implemented method of any of clauses 1-9, wherein the feasible region comprises all possible solutions that satisfy the one or more constraints of the first-stage decision.
11: The computer-implemented method of any of clauses 1-10, comprising: identifying the feasible region; and in response to determining the feasible region is empty, determining an optimization problem is infeasible when no feasible solution exists to satisfy the one or more constraints.
Clause 12: The computer-implemented method of any of clauses 1-11, comprising: modifying a plurality of columns and a plurality of constraints to incorporate a dependence structure associated with the uncertain parameters; and solving a replicate of a recourse problem iteratively for each identified critical scenario, wherein a critical scenario includes one or more scenarios for which the first-stage decision changes due to a dependence of the uncertain parameters on the first-stage decision, wherein generating one or more optimality conditions parametrically provides the one or more optimality conditions as a function of a parameter.
Clause 13: The computer-implemented method of any of clauses 1-12, comprising: parameterizing one or more scenarios in the second-stage problem based on a finite set of parameters to construct a solution for each value of a plurality of parameters; and identifying trade-offs involved in decision-making by adjusting the solution to a specific structure of the first-stage decision; and providing available data for the specific structure of the first-stage decision.
Clause 14: The computer-implemented method of any of clauses 1-13, wherein a solution to the first-stage decision is configured to determine a particular tolerance level of an optimal solution, comprises: in response to determining an infeasible solution in the first-stage decision, adding cutting planes to one or more linear constraints associated with the first-stage decision until a feasible solution is obtained, such that the solution to the first-stage decision is further defined by the plurality of cutting planes determined during an iteration of the second-stage problem, wherein the one or more cutting planes are parametric column-and-constraint generation (“C&CG”) cuts added to the first-stage decision.
Clause 15: The computer-implemented method of any of clauses 1-14, wherein a parameter space is continuous.
Clause 16: The computer-implemented method of any of clauses 1-15, wherein after the iteration of the second-stage problem, the first-stage decision and the second-stage problem converge toward a respective optimal solution.
Clause 17: A system, comprising: at least one processor configured to: generate a first-stage decision before determining one or more uncertain parameters of the first-stage decision; adjust a second-stage problem according to the one or more uncertain parameters, wherein the one or more uncertain parameters may be combined to represent a plurality of outcomes modeled as one or more possible scenarios in the second-stage problem, and the first-stage decision is optimized based on the one or more possible scenarios in the second-stage problem; generate a feasible region in the first-stage decision based on at least one possible scenario of the one or more possible scenarios in the second-stage problem, the feasible region forming a boundary for the first-stage decision; and provide a cutting set to narrow the feasible region of the first-stage decision to obtain an optimal solution that performs under a worst case scenario.
Clause 18: The system of clause 17, wherein the at least one processor is further configured to: determine the one or more uncertain parameters associated with the first-stage decision by solving a deterministic mixed integer linear program (“MILP”); determine a plurality of second-stage parameters by solving a set of MILPs, each MILP of the set of MILPs corresponding to at least one of the one or more possible scenarios in the second-stage problem, wherein an objective function of the two-stage RO formulation comprises a cost of the first-stage decision and a value of the uncertain parameters of a worst-case scenario; and optimize a solution to the second-stage problem with decision-dependent uncertainty that minimizes a worst-case cost over all possible realizations of the uncertain parameters.
Clause 19: The system of clause 17 or 18, wherein the at least one processor is further configured to: generate one or more columns and one or more constraints for solving two-stage RO problems based on the one or more possible scenarios, each scenario of the one or more possible scenarios generated separately at runtime during optimization, comprising: combine the one or more columns at runtime by iteratively adding a plurality of new columns corresponding to a new scenario of the one or more possible scenarios of the second-stage problem; generate one or more new constraints for adding to the first-stage decision to further optimize; determine a candidate solution based on the new scenario by solving the second-stage problem to determine the candidate solution for the worst-case cost of the new scenario of the second-stage problem; determine the candidate solution violates at least one of the one or more possible scenarios; and in response to determining the candidate solution violates at least one of the one or more possible scenarios, the at least one processor is further configured to generate new columns and constraints in the first-stage decision to improve candidate solution.
Clause 20: A computer program product comprising at least one non-transitory computer-readable medium including one or more instructions that, when executed by at least one processor, cause at least one processor to: generate a first-stage decision before determining one or more uncertain parameters of the first-stage decision; adjust a second-stage problem according to the one or more uncertain parameters, wherein the one or more uncertain parameters may be combined to represent a plurality of outcomes modeled as one or more possible scenarios in the second-stage problem, and the first-stage decision is optimized based on the one or more possible scenarios in the second-stage problem; generate a feasible region in the first-stage decision based on at least one possible scenario of the one or more possible scenarios in the second-stage problem, the feasible region forming a boundary for the first-stage decision; and provide a cutting set to narrow the feasible region of the first-stage decision to obtain an optimal solution that performs under a worst case scenario.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for two-stage robust optimization (“RO”) with decision dependent uncertainty (“DDU”) according to a non-limiting embodiment;

FIGS. 2A-2C are schematic diagrams of an optimal distribution network design according to some non-limiting embodiments or aspects;

FIGS. 3A and 3B are schematic diagrams of the performance difference between two-stage RO with DDU in contrast to two-stage RO with decision-independent uncertainty (“DIU”) according to a non-limiting embodiment;

FIGS. 4A and 4B are schematic diagrams of a comparison of both the computational time and the number of iterations with only hardening decisions according to some non-limiting embodiments or aspects;

FIGS. 5A and 5B are schematic diagrams of a power grid with a hardening budget to capture unsatisfied demand according to some non-limiting embodiments or aspects;

FIG. 6 is a schematic diagram of a DDU set bounded by two piece-wise linear functions according to some non-limiting embodiments or aspects;

FIG. 7 is a flow diagram for a method of two-stage RO with DDU according to a non-limiting embodiment;

FIG. 8 illustrates example components of a device used in connection with non-limiting embodiments; and

FIGS. 9A and 9B are schematic diagrams of the performance showing convergence behaviors of algorithms over iterations and time.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, satisfying a threshold may refer to a value (e.g., a score, a power consumption, etc.) being greater than the threshold, more than the threshold, higher than the threshold, greater than or equal to the threshold, less than the threshold, fewer than the threshold, lower than the threshold, less than or equal to the threshold, equal to the threshold, and/or the like.

The terms “optimal,” “optimizing,” “optimize,” “optimality,” “optimization” (as well as derivatives and other forms of those terms and linguistically related words and phrases), as used herein, are not intended to be limiting in the sense of requiring the present invention to find the best solution or to make the best decision. Although a mathematically optimal solution may in fact arrive at the best of all mathematically available possibilities, real-world embodiments of optimization routines, methods, models, and processes may work towards such a goal without ever actually achieving perfection. Accordingly, one of ordinary skill in the art having benefit of the present disclosure will appreciate that these terms, in the context of the scope of the present invention, are more general. The terms can describe working towards a solution which may be the best available solution, a preferred solution, or a solution that offers a specific benefit within a range of constraints, continually improving, refining, or searching for a high point or a maximum for an objective, processing to reduce a penalty function, and/or the like.

As used herein, the term “polyhedron” may refer to or include one or more multi-dimensional objects that can be described geometrically and programmatically by a set of vertices, edges, and faces. Polyhedra have well-defined geometric properties such as volume and surface area as used herein, for engineering fields, including geometry, topology, computer graphics, architecture, and/or the like when two-stage robust optimization may be desired. In some examples, implementation specific problems or applications may be used to model a multi-dimensional object with a regular shape, such as a cube or tetrahedron, a polyhedron, and/or the like to approximate more complex shapes or to analyze the geometry of a physical object or system.

As used herein, the term “first stage problem” may refer to the initial optimization problem that is formulated and solved as part of the two-stage optimization process. The first-stage problem involves decision variables that the decision-maker can control or adjust in the initial stage of the optimization process (e.g., continuous variables, discrete variables, etc.) depending on the problem's characteristics. The first-stage problem includes an objective function that represents the goal or objective that the decision-maker aims to achieve in the initial stage. The objective function may be minimized for a worst case scenario based on the optimization goals. Constraints (e.g., resource availability, capacity constraints, operational constraints, relevant factors, etc.) are included in the first-stage problem to represent limitations, requirements, or conditions that must be satisfied when solving the first-stage problem. In robust optimization, the first-stage problem may incorporate uncertainty by considering uncertain parameters that affect the decision-making process. Solving the first-stage problem provides a solution including values assigned or associated with decision variables. The solution to the first-stage problem represents the initial decisions made by the decision-maker to optimize the system based on the information at hand. The solution obtained from the first-stage problem may be input to the second-stage problem, such that the initial decisions determined in the first stage, guide and influence the subsequent decision-making process in the second stage. In the example of two-stage optimization, the decisions made in the first stage which may impact the structure and formulation of the second-stage problem, may include production quantity decisions (e.g., determining a quantity of each product to manufacture in each production period based on demand forecasts, production capacity, inventory levels, etc.), inventory levels decisions (e.g., determining the initial inventory levels for each product, etc.), resource allocation decisions (e.g., allocating resources including labor, equipment, raw materials to different production processes, etc.), production scheduling decisions (e.g., creating a production schedule to meet customer demand while minimizing production costs and ensuring timely delivery, etc.), capacity planning decisions (e.g., planning for capacity expansion (or contraction), based on anticipated demand fluctuations and production constraints, etc.), and supply chain coordination decisions (e.g., setting production targets to align with distribution requirements, etc.).

As used herein, the term “second-stage problem” may refer to the optimization problem that is formulated and solved based on the first-stage problem solution. The second-stage problem builds upon the decisions made in the first-stage. The second-stage problem addresses the challenge of uncertainty (e.g., variability, fluctuation, incomplete information, ambiguity, risk, human judgment, environmental factors, etc.) in the system. This uncertainty can arise from various sources such as demand fluctuations, supply chain disruptions, market conditions, or other stochastic factors. The second-stage problem represents a recourse (e.g., a corrective decision-making process, etc.) based on the outcomes of the first stage and the actual values of uncertain parameters realized in the system. The second-stage problem may adjust or refine one or more decisions made in the first stage problem to account for observed outcomes and to optimize performance under uncertainty. The second-stage problem may be formulated as an optimization problem (e.g., including a set of decision variables, objective function, constraints, etc.). The objective function may involve minimizing costs, maximizing profits, or optimizing some other performance metric. In the context of robust optimization, multiple scenarios (e.g., realizations of uncertain parameters, etc.) may be considered to populate multiple replicates of the second-stage problem (i.e., separate from a first stage problem). If they are solved, their solutions determine a system's performance under different conditions (e.g., conditions related to the different scenarios as they are solved). The solutions obtained from solving the second-stage problems may be iterations, each iteration generating a solution that may be provided to the decision-maker to influence future decisions of the first-stage in subsequent iterations of the optimization process. This iterative approach allows for the refinement and improvement of the overall solution strategy by adjusting or refining a solution based on observed outcomes and uncertainty considerations. In such an example, the solution obtained from the first-stage problem may be input to the second-stage problem, such that the initial decisions determined in the first stage, guide and influence the subsequent decision-making process in the second stage, which could involve decisions related to distribution, such as: inventory replenishment for determining how much inventory to ship from the manufacturing stage to distribution centers to meet customer demand, order fulfillment by allocating available inventory at distribution centers and determining shipment schedules, transportation planning for determining routes and modes to optimize delivery schedules and minimize transportation costs, inventory positioning for the placement of inventory across distribution centers to reduce lead times and improve service levels, demand forecasting for updating demand forecasts based on actual sales data and adjusting distribution plans accordingly, and/or the like.

As used herein, the term “decision independent uncertainty” may refer to one or more sources of uncertainty that are beyond the control and are not influenced by the decisions made by the decision makers. These uncertainties typically arise from external factors such as changes in customer demand, supply problems, fluctuations in raw material prices, disruptions in transportation networks, natural disasters, and/or the like. Decision-independent uncertainty poses challenges because decision-makers cannot directly influence or mitigate these uncertainties through their decisions. Instead, they must anticipate and adapt to uncertain conditions by designing robust and flexible strategies that can withstand unforeseen events. In contrast, “decision-dependent uncertainty” refers to uncertainties that are influenced by the decisions made. For example, the choice of transportation routes, inventory policies, or production levels may impact factors such as lead times, service levels, or production costs, introducing additional uncertainty into the system. By distinguishing between decision-independent and decision-dependent uncertainty, decision makers can better understand the sources of uncertainty and develop appropriate strategies to manage and mitigate risks by building resilience and flexibility into systems to cope with unpredictable events and disruptions.

As used herein, the term, “recourse problem” may refer to the set of decisions that can be made after the realization of uncertain events. The recourse problem involves one or more actions that can be taken in response to uncertain outcomes. The recourse problem arises in the second stage of robust optimization. In the first stage decisions are made before uncertainty is realized. Such decisions often involve determining production levels, inventory levels, transportation routes, facility capacities, and/or the like. In the second stage, the recourse problem is solved after the realization of uncertainty, in response to actual demand, cost fluctuations, unpredictable events, and/or the like. These decisions may involve taking a particular action, such as adjusting production schedules, rerouting transportation, reallocating inventory, and/or the like.

As used herein, the term, “mixed integer” refers to a type of mathematical programming problem where some of the decision variables are restricted to integer values, while others can take on any real value. This is in contrast to purely continuous optimization problems, where each of the decision variables take on real values. Linear program refers to a mathematical optimization problem where both the objective function and the constraints are linear functions of the decision variables. In this way, the objective function and each constraint may be represented as a linear combination of one or more decision variables, where the coefficients are constants. In mixed integer linear programming (MILP), the optimization problem involves linear constraints and an objective function, where some of the variables are constrained to be integers. These integer variables often represent decisions that are inherently discrete, such as the number of units to produce, the number of facilities to open, the assignment of tasks to different resources, etc. MILP problems may be used to solve supply chain optimization, scheduling optimization, logistics optimization, and finance optimization, where decision variables may have discrete or binary characteristics. The inclusion of integer variables allows for modeling complex decision-making scenarios more accurately, leading to more realistic and practical solutions.

As used herein, the term, “deterministic conditions” refers to situations where each of the parameters and variables are known with certainty, such that there is no uncertainty or variability associated with the parameters influencing the problem. The parameters may include values that are known with certainty and may remain constant throughout the optimization process (e.g., such as fixed characteristics or attributes of the system being optimized, etc.). The parameters might include values for transportation costs, production capacities, demand forecasts, lead times, facility capacities, and/or the like, that are predetermined and do not change based on decisions made during the optimization process. The variables may include quantities that change or are manipulated within the optimization model to achieve the desired outcome, such as decision choices that the optimization algorithm can adjust to find the optimal solution (e.g., production levels, inventory levels, transportation routes, allocation of resources, facility utilization, etc.). These variables may be adjusted to minimize costs, maximize profits, achieve other objectives, and/or the like, while satisfying one or more constraints imposed by the parameters. When formulating optimization models under deterministic conditions, each of the parameters are assumed to have fixed values, allowing for the precise determination of optimal decisions using mathematical techniques such as linear programming or mixed-integer linear programming.

As used herein, the term “objective function”, may refer to a quantitative measure to optimize or minimize the overall decision-making process. The objective function guides the decision maker in selecting optimal first-stage decisions that are robust to uncertainty, considering both the initial decisions and the subsequent decisions resulting from solving the recourse problem. Within this formulation, the objective function encompasses an outer minimization over the first-stage decision variable, aiming to determine optimal values that minimize the total objective function. The robust optimization (RO) aspect involves assessing worst-case scenarios within the uncertainty set, where the maximization is over this set. This process helps identify robust solutions that perform well across various scenarios in the uncertainty set. The objective function may incorporate costs or benefits associated with the first-stage decision variable, reflecting the importance assigned to these initial decisions. In certain instances, an inner minimization is performed over a second-stage decision variable, representing the decision maker's response or recourse decision after observing the realization of uncertainty. This two-stage approach allows for a comprehensive optimization strategy that considers both initial decisions and responses to uncertainties, ultimately contributing to the robustness of the decision-making process. The overall objective is to find the values of the first-stage decision variable that minimize the total cost or maximize the total benefit, considering the worst-case scenario within the specified uncertainty set and the associated recourse decisions.

As used herein, the term “supervised learning” may refer to one or more machine learning algorithms that start with known input variables (x) and an output variable (y), and learn the mapping function from the input to the output. The goal of supervised learning is to approximate the mapping function so that predictions can be made about new input variables (x) that can be used to predict the output variables (y) for that data. The process of a supervised algorithm learning from the training dataset can be thought of as a teacher supervising the learning process. The correct answers are known. The algorithm iteratively makes predictions on the training data and is corrected by the teacher. Learning stops when the algorithm achieves an acceptable level of performance. Supervised learning problems can be further grouped into regression problems and classification problems. Supervised learning techniques can use labeled (e.g., classified) training data with normal and outlier data, but are not as reliable because of the lack of labeled outlier data. For example, multivariate probability distribution based systems are likely to score the data points with lower probabilities as outliers.

As used herein, the term “unsupervised learning” may refer to an algorithm which has input variables (x) and no corresponding output variables. The goal for unsupervised learning is to model the underlying structure or distribution in the data in order to learn more about the data. Unlike supervised learning, in unsupervised learning there are no correct answers and there is no teacher. Unsupervised learning algorithms are used to discover and present the interesting structure in the data. Unsupervised learning problems can be further grouped into clustering and association problems. A clustering problem is modeling used to discover the inherent groupings in a dataset, such as grouping customers by purchasing behavior. An association rule learning problem may be used to discover rules that describe large portions of data, such as supplier performance rules to discover rules that link supplier performance metrics (e.g., on-time delivery, quality, responsiveness, product demand, etc.) to delivery decisions, cost savings association rules to identify rules that define conditions under which cost-saving opportunities are recognized, inventory management rules to determine rules that optimize inventory levels, and/or the like. Some examples of unsupervised learning algorithms are clustering and likelihood modeling.

As used herein, the term “training” may refer to a process of analyzing training data to generate a model (e.g., create a machine learning algorithm, a prediction model, a classification model, a segmentation model, etc.). For example, a training server uses machine learning techniques to analyze the training data to generate the model, often the training data includes numerous examples so that a robust model is generated to solve a problem for many variations present in the data. In some non-limiting embodiments or aspects, generating the model (e.g., based on training data from a variety of sources) is referred to as “training the model.” The machine learning techniques include, for example, supervised and/or unsupervised techniques, such as decision trees (e.g., gradient boosted decision trees), logistic regressions, artificial neural networks (e.g., convolutional neural networks), Bayesian statistics, learning automata, hidden Markov modeling, linear classifiers, quadratic classifiers, association rule learning, and/or like. In some examples, the model includes a prediction model that is specific to a particular geographic location, a particular supplier, a particular vendor, and/or like. Such as decision trees for predicting the most effective negotiation strategies for contract terms with a particular supplier sourcing process, logistic regression estimating the likelihood of a shipment occurring, artificial neural networks learning patterns in historical contract documents to identify new patterns and best practices for demand management, Bayesian statistics for determining the probability of delays or bottlenecks in the supplier management steps based on historical data and external factors, like regulatory changes, hidden Markov modeling predicting the expected timeline for supplier management for a specific type of item procurement, linear classifiers estimating the likelihood of a specific concept progressing to the contract stage based on criteria such as cost, feasibility, and strategic importance, quadratic classifiers predicting the potential cost savings associated with a specific contract based on historical procurement data. Association rule learning for determining associations between different items and their respective contract outcomes to optimize decision-making and resource allocation. Additionally, or alternatively, the optimization model may be specific to a particular user or thing (e.g., a supplier that uses medical devices, a supplier extending a predetermined price, one or more receipts for an order, etc.). In other examples, a training server generates one or more prediction models (e.g., one or more procurement models, one or more purchase order segmentations, one or more voucher classifications, etc.) for one or more accounts (e.g., one or more supplier accounts, one or more vendor accounts, etc.), a particular group of customers, and/or like.

As used herein, the term “machine learning inference engine” may refer to a process of executing a model algorithm and returns an inference output. For example, an inference engine (e.g., inference server, etc.) may utilize one or more processing units (e.g., a central processing unit (CPU), general processing unit (GPU), tensor processing unit (TPU), field programmable gateway array (FPGA), an application-specific integrated circuit (ASIC), etc.) to execute the model algorithm. In some non-limiting embodiments or aspects, a processing choice for machine learning inference can have a significant impact on speed, throughput, latency, accuracy, rate of learning, energy efficiency, and rate of learning.

As used herein, the term “data sets” may refer to or include one or more discrete data sets, collections, vectors, and/or the like comprising individual data points or values, not necessarily related geometrically, such as lists of numbers, sequences, graphs, and networks. Discrete data sets are used in many areas of science and engineering, including statistics, computer science, and social network analysis, as used herein, for engineering fields, including geometry, topology, computer graphics, architecture, and/or the like when two-stage RO may be desired. In some examples, implementation specific problems or applications may be used to model or represent relationships between objects or to analyze patterns in data. For example, an electrical network may be represented as a discrete data set of grid lines and components, their relationships, and/or the like where analyses may be performed on the data to uncover patterns or correlations.

As used herein, the term “decision-dependent uncertainty” may refer to or include a second-stage uncertain parameter(s) that is affected by the decision(s) made in the first-stage, such that the value of the second-stage uncertain parameter(s) is not just randomly determined, but rather depends on the cost of the first-stage decision variable, so that the uncertainty is no longer decision-independent but rather decision-dependent. Dependence refers to the dependence of the uncertain parameter on the decision made in the first-stage, which is reflected by restricting those parameters (e.g., objective function coefficients and/or right-hand-side of the second-stage problem (RHS)) to take values from a set determined by the first-stage decision.

In view of the foregoing background discussion, a need is apparent in the art for improved systems, methods, and computer program products for decision planning. For example, a need exists to effectively characterize, quantify, and model uncertainty associated with large-scale projects and industrial management. A need further exists for a sufficiently detailed representation of uncertainty while a development plan or management strategy is being optimized. A need further exists to reduce the model to a manageable size, while retaining the critical features of the model. A need further exists for a work process that can integrate the complexity of the system, the number of uncertainties affecting the decision, and the number of different considerations for the plans or decision support. A need further exists to optimize decision making related to a development plan or management strategy when uncertainty is present. The foregoing discussion of need in the art is intended to be representative of a technology addressing one or more such needs, or some other related shortcoming in the field, that may benefit from improved decisions or plans for developing and managing with large-scale projects and industrial management more effectively and more profitably.

In two-stage RO formulation, the decision maker faces a two-stage decision problem in which the first-stage decision is made before the realization of uncertain parameters, and the second-stage decision is made after the realization of uncertain parameters. The uncertain parameters are modeled as a set of scenarios, and the decision maker seeks to find a decision that is robust against all possible scenarios.

The two-stage RO formulation is typically represented as a MILP, where the first-stage decision variables are determined by solving a deterministic linear program, and the second-stage decision variables are determined by solving a set of linear programs, each corresponding to a scenario.

The objective function seeks to minimize the worst-case total cost of the system, taking into account the different scenarios for the second-stage decision variable y. The decision-dependent uncertainty arises because the parameters' randomness (including the objective function coefficients and/or RHS and their distributions) of the whole second-stage problem is not determined before the time the first-stage decision x is made, but it depends on the decision x made in the first-stage. The goal is to find the first-stage decision that minimizes the worst-case total cost, regardless of which scenario for y actually occurs.

I For example, when a company is considering building a new factory in a particular location, an uncertain parameter may include a demand for a company's product in a location. For example, a location which is outside of the company's control may include uncertainty. The company may have historical data on demand in other locations, but uncertainty about how demand will behave in the new location and uncertainty about how demand in other locations may apply to the new location. The company may consider a set of possible scenarios for demand, such as high, medium, and low levels of demand, and attempt to identify a location and production strategy that is robust to all possible scenarios.

As another example, a portfolio manager optimizes a portfolio of stocks and bonds. During optimization, it may be determined that an uncertain parameter may be the future return of an asset, which is outside of the company's control. The company may have historical data on returns for each asset, but there is uncertainty about how returns will behave in the future. The manager may consider a set of possible scenarios for returns, such as bullish, bearish, and neutral scenarios, in order to choose a portfolio that is robust to each of the possible scenarios.

In both of the above examples, the uncertain parameters (e.g., demand, returns, etc.) are assumed to be outside of the decision-maker's control, and their values are not known with certainty when the first-stage decisions are made. Instead, the decision-maker must make decisions that are robust to each of the possible realizations of the uncertain parameters, and the optimization problem must be formulated in a way to account for such uncertainty.

In some non-limiting embodiments or aspects, the decision-maker faces a two-stage optimization problem. In the first-stage, the decision-maker makes a decision (e.g., such as choosing a factory location, selecting a portfolio of assets, etc.), without knowing the exact values of the uncertain parameters (e.g., demand, future returns, etc.). Instead, the decision-maker assumes that the uncertain parameters take on a certain set of possible values (e.g., scenarios, etc.). For example, the decision-maker may consider scenarios where demand is high, medium, or low, or where returns are bullish, bearish, or neutral.

After making the first-stage decision, the decision-maker observes the actual values of the uncertain parameters, which may differ from the assumed scenarios. The decision-maker then faces a second-stage optimization problem, where they make a second decision to optimize their objective function based on the observed values of the uncertain parameters.

The goal of two-stage RO is to choose the first-stage decision in a way that is robust to all possible realizations of the uncertain parameters. This means that the first-stage decision should be a good choice regardless of which scenario is actually realized in the second-stage.

In some non-limiting embodiments or aspects, the decision-maker in a two-stage RO problem makes a first-stage decision based on assumptions about possible scenarios for the uncertain parameters. The decision-maker then makes a second-stage decision based on the actual values of the uncertain parameters and the first-stage decision. In such an example, the goal is to choose the first-stage decision in a way that is robust to all possible realizations of the uncertain parameters. The optimization problem may be formulated to consider each of the possible scenarios.

In some non-limiting embodiments or aspects, two-stage RO with decision dependent uncertainty (“DDU”) may be used with the parametric column and constraint generation (“parametric C&CG”) method for solving two-stage RO problems. For example, the method decomposes the original problem into a master problem and a number of sub-problems, each of which is a smaller version of the original problem. In this example, the first-stage decision variables are determined before the uncertainty is revealed, while the second-stage decision variables are determined after the uncertainty is revealed.

The C&CG method is specialized for solving two-stage RO problems with a large number of scenarios. This method generates the scenarios on-the-fly during the optimization process, rather than precomputing each of the possible scenarios in advance.

Two-stage RO with DDU may be solved by the C&CG method. For example, the C&CG method decomposes the problem into a master problem and a number of sub-problems. The problems are then solved iteratively. The master problem determines the first-stage decision variables, while the sub-problems determine the second-stage decision variables for the worst case scenario. The C&CG method may be used to generate the scenarios on-the-fly during the optimization process.

In some non-limiting embodiments or aspects, C&CG may be an effective way to solve large-scale problems with a large number of scenarios. C&CG iteratively adds new columns (e.g., second-stage decision variables, etc.) and constraints to the master problem as needed to improve the quality of the solution. In each iteration, a master problem is solved to obtain a candidate first-stage solution, and a set of sub-problems (e.g., one for each scenario, etc.) are solved to determine the worst-case scenario. In such an example, when the candidate solution violates any of the sub-problems, new columns and constraints are added to the master problem to improve the solution.

In some non-limiting embodiments or aspects, the C&CG method is particularly useful for problems with a large number of scenarios, where it may be computationally infeasible to precompute all possible scenarios or otherwise, computationally intensive and may require a significant amount of computational resources to solve.

In some non-limiting embodiments or aspects, a mixed integer DDU set provides a more powerful capacity in capturing sophisticated interactions between the first-stage decision and the underlying randomness, which are often beyond that of any convex set. Also, with a DDU set that is varying, a handling of mixed integer recourse is computationally demanding compared to those defined with a fixed decision-independent uncertainty (“DIU”) set. Hence, mixed integer structures within a DDU-based two-stage RO expands capacity to determine more complex RO problems.

Therefore, provided herein are improved systems, methods, and computer program products for an optimal and efficient design for decision-making by two-stage RO with DDU is provided herein. This approach and the improvements herein, provide benefits over existing systems, such as the time it takes to get results of an optimization depends on the complexity of the problem being solved, the computational resources available, and the specific optimization algorithm used. For small problems with simple models and linear optimization algorithms, the results can be obtained in a matter of seconds or minutes. However, for larger and more complex problems with non-linear models and more sophisticated optimization algorithms, the optimization process can take hours, days, or even longer to complete. Additionally, the size of the historical data set used to estimate the uncertain parameters can also impact the time it takes to get results, as more data can require more time for preprocessing and analysis.

In this way, the improved systems, methods, and computer program products may be used to determine more efficient ways to allocate resources or perform tasks, resulting in optimal (e.g., increased, enhanced, improved, etc.) productivity. The improved systems, methods, and computer program products may be applied to a wide range of industries such as transportation, logistics, manufacturing, energy, and/or the like.

Moreover, improved systems, methods, and computer program products may aid decision-makers when considering a range of scenarios to take into account uncertainty and potential risks. This may be particularly useful in fields like finance, where decisions made by investors may have significant impacts on the market. The improved systems, methods, and computer program products may be used to reduce waste by optimizing processes, reducing inventory, and minimizing scrap or rework, for example, in industries such as manufacturing, healthcare, and agriculture.

The improved systems, methods, and computer program products may be used to promote sustainability by optimizing energy use, reducing emissions, and minimizing waste. The improvements can be applied to a wide range of industries and can help to address global environmental challenges such as climate change.

The improved systems, methods, and computer program products may be used to provide significant increase in efficiency, decision-making, waste reduction, and sustainability, among others, so that using the techniques, organizations can make better use of their resources, reduce costs, and improve their bottom line while also promoting other input, such as social, geographic, environmental, proximity, and/or the like.

In some non-limiting embodiments or aspects, optimization problems may be solved in real-time or near real-time depending on the complexity of the problem and the available computational resources. For example, in the case of automation of autonomous navigation, to make decisions in real-time, such as in self-driving cars, where optimization algorithms can be used to optimize the route the car takes to get to its destination based on real-time traffic information, road conditions, and other factors. This approach and the improvements herein, may be used to optimize the car's speed, acceleration, and braking to improve fuel efficiency, reduce emissions, and ensure safe and comfortable travel. These decisions are made in real-time or near real-time to ensure that the car is constantly adapting to changing road conditions and traffic patterns. This approach and the improvements herein, may be used to minimize transportation costs by determining the most efficient routes and schedules for vehicles. This may result in reduced fuel consumption, lower maintenance costs, and improved on-time delivery. For example, a transportation company may use optimization algorithms to determine the best routes for their trucks to take when delivering packages, which may reduce fuel consumption and improve delivery times.

In some non-limiting embodiments or aspects, warehouse operations may be improved by determining the most efficient layout for storage, the best routing, scheduling for picking and packing operations, and/or the like. This may result in improved inventory management, and faster order fulfillment. For example, a logistics company may determine the best way to store and retrieve products in their warehouse, and may reduce the time and effort required to pick and pack orders.

Still further, production efficiency may be improved by determining the optimal use of resources such as labor, raw materials, and equipment. This may result in reduced waste, improved quality, and increased throughput. For example, a manufacturing company may use optimization algorithms to determine an optimal solution (e.g., a best way to schedule production runs and allocate resources, etc.), which may reduce downtime and improve overall efficiency.

Further improvements to energy efficiency by determining the most efficient use of resources such as electricity and natural gas may result in reduced energy consumption, lower operating costs, improved environmental sustainability, and/or the like. For example, a utility company may use optimization algorithms to determine the optimal distribution of energy across a grid and may reduce waste and improve reliability. Additionally, optimization techniques may be used to optimize the design and operation of renewable energy systems (e.g., wind turbines, solar panels, etc.).

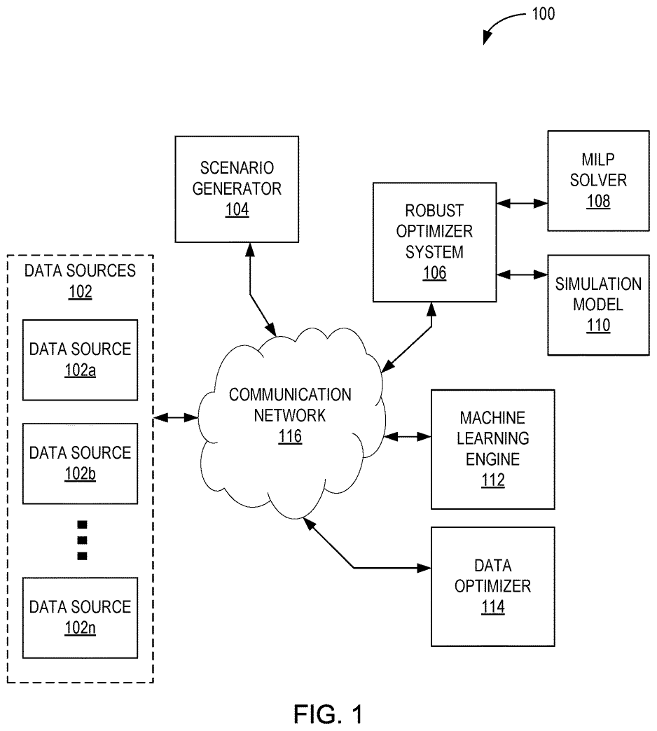

Referring now to FIG. 1, a diagram of a non-limiting embodiment or aspect of system 100 is shown for two-stage RO with DDU. In some non-limiting embodiments or aspects, as shown in FIG. 1, system 100 includes one or more computers or devices. For example, system 100 includes data sources 102 (e.g., one or more data sources, data source 102a-102n, etc.), scenario generator 104, RO system 106, MILP) solver 108, simulation model 110, machine learning (“ML”) engine 112, data optimizer 114, and communication network 116.

In some non-limiting embodiments or aspects, data source 102a-102n performs data collection, storage, and processing. For example, data source 102a-102n represent sources of data that may collect data, for example, energy data for an energy system, including historical data on energy demand, prices, and supply. The data may be processed, cleansed, transformed, organized, and/or the like.

In some non-limiting embodiments or aspects, scenario generator 104 may perform scenario generation. For example, scenario generator 104 may generate a set of scenarios that represent possible values of uncertain parameters. Scenario generator 104 may generate scenarios based on statistical methods, such as time-series analysis or using other simulations which take into account historical data (e.g., weather patterns, market conditions, roadway objects, relevant factors, etc.).

In some non-limiting embodiments or aspects, RO system 106 performs first-stage optimization, real-time optimization, and second-stage optimization. For example, RO system 106 performs first-stage optimization by making decisions, such as decisions about energy investments, such as building new power plants, managing a power grid, upgrading existing infrastructure, or implementing energy conservation measures. The objective of the first-stage optimization is to minimize the worst-case cost or maximize the expected profit over all scenarios. The decision variables can include the physical protection, condition and repairs, type, capacity, and location of the energy investments. In another example, for emergency planning, the objective includes placements of various facilities and their capacities, as well as resource allocations, which certainly affects the effectiveness and the efficiency of recovery and reconstruction.

In some non-limiting embodiments or aspects, RO system 106 generates actual values of the uncertain parameters. As an example, after the first-stage decisions are made, RO system 106 generates one or more actual values of the uncertain parameters (e.g., in response to determining the first-stage problem, in real-time, etc.). The system observes these values and determines the scenarios that best represents the observed values.

In some non-limiting embodiments or aspects, scenario generator 104 performs second-stage optimization, such as, for example, making decisions on energy operations, such as dispatching power plants, adjusting energy prices, or curtailment of renewable energy sources. The objective of the second-stage optimization is to optimize the operation of the energy system based on the chosen scenario. The decision variables can include the dispatch schedule, the energy prices, and the amount of reduction.

In some non-limiting embodiments or aspects, data optimizer 114 evaluates the performance of the decisions made in both stages by comparing with the actual costs or profits. The system also evaluates the robustness of the decisions by comparing to the performance over all observed scenarios.

In some non-limiting embodiments or aspects, data optimizer 114 generates visualization of the results of the analysis to include visualizations of the energy system, reports on the performance of the decisions, and recommendations for future investments and operations (e.g., reported to the decision-makers in a format that is easy to understand and act upon, etc.).

In some non-limiting embodiments or aspects, data source 102a-102n includes possible inputs such as historical data on energy demand, energy prices, weather patterns, and other relevant variables, uncertainty sets and parameters, constraints on the system, such as maximum and minimum capacity of energy sources and transmission lines, first-stage decisions (e.g., investment in energy sources and transmission lines, etc.), and/or the like.

In some non-limiting embodiments or aspects, data optimizer outputs optimal second-stage decisions (e.g., how much energy to generate from each source, how much to transmit through each line, etc.), sensitivity analysis (e.g., measures the impact of changes in input parameters on the optimal solution, etc.), visualization of the results (e.g., charts and graphs of energy generation, transmission, costs, etc.), optimization solvers (e.g., linear programming (“LP”) solver to solve the first-stage problem), MILP (e.g., MILP solver 108 handles the first-stage problem, etc.), and RO solver 106 to handle the uncertainty sets and parameters.

In some non-limiting embodiments or aspects, MILP solver 108 generates solutions for the first-stage optimization problem. For example, decisions made to optimize the system may be based on values for uncertain parameters. For example, in energy system planning, MILP solver 108 may be used to determine an optimal mix of energy sources, infrastructure investments, or resource allocations.

In some non-limiting embodiments or aspects, MILP solver 108 may generate solutions for a second-stage optimization problem. For example, MILP solver 108 generates decisions based on observed outcomes and actual (e.g., estimated, measured, etc.) values of uncertain parameters. In some examples, MILP solver 108 determines the optimal recourse actions or corrective measures to adjust the initial decisions made in the first-stage.

In some non-limiting embodiments or aspects, MILP solver 108 may be programmed or configured to provide scenario generation, scenario reduction techniques used to represent uncertainty, and/or the like. In some examples, MILP solver 108 may generate a discrete set of scenarios or define uncertainty sets to capture different possible realizations of uncertain parameters. In some non-limiting embodiments or aspects, MILP solver 108 formulates RO models that explicitly account for uncertainty in the optimization problem. These models incorporate decision-dependent uncertainty to optimize system performance across multiple scenarios or realizations of uncertain parameters.

In some non-limiting embodiments or aspects, RO system 106 comprises MILP program solver 108, simulation model 110, and ML engine 112. For example, simulation model 110 or ML engine 112 may provide one or more models, such as simulation models, including models for energy demand forecasting, which may use time series analysis or ML algorithms, models for energy generation and transmission, which may use physics-based models or empirical data, Monte Carlo simulation models, which may generate random scenarios of the uncertain parameters and evaluate the robustness of the solution.

In some non-limiting embodiments or aspects, ML engine 112 may execute supervised learning for determining energy demand forecasting, energy generation, transmission, Monte Carlo simulation tasks, and/or the like.

In an energy demand forecasting example, supervised learning algorithms may learn from historical data related to factors (e.g., time of day, weather conditions, economic indicators, etc.), to predict future energy demand. The input variables (x) may include features (e.g., time stamps, weather data, economic indicators, etc., while the output variable (y) may represent the predicted energy demand.

In some non-limiting embodiments or aspects, ML engine 112 may execute supervised learning algorithms for modeling energy generation and transmission processes. For example, ML engine 112 may learn from historical data related to power generation sources (e.g., solar, wind, hydro, etc.), transmission line capacities, demand patterns, and/or the like, to predict future energy generation and transmission levels.

In some non-limiting embodiments or aspects, ML engine 112 may execute a Monte Carlo simulation for generating scenarios (e.g., random, etc.) of uncertain parameters. The uncertain parameters for optimizing the robustness of solutions. ML engine 112 may generate scenarios by learning from historical data and patterns to create realistic distributions for uncertain parameters.

In some non-limiting embodiments or aspects, ML engine 112 may use regression (e.g., for continuous output variables, etc.) or classification (e.g., for discrete output variables, etc.), that may be applied depending on the nature of the prediction task. ML engine 112 may learn the mapping function from known input-output pairs (training data) and then use this learned function to make predictions on new data.

In some examples, labeled training data with normal and outlier data may be particularly useful for assessing the robustness of solutions by identifying outlier scenarios or extreme events that may impact energy operations.

In some non-limiting embodiments or aspects, ML engine 112 may provide a modeling data structure and distribution based on unsupervised learning algorithms. For example, ML engine 112 may provide clustering or density estimation that may be used to model the underlying structure or distribution in the data without a need for labeled output variables. ML engine 112 may provide a modeling data structure and distribution to uncover patterns, relationships, or groupings in the data that may not be apparent through manual inspection.

In some non-limiting embodiments or aspects, ML engine 112 may provide clustering. For example, ML engine 112 may provide clustering algorithms, such as k-means clustering or hierarchical clustering, may be employed to discover inherent groupings or clusters in the dataset. ML engine 112 may provide clustering to group customers based on their energy consumption patterns or to identify similar energy infrastructure assets for optimization purposes.

In some non-limiting embodiments or aspects, ML engine 112 may provide association rule learning. For example, ML engine 112 may provide unsupervised learning techniques for association rule learning. ML engine 112 may generate (e.g., create, etc.) rules that describe relationships or associations between different variables in the data. For instance, association rule learning may be applied to identify patterns in supplier performance metrics and their impact on renewal or termination decisions, cost-saving opportunities, or inventory management rules.

In some non-limiting embodiments or aspects, ML engine 112 may provide likelihood modeling. For example, ML engine 112 provides likelihood modeling techniques, such as gaussian mixture models or hidden Markov models, to estimate the probability distribution of the data to determine relationships between variables. These models can be particularly useful for tasks such as anomaly detection, pattern recognition, or generating synthetic data samples.

By leveraging unsupervised learning algorithms, ML engine 112 optimizes based on the structure, patterns, and relationships within the data, for decision-making, optimization.

For the purpose of illustration, in the following description, while the presently disclosed subject matter is described with respect to methods, systems, and computer program products for supervised and unsupervised learning algorithms that learn from historical data related to factors such as time of day, weather conditions, economic indicators, and/or the like, to predict future energy demand, or the other examples provided herein, one skilled in the art will recognize that the disclosed subject matter is not limited to the non-limiting embodiments or aspects disclosed herein. For example, the methods, systems, and computer program products described herein may be used with a wide variety of settings, such as other supervised or unsupervised ML models for making determinations based on the dataset (e.g., predictions, classifications, regressions, and/or the like) with at least one ML model based on the dataset, such as for production and inventory management for perishable products, supply chain management, pre-disaster location and storage of emergency commodities, electricity supply, station location and vehicle rebalancing in bike-sharing systems, and/or the like.

In some non-limiting embodiments or aspects, data optimizer 114 provides data analysis tools, such as, for example, statistical analysis tools, which may be used to analyze historical data and estimate probability distributions for the uncertain parameters, sensitivity analysis tools, which may be used to quantify the impact of changes in input parameters on the optimal solution, ML algorithms, which may be used to identify patterns in the data and improve the forecasting models. In other examples, data optimizer 114 provides tools to visualize the data and results, interactive dashboards and web applications to provide a user-friendly interface to explore the results and scenarios.

In some non-limiting embodiments or aspects, one of MILP program solver 108, simulation model 110, and ML engine 112 may be used to model energy demand forecasting that use ML algorithms and incorporate the two-stage RO algorithm to estimate the probability distribution of the uncertain parameters and then use the estimated distribution in the two-stage RO model. For example, an ML algorithm can be trained on historical data to predict future electricity demand, and the resulting predictions can be used to estimate the probability distribution of demand.

MILP program solver 108 improves the solution process by optimizing decisions based on multiple scenarios and identifying robust decision strategies that perform well across different real-world scenarios. MILP program solver 108 improves the solution's resilience and reduces the risk of incurring high costs due to unexpected events.

In another approach, one of MILP program solver 108, simulation model 110, and ML engine 112 may generate scenarios for the uncertain parameters, which can then be used in the two-stage RO model. For example, an ML algorithm can be trained to generate realistic scenarios for electricity demand based on historical data, and the resulting scenarios can be used to define the uncertainty set (U) in the two-stage RO model. In such an example, the ML algorithm may be integrated into the overall system architecture and used to provide inputs to the two-stage RO model. The results of the optimization model may then be used to inform energy planning decisions, such as determining the optimal mix of energy sources or the optimal scheduling of energy production and consumption.

In some non-limiting embodiments or aspects, RO system 106 provides one or more optimization solvers to improve decision-making around planning, allocating, scheduling scarce resources, and/or the like. For example, RO system 106 may be programmed or configured to solve mathematical programming models, constraint programming, and constraint-based scheduling models.

In some non-limiting embodiments or aspects, RO system 106 comprises MILP program solver 108 and simulation model 110, or a connected processor, for providing capabilities and functions of MILP program solver 108 and/or simulation model 110. RO system 106 may generate, determine, provide, and/or the like one or more answers for linear programming, mixed integer programming, quadratic programming and quadratically constrained programming problems. In such an example, generating constraints for programming models, accessing or communicating models (or information therein) to solve optimization problems.

In some non-limiting embodiments or aspects, RO system 106 is configured to formulate a supply chain optimization problem as an MILP problem using capabilities and functions of MILP program solver 108 and/or simulation model 110. For example, RO system 106 models various decision variables such as production levels, inventory levels, transportation routes, facility capacities, and/or the like.

Simulation model 110 accounts for uncertainties by providing simulation software such as Monte Carlo simulation techniques, and/or the like to model stochastic demand, lead times, transportation delays, and/or the like. For example, simulation model 110 assesses the robustness of different supply chain models designed under (e.g., to account for, etc.) various scenarios. Simulation model 110 enhances the simulation process by providing more accurate input data for stochastic modeling based on the improvements described herein. For example, instead of relying solely on historical data or subjective estimates for uncertain parameters, such as demand variability or lead time uncertainty, RO system 106 generates improved scenario-based data that captures the range of possible outcomes. In this way, RO system 106 generates improved realistic simulations for optimization based on better, ultimately improving decision-making and quantifiable improvements for evaluation of supply chain performance under various conditions.

In some non-limiting embodiments or aspects, RO system 106 provides decision support systems (“DSS”) tailored to its specific supply chain requirements. RO system 106 may integrate DSS mathematical optimization models with real-time data from enterprise systems, sensor networks, and external sources to provide actionable insights and decision recommendations.

Data optimizer 114 provides one or more optimization algorithms, such as genetic algorithms, particle swarm optimization, simulated annealing, and/or the like.

Data optimizer 114 provides large-scale and complex supply chain optimization problems for decoding, deciphering, or interpreting the solution space efficiently and finding near-optimal solutions. For the optimal supply chain example, once the design is identified, the solution may be deployed using supply chain management software like SAP, Oracle, SalesForce, PeopleSoft software, and/or the like.

In some non-limiting embodiments or aspects, RO system 106 provides continuous (or substantially continuous) monitoring and optimization to adapt to changing market conditions and business requirements. By leveraging RO system 106 and the computational tools and software platforms, significant improvements in the accuracy and predictability are implemented that enhance customer service levels and overall supply chain performance.

In some non-limiting embodiments or aspects, RO system 106 improves RO by providing a rigorous mathematical framework for addressing uncertainty. In existing systems, optimization algorithms may struggle to handle uncertain parameters directly, may require complex modifications to accommodate stochastic data, and/or the like. RO system 106, on the other hand, formulates optimization problems as robust decision-making under uncertainty according to the disclosed techniques, enabling optimization algorithms to find solutions that are resilient to variations in input parameters and improving the efficiency and effectiveness of optimization algorithms, leading to better-quality solutions with efficient solution generation in less time.

For example, during a two-stage decision making procedure, the decision maker (e.g., RO system 106, scenario generator 104, etc.) defines a two-stage RO problem with DDU which initially determines a value of a first-stage decision variable x before the materialization of a random factor u. Then, after the uncertainty is cleared, a recourse decision for mitigation is restricted by a choice of x and a realization of factor u. More particularly, let x=(x_{c}, x_{d}) denote the first-stage decision variable vector with x, and xa representing its continuous and discrete components, respectively. Similarly, y=(y_{c}, y_{d}) and u=(u_{c}, u_{d}) denote the recourse decision variable vector and the uncertainty variable vector, respectively, both of which may contain continuous and discrete variables. The general mathematical formulation of two-stage RO with DDU is

$$2 - Stg RO : {w}^{*} = {min}_{x ∈ 𝒳} {c}_{1} x + {max}_{u ∈ 𝒰 ( x )} {min}_{v ∈ 𝒴 ( x , u )} {c}_{2} y where \qquad ( 1 )$$

$$𝒳 = \{ x ∈ {ℝ}_{+}^{{n}_{x}} \times {ℤ}_{+}^{{m}_{x}} : Ax \geq b \} , 𝒰 ( x ) is the uncertainty set with$$

$$𝒰 ( x ) = \{ u ∈ {ℝ}_{+}^{{n}_{u}} \times {u}_{d} : {F}_{c} ( x ) {u}_{c} + {F}_{d} ( x ) {u}_{d} \leq h + G x \} \qquad ( 2 )$$

and [symbol] (x,u) is the feasible set of the recourse problem as in the next.

$$𝒴 ( x , u ) = \{ y ∈ {ℝ}_{+}^{{n}_{y}} \times {𝒴}_{d} : {B}_{2 , c} {y}_{c} + {B}_{2 , d} {y}_{d} \geq d - {B}_{1} x - {E}_{c} {u}_{c} - {E}_{d} {u}_{d} \} \qquad ( 3 )$$

In some non-limiting embodiments or aspects,

$${𝕌}_{d} ⊆ {ℤ}_{+}^{{m}_{u}} and {𝕐}_{d} ⊆ {ℤ}_{+}^{{m}_{y}}$$

are each two bounded sets of discrete structures. Coefficient vectors c₁, c₂ (both are row vectors), b, h, d, and matrices, A, F(x)=[F_{c}(x)F_{d}(x)], G, B₁, B₂=[B_{2, c}B_{2, d}], and E=[E_{c}E_{d}] are all with appropriate dimensions.

In some non-limiting embodiments or aspects, [symbol] (x) (e.g., a DDU set defined by a point-to-set mapping in equation (2) above, etc.), comprises two types of decision-dependence: RHS dependence and left-hand-side (“LHS”) dependence. RHS dependence has x appearing in a RHS of equation (2) above only, while the LHS dependence has x in LHS of equation (2) only.

In some non-limiting embodiments or aspects, when [symbol] (x) includes both RHS and LHS dependence, the dependence can be converted into an LHS one by appending −Gx as a column to F(x) and extending u with one more dimension that takes value 1. Equation (1) subsumes the classical DIU-based two-stage RO model by setting [symbol] (x) to a fixed set [symbol] ⁰ for all x∈X.

In some non-limiting embodiments or aspects, the definition of equivalence provides that two formulations are equivalent to each other if they share the same optimal value, and one's optimal first-stage solution is also optimal to the other one. Additionally, the following assumptions may apply:
(A1) For any x∈X, [symbol] (x)≠Ø;
(A2) [symbol] (x) is a bounded set (i.e., for any given x∈X, u(x)ⱼ<∞∀j)
(A3) The next monolithic MIP has a finite optimal value.

$${w}_{R} = min \{ {c}_{1} x + {c}_{2} y : x ∈ 𝒳 , u ∈ 𝒰 ( x ) , y ∈ 𝒴 ( x , u ) \} > - ∞ \qquad ( 4 )$$

Assumption (A1) substantiates the two-stage decision making framework, and can be simply achieved by the next formulation that again is in the form of equation (1).

$${min}_{x ∈ 𝒳 , {u}^{′} ∈ 𝒰 ( x )} {c}_{1} x + {max}_{u ∈ 𝒰 ( x )} {min}_{y ∈ 𝒴 ( x , u )} {c}_{2} y$$

Also, assumption (A2) generally holds for practical random factor. We say x⁰ ∈X is infeasible if the recourse problem is infeasible for some u∈ [symbol] (x⁰), and otherwise it is feasible.

In some non-limiting embodiments or aspects, the model 2-Stg RO is infeasible (e.g., the whole model, etc.) when no first-stage decision in X is feasible. Regarding assumption (A3), it is clear that w_{R} from equation (4) yields a lower bound to w*, since equation (4) is a simple relaxation of equation (1). In some examples, when equation (4) is infeasible, 2-Stg RO is also known to be infeasible.

### Basic Properties

Let w(X [symbol] (x), [symbol] (x,u)) denote the optimal value of equation (1) defined on those sets. Next, in some examples, several simple results of 2-Stg RO in equation (1) are determined by varying the underlying sets, to derive more sophisticated relaxations. In some examples, when either X, [symbol] (x) or [symbol] (x,u) is the original one without any modification, “⋅” is used to replace it. For example, by definition,

$${w}^{*} = w ( 𝒳 , 𝒰 ( x ) , 𝒴 ( x , u ) ) = w ( \cdot , \cdot , \cdot ) .$$

In some non-limiting embodiments or aspects, Proposition 1 includes the following results.
(i) Consider two sets Ø≠ [symbol] (x)⊆ [symbol] (x)∀x∈X.
   We have w(⋅, [symbol] (x), ⋅)≤w(⋅, [symbol] (x), ⋅)
(ii) Consider two sets [symbol] (x,u )⊆ [symbol] (x, u)∀x∈X, u∈ [symbol] (x). We have

$$w ( \cdot , \cdot , {𝒴}^{2} ( x , u ) ) \leq w ( \cdot , \cdot , {𝒴}^{1} ( x , u ) )$$

(iii) Let Xᵣ, [symbol] (x) and [symbol] (x,u) denote some relaxations of X, [symbol] (x) and [symbol] (x, u), respectively. We have

$$w ( {𝒳}_{r} , \cdot , {𝒴}_{r} ( x , u ) ) \leq w ( \cdot , \cdot , {𝒴}_{r} ( x , u ) ) \leq {w}^{*} \leq w ( \cdot , {𝒰}_{r} ( x ) , \cdot )$$

(iv) Consider two point-to-set mappings [symbol] (x)≠Ø and²(x)≠Ø such that [symbol] (x) ∪ [symbol] (x)⊆ [symbol] (x) for all x∈X, and [symbol] (x) such that [symbol] (x)⊆ [symbol] (x) for all x∈X. Together with (4), we have

$${w}_{R} \leq max \{ w ( \cdot , {𝒰}^{1} ( x ) , \cdot ) , w ( \cdot , {𝒰}^{2} ( x ) , \cdot ) \} \leq w ( \cdot , {𝒰}^{1} ( x ) ⋃ {𝒰}^{2} ( x ) , \cdot ) \leq {w}^{*} \leq w ( \cdot , {𝒰}^{3} ( x ) , \cdot ) .$$

In some non-limiting embodiments or aspects, the result in Proposition 1—(iii) is specific to the continuous relaxations, although it is valid for any relaxation. In some examples it may be strengthened under some special situation. For example, consider cases where [symbol] (x) or [symbol] (x,u) is an integer set and the associated constraint matrix is totally unimodular (“TU”). Then, if its RHS is integral, computing an integer program can reduce to solving its linear program relaxation.

In some non-limiting embodiments or aspects, Proposition 2 comprises two results:
(i) If nᵤ=m_{y}=0 and F_{d}(x) is TU and h+Gx is an integral vector for x∈X, we say the DDU has the TU property, and then w*=w(⋅, [symbol] ᵣ(x), ⋅).
(ii) Suppose that nᵤ=n_{y}=0, B_{2, d} is TU, and d−B₁x−E_{d}u_{d} is an integral vector for x∈X and u_{d} ∈ [symbol] (x), then w*=w(⋅, ⋅, [symbol] ᵣ(x, u)).

In some non-limiting embodiments or aspects, the result in Proposition 2-(i) may be proven by using the duality of the recourse problem, noting that it is a linear program. Then, an optimal u to the max-min substructure is always an optimal solution of integer program max{c⁰ u: u∈ [symbol] (x)} for some c⁰, which, by the TU property, simply reduces to a linear program with [symbol] (x) replaced by [symbol] ᵣ(x). The result in Proposition 2-(ii) is determined by the TU property.

As a special case of the point-to-set mapping, we consider a point-to-point mapping f^{u} satisfying f^{u}(x)∈ [symbol] (x) for x∈X. In such an example, using this mapping and following Proposition 1, a non-trivial but more tractable single-level relaxation is constructed for 2-StgRO.

In some non-limiting embodiments or aspects, Corollary 1 comprises the following formulation. The formulation may be a relaxation of 2-StgRO in (1) that is stronger than equation (4):

$${w}_{R} \leq min \{ {c}_{1} x + {c}_{2} y : x ∈ 𝒳 , u = {f}^{u} ( x ) , y ∈ 𝒴 ( x , u ) \} \leq {w}^{*}$$

recalling w_{R} is the optimal value of (4).

The assumption made in Corollary 1 might be restrictive to derive a strong relaxation. Instead of fixing u to f^{u}(x) completely, we can fix it partially according to that mapping, which yields a flexible strategy in deriving a strong relaxation. Consider Ĵ⊆J={1, . . . , nᵤ+mᵤ} and define a new DDU set that fixes uⱼ for j∈Ĵ, i.e.,

$${𝒰}^{{f}^{u}} ( x \vert {u}_{\hat{J}} ) = 𝒰 ( x ) ⋂ \{ u ∈ {ℝ}_{+}^{{n}_{u}} \times {𝕌}_{d} : {u}_{j} = {{f}^{u} ( x )}_{j} , ∀ j ∈ \hat{J} \} .$$

In such an example, Corollary 2 below follows from Proposition 1:

For a given f^{u}(x) and Ĵ₁⊆Ĵ₂⊆J, we have [symbol] (x|u_{Ĵ}_{₂}) ⊆ [symbol] (x|u_{Ĵ}_{₁}) and

$${w}_{R} \leq w ( \cdot , {𝒰}^{{f}^{u}} ( x \vert {u}_{{\hat{J}}_{2}} ) , \cdot ) \leq w ( \cdot , {𝒰}^{{f}^{u}} ( x \vert {u}_{{\hat{J}}_{1}} ) , \cdot ) \leq w ( \cdot , {𝒰}^{{f}^{u}} ( x ) , \cdot ) = {w}^{*}$$

The Result in Corollary 2 above, which subsumes Corollary 1, can be generalized by introducing multiple mappings. Suppose that we have two mappings

$$( i . e . , {f}_{i}^{u} ( x ) ∈ 𝒰 ( x )$$

for x∈X and i=1,2). Also, consider subsets Ĵ_{i,1} ⊆Ĵ_{i,2}⊆J, i=1,2, noting that it is not necessary to have Ĵ_{1, j}∩Ĵ_{2, j}=Ø for j=1,2.

The result in Corollary 3 follows Corollary 2. For example, given

$${f}_{i}^{u} ( x ) , i = 1 , 2$$

and Ĵ_{i,1} ⊆Ĵ_{i,2}⊆J, the following is determined:

$${w}_{R} \leq w ( \cdot , {𝒰}^{{f}_{1}^{u}} ( x \vert {u}_{{\hat{J}}_{1 , 2}} ) ⋃ {U}^{{f}_{2}^{u}} ( x \vert {u}_{{\hat{J}}_{2 , 2}} ) , \cdot ) \leq w ( \cdot , {𝒰}^{{f}_{1}^{u}} ( x \vert {u}_{{\hat{J}}_{1 , 1}} ) ⋃ {𝒰}^{{f}_{2}^{u}} ( x \vert {u}_{{\hat{J}}_{2 , 1}} ) , \cdot ) \leq {w}^{*} .$$

In some non-limiting embodiments or aspects, the results in Proposition 1, Proposition 2, and Corollaries 1-3 provide a strategy to handle mixed integer DDU approximately by using simpler DDU sets. For example, as shown in Corollary 3, different deep insights or domain knowledge can be used to design multiple instances of f^{u}(x) which can jointly yield a strong approximation.

### The Second Variant: Parameterized C&CG

Although the first variant is theoretically sound, we observe that its performance is not satisfactory. Even for small-scale instances, it often fails to converge after many iterations. As noted earlier, it is an extension of the less-effective Benders-dual cutting plane method. Given the great performance demonstrated by basic C&CG method in computing two-stage RO with DIU, we are motivated to develop more sophisticated variants to handle DDU based models. We expect those variants should be strong if they reduce to basic C&CG when the involved uncertainty set is actually a DIU set. In particular, it may be very significant if new variants have similar iteration complexities when dealing with complex DDU sets as the basic one when dealing with DIU sets. In this subsection and the following one, we develop and analyze two variants of C&CG that have those desirable properties.

### A Less Straightforward Single-Level Reformulation

Similar to the development of Variant 1, we first present a simple but large-scale reformulation to lay down the foundation of this new C&CG variant. In the following, we derive a result regarding the max−min substructure of 2-StgRO for a given x, through making use of projections of sets [symbol] and [symbol] . Recall that π and γ are extreme point and extreme ray of Π, respectively.

Lemma 23. For a given x, we have

$${max}_{u ∈ 𝒰 ( x )} min \{ {c}_{2} y : y ∈ 𝒴 ( x , u ) \} = {max}_{u ∈ 𝒰 * ( x ) ⋃ {𝒱}^{*} ( x )} min \{ {c}_{2} y : y ∈ 𝒴 ( x , u ) \}$$

where

$${𝒰}^{*} ( x ) = {⋃}_{k = 1}^{{K}_{p}} 𝒪 {𝒰}_{u} ( x , {π}^{k} ) and {𝒱}^{*} ( x ) = {⋃}_{l = 1}^{{K}_{r}} 𝒪 {𝒱}_{u} ( x , {γ}^{l} )$$

Theorem 24. Formulation 2-Stg RO in (1) (and its other equivalences) is equivalent to a bilevel linear optimization program as in the following.

$$2 - StgRO ( {Ω}_{Ð} ) : {w}^{*} = min {c}_{1} x + η \qquad ( 30 a )$$

$$s . t . x ∈ 𝒳 \qquad ( 30 b )$$

$$\{ η \geq {c}_{2} y , y ∈ 𝒴 ( x , u ) \qquad ( 30 b )$$

$$u ∈ arg max \{ {( - E u )}^{T} π : u ∈ 𝒰 ( x ) \} \} ∀ π ∈ {P}_{Ð} \qquad ( 30 c )$$

$$\{ y ∈ 𝒴 ( x , v ) \qquad ( 30 c )$$

$$v ∈ arg max \{ {( - E v )}^{⊤} γ : v ∈ 𝒰 ( x ) \} \} ∀ γ ∈ {R}_{Ð} , \qquad ( 30 \sim d )$$

which can be further converted equivalently into the next single-level optimization problem.

$$\begin{matrix}2 - S t gRO ( {Ω}_{\prod }^{K} ) : {w}^{*} = & min {c}_{1} x + η \\ & s . t . x ∈ 𝒳\end{matrix}$$

$$η \geq {c}_{2} {y}^{k} , {y}^{k} \geq 0 , k = 1 , … , {K}_{p}$$

$$( {u}^{k} , {λ}^{k} ) ∈ 𝒪 𝒰 ( x , {π}^{k} ) , k = 1 , … , {K}_{p}$$

$${B}_{2} {y}^{l} \geq d - {B}_{1} x - E {v}^{l} , {y}^{l} \geq 0 , l = 1 , … , {K}_{r}$$

$$( {v}^{l} , {ζ}^{l} ) ∈ 𝒪𝒱 ( x , {γ}^{l} ) , l = 1 , … , {K}_{r}$$

Again, as a result of enumeration, 2-StgRO(Ω_{Ð}) and

$$2 - Stg R O ( {Ω}_{\prod }^{K} )$$

are large-scale bilevel and nonlinear optimization problems, respectively.
(i) It is worth noting a critical observation regarding the structure of (31). Although [symbol] (x) is not fixed, by their definitions, [symbol] and [symbol] actually yield a parametric approach to characterize non-trivial scenarios in [symbol] (x). Those scenarios, which are optimal to some π or γ of Π, change with respect to x. Then, by enumerating π and γ of Ð, which is fixed and independent of x, (31) can fully capture the impact of the DDU set by considering its parametrically represented scenarios. Nevertheless, given that sets [symbol] and [symbol] are large-scale and [symbol] and [symbol] are complex, directly computing (31) is unrealistic.
(ii) Since a replicate of recourse problem is introduced and associated to every [symbol] or [symbol] , 2-StgRO(Ω_{Π}) is in a form similar to that of (11) of Corollary 7. One might believe that 2-StgRO(Ω_{Ð}) reduces to (11) when [symbol] (x)= [symbol] for all x. Actually, it is not the typical case even if [symbol] and [symbol] are singletons for every π and γ. Clearly, if they are singletons, they are some extreme points of [symbol] . Nevertheless, the map from π and γ to extreme points of [symbol] is not surjective or injective. Only a subset of extreme points of [symbol] will be identified by enumerating π and γ.
Corollary 25. Consider set Σ_{\hat{Π}} defined in Corollary 16 and denote formulation (31) defined with respect to Ó_{\hat{Ð}} by

$$2 - S tgRO ( {{U}^{′}}_{Ð}^{K} ) .$$

### Then,

$$2 - StgRO ( {{U}^{′}}_{\hat{\tilde{Ð}}}^{K} )$$

is a relaxation to

$$2 - StgRO ( {{U}^{′}}_{Ð}^{K} )$$

(and 2-StgRO in (1)). And the optimal value of

$$2 - StgRO ( {{U}^{′}}_{\hat{Π}}^{K} )$$

is smaller than or equal to w*.

### Variant 2: Generate Parametric Recourse Problems by C&CG

As mentioned earlier, when 2-StgRO is with a DIU set, basic C&CG generates and incorporates a replicate of a recourse problem in an iterative fashion for every identified critical scenario. With 2-StgRO(Ω_{Π}) (and its single-level reformulation

$$- S t g RO ( {{U}^{′}}_{Ð}^{K} ) ) ,$$

such strategy now is feasible to be implemented in a parametric fashion for DDU-based 2-Stg RO. We refer to this new procedure as Variant 2. As the fundamental differences between Variants 1 and 2 are in the definitions of dynamically generated cutting sets and the resulting master problems, we, to minimize repeated descriptions, just specify the modifications on top of Variant 1 in the following.

Master Problem Throughout the algorithm, MP1 is replaced by the next one.

$$\begin{matrix}MP 2 : \underline{w} = & min {c}_{1} x + η \\ & s . t . x ∈ 𝒳\end{matrix}$$

$$η \geq {c}_{2} {y}^{π} ∀ π ∈ {\hat{𝒫}}_{Ð}$$

$${B}_{2} {y}^{π} \geq d - {B}_{1} x - {Eu}^{π} ∀ π ∈ {\hat{𝒫}}_{Ð}$$

$$( {u}^{π} , {λ}^{π} ) ∈ 𝒪𝒰 ( x , π ) , {y}^{π} \geq 0 ∀ π ∈ {\hat{𝒫}}_{Ð}$$

$${B}_{2} {y}^{γ} \geq d - {B}_{1} x - E {v}^{γ} ∀ γ ∈ {\hat{ℛ}}_{Ð}$$

$$( {v}^{γ} , {ζ}^{γ} ) ∈ 𝒪𝒰 ( x , γ ) , {y}^{γ} \geq 0 ∀ γ ∈ {\hat{ℛ}}_{Ð}$$

Cutting Sets: For every u^{π} or v^{γ} defined by sets [symbol] and [symbol] , we generate and incorporate a replicate of recourse problem (including recourse variables and constraints) into MP2. Specifically, in Step 4[Case A] where η_{f}(x*)=0, the optimality cutting set in Equation (28) is replaced by the following:

$$η \geq {c}_{2} {y}^{{π}^{*}} , {B}_{2} {y}^{{π}^{*}} \geq d - {B}_{1} x - E {u}^{{π}^{*}}$$

In Step 4 [Case B] where η_{f}(x*)>0, the feasibility cutting set in Equation (29) is replaced by the following one.

$${B}_{2} {y}^{{γ}^{*}} \geq d - {B}_{1} x - E {v}^{{γ}^{*}}$$

In some non-limiting embodiments or aspects, different from basic C&CG and Variant 1, Variant 2 dynamically generates both optimality conditions characterizing non-trivial scenarios in a parametric way and their associated recourse problems. Hence, we also refer to this variant as parametric C&CG method.

Similar to Proposition 19, the next result follows directly from the fact that [symbol] and [symbol] reduce to fixed sets when [symbol] (x) is DIU. By using any points in those sets to populate cutting sets (hence eliminating [symbol] and), Equations (32) and (33) reduce to cutting sets of basic C&CG exactly. Indeed, we can treat Variant 2 as an algebraic generalization of basic C&CG.

Proposition 26. When uncertainty set [symbol] (x)= [symbol] for all x∈X, Variant 2 reduces to basic CÉCG presented in Zeng and Zhao (2013).

Analogous to the comparison between basic C&CG and Benders-dual methods for 2-Stg RO with DIU, Variant 2 generally produces stronger lower bounds in its executions.

Proposition 27. Assume that the same sets [symbol] ⊆ [symbol] and [symbol] ⊆ [symbol] have been included for defining sets [symbol] and [symbol] in both MP1 and MP2. Then, the optimal value of MP1 is an underestimation of that of MP2.

Proof. See its proof in Appendix A.2.
In some non-limiting embodiments or aspects, this new variant 2 presents a few improvements that have practical significance.
(i) Unified cutting sets: basic C&CG can unify both optimality and feasibility cutting sets into the same form. Variant 2 also has this property. Given that [symbol] (x, γ*)∈ [symbol] (x) for an extreme ray γ* of Ð, it is feasible to augment (33) with η≥c₂y^{γ*}, which is then of the same form as Equation (32). Hence, optimality and feasibility cutting sets are unified into the same structure, and we can simply generate variables and constraints as those in Equation (32) for every identified extreme point or ray of Π. Because it might lead to stronger lower bounds without extra computational overhead, unless noted explicitly, Variant 2 adopts the unified cutting set as its default.
(ii) Fast computational performance: Compared to Variant 1, Variant 2 demonstrates a superior capacity in computing complex instances. As shown in our numerical studies presented in Section 5, Variant 2 is generally a few orders of magnitude faster than Variant 1. We believe that such a huge difference is related to and generalizes what we have observed between Benders-dual and basic C 8CG methods, given that Variants 1 and 2 reduce to them respectively when the involved uncertainty set is DIU.
(iii) Lower bound insensitive to big-M: As the algorithm proceeds, MP2 may have many complementarity constraints (in the case of KKT conditions based) or bilinear constraints (in the case of primal-dual based) in [symbol] and [symbol] representations. As mentioned earlier, those nonlinear constraints can often be linearized using binary variables and big-M technique. We usually have some concern on the choice of big-M coefficient, since if it is not large sufficiently we will have a local optimal solution that disqualifies the corresponding value of MP2 as a lower bound. Nevertheless, this is not the case. Regardless of the value of big-M parameter, we have [symbol] (x, π)∈ [symbol] (x) and [symbol] (x, γ)∈ [symbol] (x) for all π and γ, which renders the optimal value of MP2 a valid lower bound to 2-StgRO all the time. Hence, it can be seen that MP2 is less sensitive to the choice of big-M.
(iv) A flexible platform to include non-trivial scenarios parametrically: Note that π and γ just serve as criteria to introduce some critical scenarios parametrically, through [symbol] and [symbol] . They do not directly affect η or the feasibility of MP2. So, in addition to exactly being extreme points or extreme rays of Π, they can be derived by domain expertise or heuristics, or even take values out of Π, which offers a great flexibility for us to incorporate any useful knowledge. As demonstrated, this improvement can be utilized to achieve a strong result on the iteration complexity or a fast computation.

### Convergence and Complexity

According to roles of sets [symbol] and [symbol] and by adopting the same idea presented in the proof of Theorem 20, the convergence result of Variant 2 can be obtained easily.

Theorem 28. Suppose TOL=0. When terminates, Variant 2 either reports that 2-StgRO in (1) is infeasible, or converges to its optimal value and exact solution.

Similar to Corollary 21 and Proposition 22, next results simply follow. Corollary 29. The number of iterations of Variant 2 before termination is bounded by (| [symbol] |+| [symbol] |), i.e., Kₚ+Kᵣ. Hence, the algorithm is of

$$O ( ( \begin{matrix}{n}_{y} + {μ}_{y} \\ {μ}_{y}\end{matrix} ) )$$

iteration complexity.

Proposition 30. If x* is an optimal solution to MP2 in both iterations t₁ and t₂ with t₁<t₂, we have LB=UB in iteration t₂ and x* is optimal to 2-StgRO. Hence, if X is a finite discrete set, the number of iterations of Variant 2 is bounded by |X|.
(i) As those convergence and complexity results are primarily derived by making use of Ð's fixed polyhedral structure, they generally hold for [symbol] (x) with both RHS and LHS dependence, as well as with more complex convex structure.
(ii) Given the strong theoretical and computational performance of basic CESCG in computing DIU-based RO, it is desirable to theoretically prove that Variant 2 generalizes it in the context of DDU. Nevertheless, regardless of the fact that Variant 2 reduces to basic CECG if the underlying uncertainty set becomes DIU, such reduction connection is not reflected in the aforementioned complexity result. One essential reason is that, unlike a fixed DIU set, [symbol] (x) changes with respect to x and its structure becomes indeterminate. Hence, the classical extreme point/ray based analyses are not applicable to [symbol] (x).

Nevertheless, we would like to mention that a core LP concept, i.e., “basis”, can be utilized as a powerful tool with regard to an indeterminate structure. Specifically when the DDU set is with RHS dependence, it helps us obtain more general and stronger iteration complexity for Variant 2. Indeed, it ensures the convergence and bounds the complexity even if the recourse problem is beyond the linear program exhibited in (1).

Let [symbol] denote a basis of LP(x, β) defined in (19), and [symbol] contains all variables not in [symbol] . Note that its feasible set [symbol] (x) is parameterized by x in its RHS, while bases are independent of x and β. According to the theory of LP, a basis corresponds to a basic solution (BS), and if feasible, a basic feasible solution (BFS) that is an extreme point of underlying polyhedron [symbol] (x). Following the literature on LP, we assume that all rows of F are linearly independent. Next, we present a result regarding a basis and [symbol] (x).

Lemma 31. Consider LP(x⁰, β) for a fixed β, and suppose that basis [symbol] is an optimal basis, i.e., its BS with respect to [symbol] (x⁰) is a BFS and an optimal solution. If [symbol] 's BS with respect to [symbol] (x¹) is feasible, i.e., a BFS, it is also optimal to LP(x¹, β). Moreover, if [symbol] yields the unique optimal solution to LP(x⁰, β), it also yields the unique one to LP(x¹, β).

Then, as shown in the following, we can make use of bases to terminate Variant 2. Without loss of generality, we assume that the oracle computing MP2 returns BFS for sets [symbol] (x, π) and [symbol] (x, γ) (i.e., extreme point solutions of [symbol] (x)) as well as the associated optimal bases (or arbitrary one(s) when degeneracy exists). Additionally, let [symbol] denote the set of bases obtained from all [symbol] and [symbol] sets in computing MP2 in t-th iteration.

Lemma 32. If [symbol] = [symbol] with t₁<t₂, Variant 2 terminates, and x¹, an optimal solution to MP2 in t₁-th iteration, is optimal to 2-Stg RO.

In some non-limiting embodiments or aspects, total number of bases of LP(x, β) is finite and bounded by

$$( \begin{matrix}{n}_{u} + {μ}_{u} \\ {μ}_{u}\end{matrix} )$$

with μᵤ denoting the number of rows of matrix F. Hence, by enumerating all combinations of bases, which is up to

$${2}^{( {u}^{{n}_{u} + {μ}_{u}} )} ,$$

the following result can be derived from Lemma 32 easily.

Proposition 33. Variant 2 either reports that 2-Stg RO is infeasible, or converges to its optimal value and solution in a finite number of iterations, which is bounded by 2⁽ⁿ^{ᵤ}^{μ}^{ᵤ}⁾_{μ}_{ᵤ}). Hence, the algorithm is of (2(nᵤ+μᵤ)) iteration complexity.
i) Because of Corollary 29 and Propositions 30 and 33, it is straightforward to conclude that Variant 2's iteration complexity is of

$$O ( min \{ ( \begin{matrix}{n}_{y} + {μ}_{y} \\ {μ}_{y}\end{matrix} ) , {2}^{( \begin{matrix}{n}_{u} + {μ}_{u} \\ {μ}_{u}\end{matrix} )} \} ) or O ( min \{ ( \begin{matrix}{n}_{y} + {μ}_{y} \\ {μ}_{y}\end{matrix} ) , {2}^{( \begin{matrix}{n}_{u} + {μ}_{u} \\ {μ}_{u}\end{matrix} )} , \vert 𝒳 \vert \} )$$

when X is a finite discrete set.
(ii) The significance of Proposition 33 lies in that it guarantees the finite convergence by [symbol] (x), instead of the recourse problem (or its dual problem). It supports us to handle more complex recourse problems. For example, an SOC program, whose dual problem is again an SOC program, may have infinite number of extreme points. By Proposition 33, Variant 2 solves 2-Stg RO with an SOC recourse problem in finite iterations.

In some non-limiting embodiments or aspects, iteration complexity results altogether establish the finite convergence of Variant 2 for a broad class of two-stage RO. Nevertheless, neither Corollaries 29 nor Proposition 33 generalizes the iteration complexity result of basic C&CG when handling DIU sets. Because of the connection between basis and extreme point, we believe that basis is the right tool and deserves a deeper study in the context of two-stage RO. Indeed, it helps us modify Variant 2 a little bit so that it comprehensively generalizes basic C&CG in both operations and computational complexity.

### 3.2.4 Modifying Variant 2 to Achieve a Stronger Performance

In the context of linear program, basis and extreme point are rather identical unless degeneracy exists. With the indeterminate structure of [symbol] (x), they become very different and basis turns out to be a more powerful and flexible toliin the following, we consider a special situation which perfectly demonstrates the strength of this concept in helping us understand Variant 2's theoretical performance. To facilitate our derivation, we include the following additional operation in Variant 2 between (i) and (ii) for both cases in Step 4, and number it by (i.a):
(i.a) compute LP(x*, π*) (or LP(x*, γ*), respectively) with an optimal BFS and the associated basis [symbol] .

Note that

$${u}_{s}^{*}$$

obtained from computing SP2 is clearly optimal to this linear program but is not necessarily identical to this BFS. We mention that this additional operation does not change the behavior of the algorithm except for providing information on [symbol] for our proof. Also, recall that Variant 2 adopts the unified cutting sets as its default implementation.

Proposition 34. Assume that LP(x, ⋅) always has a unique optimal solution in the execution of Variant 2 (with operation (i.a)), which is referred to as the unique optimal solution (or “uniqueness” for short) property. Then, the number of iterations before termination is bounded by the number of bases of LP(x, ⋅), which is of

$$O ( ( \begin{matrix}{n}_{u} + {μ}_{u} \\ {μ}_{u}\end{matrix} ) ) .$$

With the connection between bases and extreme points, this result clearly generalizes and is comparable to the previous one developed for basic CC&G with respect to DIU. Certainly it may be of a great interest if the uniqueness assumption can be dropped. Note that this property is only necessary to ensure that a previously derived basis contributes its BFS in MP2 in the iteration whenever it is contained in [symbol] or [symbol] again, which therefore renders LB=UB. Indeed, by a very classical result stated in the following, this property always holds if we make simple modifications on LP(x, ⋅)—for any extreme point of a polyhedron (e.g., [symbol] (x)), there is a linear objective function to which this point is uniquely optimal (Nemhauser and Wolsey, 1988).

Our basic idea is to slightly modify the objective function coefficients of LP(x, ⋅) according to reduced costs to achieve the uniqueness property. Note that if some non-basic variable(s) has zero reduced cost (such information is always available after an optimal BFS and the associated optimal basis [symbol] are provided), it indicates the existence of multipleoptimal BFSs. We can make simple changes in (x, ⋅)'s objective function to eliminate occurrence of that situation, which ensures that [symbol] 's BS is uniquely optimal. The updated objective function will then be used to define set [symbol] or [symbol] , respectively, which is denoted by [symbol] or [symbol] to highlight the difference. By Lemma 31, [symbol] 's BS is the only solution in [symbol] (or [symbol] , respectively) whenever it is a BFS. Detailed modifications are available in Appendix A.3, and we refer to this modified version as the modified Variant 2.

Using an argument similar to that of Proposition 34, we can easily show that the modified Variant 2 has a desirable iteration complexity whenever [symbol] (x) is with RHS dependence.

Proposition 35. The number of iterations of the modified Variant 2 before termination is bounded by the number of bases of LP(x, ⋅), which is of

$$O ( ( \begin{matrix}{n}_{u} + {μ}_{u} \\ {μ}_{u}\end{matrix} ) ) .$$

Remark 14. Proposition 35 and associated derivations present several new insights.
(i) When the modifications on the objective function coefficients of LP(x, ⋅) is sufficiently small, it can be seen that [symbol] (x, ⋅)⊆ [symbol] (x, ⋅) (or [symbol] ⊆ [symbol] (x, ⋅), respectively) for all x∈X, i.e., it does not expand to include a new BFS. This result ensures that the modified Variant 2 also inherits Variant 2's complexity result described in Corollary 29. So, the modified Variant 2's iteration complexity is of

$$O ( min \{ ( \begin{matrix}{n}_{y} + {μ}_{y} \\ {μ}_{y}\end{matrix} ) , ( \begin{matrix}{n}_{u} + {μ}_{u} \\ {μ}_{u}\end{matrix} ) \} ) or O ( min \{ ( \begin{matrix}{n}_{y} + {μ}_{y} \\ {μ}_{y}\end{matrix} ) , ( \begin{matrix}{n}_{u} + {μ}_{u} \\ {μ}_{u}\end{matrix} ) , \vert 𝒳 \vert \} )$$

when X is a finite discrete set. We can further conclude that, because of the connection between bases and extreme points, the modified Variant 2 extends and generalizes basic C&CG in both aspects, i.e., the operations and computational complexity.
(ii) It is worth highlighting the basis based analysis approach, which we believe is a rather novel application of the “basis” concept from LP theory. In addition to using it for analysis, we are inspired to develop another variant of CGCG in the following subsection, which explicitly makes use of bases within its operations.
(iii) The reduced cost based modifications involve some operation, i.e., obtaining the associated optimal basis after solving an LP, that is not supported by current professional solvers. This situation clearly imposes a technical difficulty in implementation. Also, those modifications require non-trivial operations. Nevertheless, in practice we often have structural insights that can help to implement the modified Variant 2 without performing those operations. A demonstration on the reliable p-median problem is presented in Section 4.3. We observe that on uncapacitated instances the modified version dominates the standard Variant 2 with a clear advantage.

### 3.3 The Third Variant: Generating Bases by C&CG

The concept of basis and related methodology lay the foundation of Simplex algorithm in LP, which is theoretically elegant and practically fast. In the previous subsection, we also adopt them to develop a set of new convergence and complexity analyses for Variant 2. It may be interesting to design some algorithm that directly makes use of bases and other powerful LP tools to achieve a strong performance. This idea is investigated in this subsection. Before presenting our results, we assume in this subsection that the oracle solving linear programs always returns both an optimal BFS and the associated basis.

### 3.3.1 Another Single-Level Reformulation Through Basis Enumeration

Consider an extreme point and the associated basis [symbol] of LP(x, β) defined in (19) for a given x∈X. Based on [symbol] (and its complement [symbol] ) we can always rewrite and reorganize constraints of [symbol] (x) in the following form, where equality constraints correspond to those whose slack variables are in [symbol] and inequality constraints represent the remaining ones, and u [symbol] and [symbol] denote the subvectors consisting of uⱼ with i∈ [symbol] and i∈ [symbol] respectively. For the purpose of simplicity, we do not explicitly list slack variables, noting that they either are provided or can be inferred easily according to the context. Let [symbol] ( [symbol] , x) denote this singleton as in the following, noting that its only element is that extreme point.

$$ℬ𝒮 ( 𝔅 , x ) = \{ \begin{matrix}{F}_{ℜ} ( x ) u = {h}_{ℜ} + {G}_{ℜx} \\ {F}_{𝔅} ( x ) u \leq {h}_{𝔅} + {G}_{𝔅} x \\ {u}_{𝔅} \geq 0 , {u}_{ℜ} = 0\end{matrix} \} \qquad ( 34 )$$

Because of the connection between extreme points and bases and Proposition 6, it is anticipated that we can enumerate all such bases of [symbol] (x) to convert 2-StgRO into a single-level optimization model as those in (21) and (31). Previous approaches employ optimization problems (equivalently their optimality conditions) to elicit critical scenarios, whose validity holds regardless of the particular realization of parameterized set [symbol] (x). Nevertheless, directly utilizing an explicit and fixed basis in algorithm design is technically more challenging. Note that the change of x may alter [symbol] (x) drastically, especially when LHS dependence presents, i.e., constraint matrix F is a function of x. Next, we give a simple [symbol] (x) as in the following to show this challenge, where u^{s} represents slack variables and

$$F ( x ) = [ \begin{matrix}{f}_{11} & {f}_{12} \\ {f}_{21} & {f}_{22}\end{matrix} ]$$

is a function of the first-stage decision x.

$${f}_{11} {u}_{1} + {f}_{12} {u}_{2} + {u}_{1}^{s} = 3$$

$${f}_{21} {u}_{1} + {f}_{22} {u}_{2} + {u}_{2}^{s} = 5$$

$${u}_{1} \geq 0 , {u}_{2} \geq 0 , {u}_{1}^{s} \geq 0 , {u}_{2}^{s} \geq 0$$

Assume that for some x⁰ we have

$$F ( {x}^{0} ) = \begin{matrix} \\ \end{matrix} [ \begin{matrix}2 & 1 \\ 1 & 2\end{matrix} ] .$$

Considering basis [symbol] ={u₁,u₂}, we have

$$ℬ𝒮 ( {𝔅}^{0} , {x}^{0} ) = \{ ( \frac{1}{3} , \frac{7}{3} ) \} ,$$

an extreme point solution. If x¹ renders

$$F ( {x}^{1} ) = [ \begin{matrix}1 & 1 \\ 1 & 1\end{matrix} ] ,$$

note that [symbol] (x¹) is not empty. Nevertheless, if rewriting the whole system with respect to [symbol] , we have

$$ℬ𝒮 ( {𝔅}^{0} , {x}^{1} ) = \{ \begin{matrix}{u}_{1} + {u}_{2} = 3 \\ {u}_{1} + {u}_{2} = 5 \\ {u}_{1} \geq 0 , {u}_{2} \geq 0\end{matrix} \}$$

which is simply empty (i.e., infeasible). Hence, if (34) with [symbol] , i.e., {f₁₁u₁+f₁₂u₂=3, f₂₁u₁+f₂₂2u₂=5, u₁≥0, u₂≥0}, is imposed as constraints on X, x¹ will be eliminated from X. However, it should not be the case given that [symbol] (x¹) is meaningful.

The aforementioned situation actually can be detected by applying one core result for the system of linear inequalities, i.e., Theorem of Alternatives (Boyd et al., 2004). In the following, we present a variant of this theorem tailored for (34), where [symbol] and [symbol] are simplified to [symbol] and [symbol] , respectively, after removing columns associated with [symbol] .

Lemma 36 (e.g., Theorem of Alternatives) One and only one of the following two statements holds: either 0=max {0: u∈ [symbol] ( [symbol] , x)}min{( [symbol] + [symbol] x)^{T} [symbol] + [symbol] x)^{T} [symbol] : [symbol] (x)^{T} [symbol] + [symbol] (x)^{T} [symbol] ≥0, [symbol] ≥0}, or the preceding maximization problem is infeasible and the minimization problem is unbounded.

Next, we discuss son changes to achieve the computational feasibility of directly using bases. Let [symbol] denote the collection of possible bases of LP(x, ⋅), and for [symbol] ∈ [symbol] , we extend [symbol] to [symbol] as in the following. We mention that with additional variables (ū¹, ū², ū³), which are 3 vectors of appropriate dimensions, [symbol] ( [symbol] , x) is not empty for x∈X.

$$\overline{ℬ𝒮} ( 𝔅 , x ) = \{ \begin{matrix}{\hat{F}}_{ℜ} ( x ) {u}_{𝔅} = {h}_{ℜ} + {G}_{ℜ} x + {\overline{u}}^{1} - {\overline{u}}^{2} \\ {\hat{F}}_{ℜ} ( x ) {u}_{𝔅} = {h}_{𝔅} + {G}_{𝔅} x + {\overline{u}}^{3} \\ {u}_{𝔅} \geq 0 , {\overline{u}}^{j} \geq 0 , j = 1 , 2 , 3\end{matrix} \} \qquad ( 35 )$$

By mainly taking advantage of Lemma 36 and enumeration of bases in [symbol] , we next show that 2-Stg RO can be converted into a new single-level formulation.

Theorem 37. Formulation 2-Stg RO in (1) (and its equivalences) is equivalent to a sing-level optimization program as in the following.

$$2 - StgRO ( 𝔹 ) : w *= {minc}_{1} x + η \qquad ( 36 a )$$

$$s . t . x ∈ 𝒳 \qquad ( 36 b )$$

$$\{ η \geq {c}_{2} y + M ( {1}^{⊤} {\overline{u}}^{1} + {1}^{⊤} {\overline{u}}^{2} + {1}^{⊤} {\overline{u}}^{3} ) \qquad ( 36 c )$$

$$+ {( {h}_{ℜ} + {G}_{ℜ} x )}^{⊤} {λ}_{ℜ} + {( {h}_{𝔅} + {G}_{𝔅} x )}^{⊤} {λ}_{𝔅} \qquad ( 36 c )$$

$$( u , {\overline{u}}^{1} , {\overline{u}}^{2} , {\overline{u}}^{3} ) ∈ \overline{ℬ𝒮} ( ℬ , x ) \qquad ( 36 ∼ d )$$

$${\hat{F}}_{ℜ} {( x )}^{⊤} {λ}_{ℜ} + {{\hat{F}}_{𝔅} ( x )}^{T} {λ}_{𝔅} \geq 0 , {λ}_{ℜ} \geq 0 \qquad ( 36 e )$$

$$y ∈ 𝒴 ( x , u ) \} ∀ 𝔅 ∈ 𝔹 \qquad ( 36 f )$$

In some non-limiting embodiments or aspects, compared to the previous two single-level reformulations, 2-StgRO( [symbol] ) seems to have a relatively simpler structure, given that there are no complex optimality conditions involved. As noted earlier, bases and extreme points of a polyhedron are directly connected. So, 2-StgRO( [symbol] ) should reduce to (11) of Corollary 7 when [symbol] (x)= [symbol] for all x. Actually, except the infeasible bases it is the case according to the proof of Theorem 37. Hence, 2-Stg RO( [symbol] ) can be treated as an algebraic generalization of (11).

Similar to Corollaries 16 and 25, we derive a relaxation to −StgRO( [symbol] ) (and therefore to 2-Stg RO) based on partial enumeration.
Corollary 38. Consider set [symbol] ⊆ [symbol] and denote formulation (36) defined with respect to [symbol] by 2-StgRO( [symbol] ). Then, 2-StgRO( [symbol] ) is a relaxation to 2-StgRO( [symbol] ) (and 2-Stg RO in (1)). And the optimal value of 2-StgRO( [symbol] ) is smaller than or equal to w*.

### 3.3.2 Variant 3: Basis Based C&CG and Analysis

Theorem 37 and Corollary 38 naturally yield a foundation to develop our third variant of C&CG. Similar to the case of Variant 2, we describe it by specifying modifications on top of Variant 1 to minimize repetition. Also, we simply adopt the unified cutting sets for all identified bases, in spite of they are derived due to optimality or feasibility reasons.

Master Problem Throughout the algorithm, MP1 is replaced by the next one. Recall that [symbol] is uniquely defined for any fixed [symbol] .

$$\begin{matrix}MP 3 : \underline{w} = & min {c}_{1} x + η \\ & s . t . x ∈ 𝒳\end{matrix}$$

$$η \geq {c}_{2} {y}^{ℬ} + M ( {1}^{⊤} {\overline{u}}_{ℬ}^{1} + {1}^{⊤} {\overline{u}}_{ℬ}^{2} + {1}^{⊤} {\overline{u}}_{ℬ}^{3} ) + {( {h}_{ℜ} + {G}_{ℜ x} )}^{⊤} {λ}_{ℜ} + {( {h}_{ℬ} + {G}_{ℬ} x )}^{⊤} {λ}_{ℬ} ∀ ℬ ∈ \hat{𝔹}$$

$${\hat{F}}_{ℜ} ( x ) {u}_{ℬ} = {h}_{ℜ} + {G}_{ℜ} x + {\overline{u}}_{ℬ}^{1} - {\overline{u}}_{ℬ}^{2} ∀ ℬ ∈ \hat{𝔹}$$

$${\hat{F}}_{ℬ} ( x ) {u}_{ℬ} \leq {h}_{ℬ} + {G}_{ℬ x} + {\overline{u}}_{ℬ}^{3} ∀ ℬ ∈ \hat{𝔹}$$

$${{F}_{ℜ} ( x )}^{⊤} {λ}_{ℜ} + {{F}_{ℬ} ( x )}^{⊤} {λ}_{ℬ} \geq 0 ∀ ℬ ∈ \hat{𝔹}$$

$${B}_{2} {y}^{ℬ} \geq d - {B}_{1} x - E {u}_{ℬ} ∀ ℬ ∈ \hat{𝔹}$$

$${u}_{ℬ} \geq 0 , {\overline{u}}_{ℬ}^{j} \geq 0 , j = 1 , 2 , 3 , {λ}_{ℜ} \geq 0 , {y}^{ℬ} \geq 0 ∀ ℬ ∈ \hat{𝔹}$$

Cutting Sets: For every [symbol] identified by computing subproblems, we generate and incorporate a replicate of recourse problem (including recourse variables and constraints) to MP3. Specifically, we modify Step 4[Case A] as in the following.
(i) compute SP2 in (25) to derive ηₛ(x*), uₛ* and corresponding extreme point π* of Ð; (i.a) compute LP(x*, π*) with an optimal BFS and its associated basis [symbol] ; (ii) update [symbol] = [symbol] ∪{ [symbol] } and augment master problem MP3 accordingly, i.e., create variables [symbol] ,

$${u}_{{ℬ}^{*}}^{j} , j = 1 , 2 , 3 , {λ}_{{ℜ}^{*}} , {λ}_{{ℬ}^{*}}$$

and [symbol] and add following constraints to MP3.

$$η \geq {c}_{2} {y}^{{ℬ}^{*}} + M ( {1}^{⊤} {\overline{u}}_{{ℬ}^{*}}^{1} + {1}^{⊤} {\overline{u}}_{{ℬ}^{*}}^{2} + {1}^{⊤} {\overline{u}}_{{ℬ}^{*}}^{3} ) + {( {h}_{{ℜ}^{*}} + {G}_{{ℜ}^{*} x} )}^{⊤} {λ}_{{ℜ}^{*}} + {( {h}_{{ℬ}^{*}} * + {G}_{{ℬ}^{*} x} )}^{⊤} {λ}_{{ℬ}^{*}}$$

$${\hat{F}}_{{ℐ}^{*}} ( x ) {u}_{{ℬ}^{*}} = {h}_{{ℐ}^{*}} + {G}_{{ℜ}^{*} X} + {\overline{u}}_{{ℬ}^{*}}^{1} - {\overline{u}}_{{ℬ}^{*}}^{2}$$

$${{\hat{F}}_{{ℜ}^{*}} ( x )}^{⊤} {λ}_{{ℜ}^{*}} + {{F}_{{ℬ}^{*}} ( x )}^{⊤} {λ}_{{ℬ}^{*}} \geq 0$$

$${B}_{2} {y}^{{ℬ}^{*}} \geq d - {B}_{1} x - {E}_{{ℬ}^{*}}$$

$${u}_{{ℬ}^{*}} \geq 0 , {\overline{u}}_{{ℬ}^{*}}^{j} \geq 0 , j = 1 , 2 , 3 {λ}_{{ℜ}^{*}} \geq 0 , {y}^{{ℬ}^{*}} \geq 0$$

For operations in Step 4 [Case B], almost same modifications will be made, except that (i.a) is changed to “compute LP(x*, γ*) with an optimal solution and the associated basis [symbol] . Note that the feasibility cutting set in (29) is replaced by the unified cutting set (37) defined with respect to this identified [symbol] .

When [symbol] (x)= [symbol] for all x∈X, the next result naturally follows, noting that all bases generated in the execution of Variant 3 are just extreme points of [symbol] .

Proposition 39. When uncertainty set [symbol] (x)= [symbol] for all x∈X, Variant 3 reduces to basic CECG presented in Zeng and Zhao (2013).

In the following, we provide the convergence and iteration complexity results of Variant 3. Similar to Proposition 34, they can be easily proven by arguing that the algorithm converges if a particular basis is identified more than once.

Theorem 40. Suppose TOL=0. When terminates, Variant 3 either reports that 2-StgRO in (1) is infeasible, or converges to its optimal value and exact solution.
Corollary 41. Variant 3 is of

$$O ( ( \begin{matrix}{n}_{u} + {μ}_{u} \\ {μ}_{u}\end{matrix} ) )$$

iteration complexity.
(i) Since 2-StgRO( [symbol] ) is an algebraic generalization of the extreme point based reformulation in (11), Variant 3 is clearly an algebraic generalization of basic CECG. As it is built upon bases, we also refer to Variant 3 as basis based CB°G method. Note that, compared to Variant 2, Variant 3 is rather a static generalization.
(ii) Variant 3 demonstrates a theoretically strong iteration complexity regardless of LHS or RHS. It is clearly desired as this iteration complexity actually is comparable to and generalizes that of basic CECG. Nevertheless, in our numerical study, its computational performance is not as good as that of Variant 2. One primary reason is the complex constraints with big-M and bilinear terms introduced in (36c).
(iii) As noted earlier, an additional technical difficulty is that current professional MIP solvers do not pr ovide optimal basis when they report optimal solution, although we might be able to infer this information according to variables' values in an optimal solution. Indeed, it is often the case that we cannot single out a specific basis, as multiple bases may be optimal. If it occurs in our algorithm implementation, we simply include all those bases (i.e., their associated cutting sets in (37)) into MP3.

Given Variant 3's nice theoretical properties, we still believe that it deserves further studies and deep analyses, especially stronger and better integration with MIP solvers. Moreover, generalizing extreme points to either bases or sets of optimal solutions (as in Variant 2) provides a higher level abstraction and may inspire new strategies to handle problems with indeterminate structures. Hence, we anticipate that more sophisticated algorithm designs will be developed in this line of research.

### 3.4 Computing Complex Two-Stage RO Formulations

In some non-limiting embodiments or aspects, basic C&CG and variants developed in this section are rather general computing schemes. When the utilized oracle for master and subproblems is powerful, they can be called to compute complex nonlinear two-stage RO formulations beyond the linear one in the form of Equation (1).

Regarding the feasible set for the first-stage decision, i.e., X, it does not need to be a linear MIP set for any of three variants. It actually can be more complex sets, as long as master problems can be solved exactly. For example, X can be a mixed integer SOC set or a mixed integer bilinear set, given that they are supported by commercial solvers. As for the recourse problem, we can employ convex programs whose optimality conditions are supported by some oracles. For example, the recourse problem can be an SOC formulation with the strong duality. By replacing the recourse problem with its dual problem, we then can convert a max−min subproblem into a max formulation, which is directly computable by some commercial solvers. As for the uncertainty set, as Variant 3 depends on the concept of basis and related mathematical representation, it is restricted to a polyhedral DDU set. For the other two, the uncertainty set can be a set of convex program whose optimality conditions are friendly to existing oracles. Moreover, we can bound the iteration complexity of those algorithms according to the context and by using some of the following structural information, i.e., the cardinality of X if it is finite, the extreme points and rays of D if the recourse problem is an LP, and the bases of LP(x) if [symbol] (x) is a polyhedron.

For two-stage RO models with SOC recourse problem (and SOC uncertainty set, respectively), we present detailed algorithm operations using the scheme of Variant 2 in Appendix A.4. In Section 5.5, we consider two such formulations and perform a small computational study by taking advantage of a professional solver's solution capacity on mixed integer SOC programs. It is observed that the numbers of iterations for those complex two stage RO models are roughly same as those for their linear counterparts. Nevertheless, much longer computational time is needed for those models, which indicates the great challenge imposed by their nonlinear structures.

Before closing this section, we mention that, similar to the study in An and Zeng (2015), those new C&CG variants can solve, with little change, risk constrained two-stage RO with DDU, where risk constraint(s) in the form of max_{u∈} [symbol] ₍ₓ₎min{c₂y:y ∈ [symbol] (x,u)}≤b₀ is appended to X. Also, the underlying sets X, [symbol] (x) and [symbol] (x,u) can take the form of the aforementioned complex structures, and can be exactly handled.

### Mixed Integer DDU

In some non-limiting embodiments or aspects, mixed integer structure improves a modeling capacity of DDU. For example, a connection between the first-stage decision and behavior of the random factor (e.g., which may be impossible to be described by any convex DDU set, etc.) may be determined by employing discrete, binary, continuous variables, and/or the like. A mixed integer DDU set may be complex to analyze and compute. In such an example, the number of discrete variables needed to describe [symbol] (x) may be reduced. In some further examples, discrete variables may be eliminated from [symbol] (x).

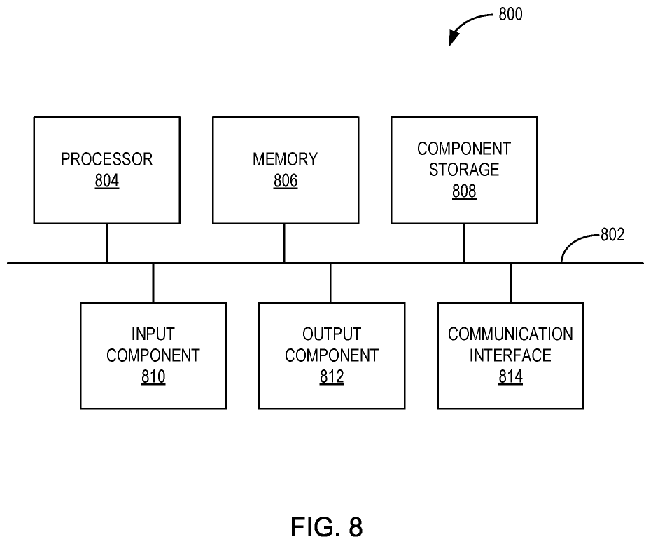

For example, with reference to FIG. 8, consider the uncertainty set depicted that is a function of x, which is represented by the following formulation:

$$( 5 a )$$

$$𝒰 ( x ) = \{ ( {u}_{c} , {u}_{d} , t , {\tilde{g}}_{1} , {\tilde{g}}_{2} ) : {\tilde{g}}_{1} = {\sum }_{j = 0}^{3} {g}^{1} ( {x}^{j} ) {t}_{j} ; {\tilde{g}}_{2} = {\sum }_{j = 0}^{3} {g}^{2} ( {x}^{j} ) {t}_{j} ; x = {\sum }_{j = 0}^{3} {x}^{j} {t}_{j} ;$$

$${\tilde{g}}_{1} \leq {u}_{c} \leq {\tilde{g}}_{2} ; {t}_{0} \leq {u}_{d , 1} ; {t}_{j} \leq {u}_{d , j} + {u}_{d , j + 1} , j = 1 , 2 ; {t}_{3} \leq {u}_{d , 3} ; \qquad ( 5 b )$$

$${\sum }_{j = 1}^{3} {u}_{d , j} = 1 ; {\sum }_{j = 0}^{3} {t}_{j} = 1 ; {u}_{d , j} ∈ \{ 0 , 1 \} , j = 1 , 2 , 3 ; {t}_{j} \geq 0 , j = 0 , 1 , 2 , 3 \} \qquad ( 5 c )$$

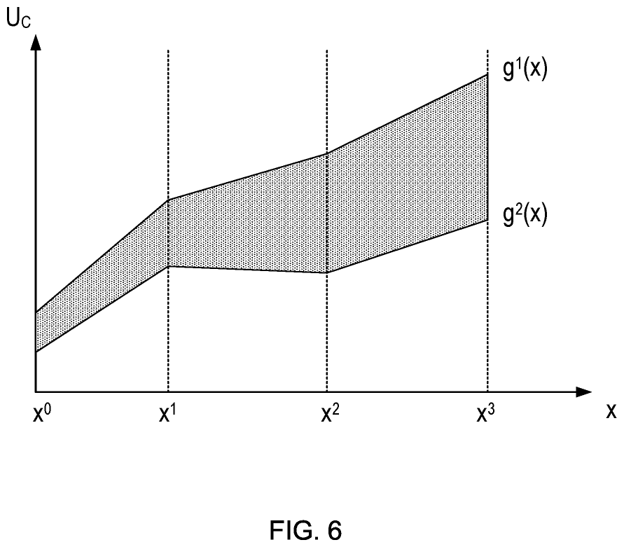

In some non-limiting embodiments or aspects, with further reference to FIG. 6, the DDU set is bounded by two piece-wise linear functions (i.e., g¹(x) and g²(x)) Although (u_{d}, t, \tilde{g}₁, \tilde{g}₂) is not part of the first-stage decision, it can be seen that (u_{d}, t, \tilde{g}₁, \tilde{g}₂) is uniquely determined by x. Under such an example, x may be augmented with (u_{d}, t, \tilde{g}₁, \tilde{g}₂) (e.g., annex all constraints, except \tilde{g}₁≤u_{c}<\tilde{g}₂, to X, etc.). In some examples, DDU set [symbol] (x)={\tilde{g}₁≤\tilde{g}₂} is a simpler set from which an equivalent may be obtained, with much less complexity, and therefore more efficiently than it may be obtained from a 2nd-stage RO. In some examples, if variables (e.g., especially discrete ones, etc.) may be uniquely determined by x, they may then also be safely moved from [symbol] (x) to X. In such a case, this result is formalized by rewriting u as (u₀, u₁), assuming that those sub-vectors may contain continuous or/and discrete variables.

In some non-limiting embodiments or aspects, for Proposition 3, suppose that:

$$𝒰 ( x ) = \{ ( {u}_{0} , {u}_{1} ) ∈ ( {ℝ}_{+}^{{n}_{u}^{0}} \times {𝕌}_{{d}_{0}} ) \times ( {ℝ}_{+}^{{n}_{u}^{1}} \times {𝒰}_{{d}_{1}} ) : {u}_{0} = \tilde{f} ( x ) , {F}_{0} ( x ) {u}_{0} + {F}_{1} ( x ) {u}_{1} \leq h + Gx \} ,$$

where \tilde{f}(x) returns a unique value for u₀ for any fixed x. In such an example, 2-StgRO in equation (1) is equivalent to the following two-stage RO formulation:

$${min}_{x ∈ 𝒳 , {u}_{0} = \tilde{f} ( x )} {c}_{1} x + {max}_{{u}_{1} ∈ {𝒰}_{1} ( x , {u}_{0} )} {min}_{( {y}_{c} , {y}_{d} ) ∈ 𝒴 ( x , u )} {c}_{2} y where$$

$${𝒰}_{1} ( x , {u}_{0} ) = \{ {u}_{1} ∈ {ℝ}_{+}^{{n}_{u}^{1}} \times {𝕌}_{{d}_{1}} : {F}_{1} ( x ) {u}_{1} \leq h + Gx - {F}_{0} ( x ) {u}_{0} \} .$$

In the above example, even if \tilde{f}(x) does not exist or is not known, together with Corollary 1, a nontrivial relaxation is made by augmenting x with u and adopting [symbol] ₁(x, u₀) as the DDU set.

In such an example, Corollary 4 below follows. For example, Let

$${u}_{1}^{′}$$

be a replicate of u₁. We then have:

$${w}_{R} \leq {w}_{( {u}_{0} , {u}_{1} )} ≡ {min}_{x ∈ 𝒳 , ( {u}_{0} , {u}_{1}^{′} ) ∈ 𝒰 ( x )} {c}_{1} x + {max}_{{u}_{1} ∈ {𝒰}_{1} ( x , {u}_{0} )} {min}_{( {y}_{c} , {y}_{d} ) ∈ 𝒴 ( x , {u}_{0} , {u}_{1} )} {c}_{2} y \leq {w}^{*} \qquad ( 6 )$$

$$and if {w}_{( {u}_{0} , {u}_{1} )} = + ∞ , so is {w}^{*} .$$

In some non-limiting embodiments or aspects, when one variable in a DDU set cannot be uniquely determined by x, it should not be relocated to X. For example, otherwise, the resulting formulation is generally a relaxation to the original 2-Stg RO. It is also interesting to compare two formulations: the aforementioned one for w that defines a lower bound to w*, and the one for w(⋅, [symbol] ᵣ(x), ⋅), which considers the continuous relaxation of [symbol] (x) and yields an upper bound for w*.

Two-Stage RO with Mixed Integer DDU Set

In some non-limiting embodiments or aspects, 2-StgRO is used with a mixed integer DDU set and a recourse problem in the form of linear program. For example, the derivation of computationally more friendly equivalences may be used with the development of a C&CG type of algorithm and its convergence analysis. According to Proposition 3, we assume without loss of generality that discrete variables in [symbol] (x) cannot be uniquely determined by the first-stage decision x.

### Enumeration Based Reformulations

In some non-limiting embodiments or aspects, a recourse problem is a linear program, with a dual problem for a given u, as defined below:

$$( 7 )$$

$$max \{ {( d - {B}_{1} x - E u )}^{⊤} π : {B}^{⊤} π \leq {c}_{2}^{⊤} , π \geq 0 \} = max \{ {( d - {B}_{1} x - E u )}^{⊤} π : π ∈ Π \}$$

$$where Π = \{ {B}^{⊤} π \leq {c}_{2}^{⊤} , π \geq 0 \} .$$

Let [symbol] be the set of extreme points and [symbol] the set of extreme rays of Π, respectively. Clearly, an optimal solution of Equation (7) belongs to [symbol] if it is finite, or it is unbounded following some direction in [symbol] . Next, we generalize a result with minor modifications from polytope [symbol] (x) to the case where it is a mixed integer set.

Theorem 4. Formulation for 2-StgRO in Equation (1) is equivalent to a bilevel linear optimization program in the following:

$$2 - StgRO ( {Ω}_{Π} ) : {w}^{*} = min {c}_{1} x + η \qquad ( 8 a )$$

$$s . t . x ∈ 𝒳 \qquad ( 8 b )$$

$$\{ η \geq {c}_{2} y , y ∈ 𝒴 ( x , u ) \qquad ( 8 b )$$

$$u ∈ arg max \{ {( - Eu )}^{⊤} π : u ∈ 𝒰 ( x ) \} \} ∀ π ∈ {𝒫}_{Π} \qquad ( 8 c )$$

$$\{ y ∈ 𝒴 ( x , v ) \qquad ( 8 c )$$

$$v ∈ arg max \{ {( - Ev )}^{⊤} γ : v ∈ 𝒰 ( x ) \} \} ∀ γ ∈ {ℛ}_{Π} \qquad ( 8 d )$$

Unlike the polytope case, with the mixed integer structure of [symbol] (x), the optimal solution set of the optimization problem in 8c) or 8d) cannot be represented by any known optimality conditions. For example, once the discrete variables are fixed, such problems reduce to linear programs. It is thus tempting to enumerate discrete variables so that only the continuous portion of [symbol] (x) is under consideration. In such an example, we first define an extension of [symbol] (x) in the following, where μᵤ denotes the number of constraints of [symbol] (x):

$$\tilde{𝒰} ( x ) ≡ \{ ( {u}_{c} , {u}_{d} , \tilde{u} ) ∈ {ℝ}_{+}^{{n}_{u}} \times {𝕌}_{d} \times {ℝ}_{+}^{{μ}_{u}} : {F}_{c} ( x ) {u}_{c} + {F}_{d} ( x ) {u}_{d} - \tilde{u} \leq h + Gx \}$$

$$Also ,$$

$$\tilde{𝒰} ( x \vert {u}_{d}^{0} ) ≡ \tilde{𝒰} ( x ) ⋂ \{ ( {u}_{c} , {u}_{d} , \tilde{u} ) ∈ {ℝ}_{+}^{{n}_{u}} \times {𝕌}_{d} \times {ℝ}_{+}^{{μ}_{u}} \vert {u}_{d} = {u}_{d}^{0} \} .$$

In some non-limiting embodiments or aspects, due to the existence of ũ,

$$\tilde{𝒰} ( x \vert {u}_{d}^{0} )$$

is not empty for any fixed

$$( x , {u}_{d}^{0} ) ∈ 𝒳 \times {𝕌}_{d} .$$

Without loss of generality, assume that

$${𝕌}_{d} = \{ {u}_{d}^{1} , … , {u}_{d}^{T} \} .$$

Given a fixed

$$( x , {u}_{d}^{t} )$$

with x∈X and

$${u}_{d}^{t} ∈ {𝕌}_{d} ,$$

we abstract the two optimization problems in (8c) and (8d) into the following linear program defined with respect to

$$\tilde{𝒰} ( x \vert {u}_{d}^{t} ) .$$

With 1 ≡(1, . . . ,1) (i.e., a column vector with all its entries being ones), we have:

$$LP ( x , {u}_{d}^{t} , β ) : max \{ {( - E {u}_{c} )}^{T} β - M ( {1}^{⊤} \tilde{u} ) : {F}_{c} ( x ) {u}_{c} - ũ \leq h + G x - {F}_{d} ( x ) {u}_{d}^{t} ,$$

In such an example, M is a sufficiently large number, and coefficient β may be either an extreme point or an extreme ray of Π. The next result follows trivially.

Lemma 5. For a given x,

$${u}_{d}^{t}$$

and β, if

$$𝒰 ( x \vert {u}_{d}^{t} ) ≡ 𝒰 ( x ) ∩ \{ ( {u}_{c} , {u}_{d} ) ∈ {ℝ}_{+}^{{n}_{u}} \times {𝕌}_{d} \vert {u}_{d} = {u}_{d}^{t} \} = \{ {u}_{c} ∈ {ℝ}_{+}^{{n}_{u}} : {F}_{c} ( x ) {u}_{c} \leq h + G x - {F}_{d} ( x ) {u}_{d}^{t} \} \neq ∅$$

we have ũ=0 in any optimal solution to Equation (9). Otherwise, we have ũ≥0 satisfying

$${Σ}_{j = 1}^{{μ}_{u}} {\tilde{u}}_{j} > 0$$

for its all optimal solutions.

In some non-limiting embodiments or aspects, Equation (9) comprises a linear program that is always finitely optimal, its optimal solution set can be characterized by its optimality conditions. In such an example, we next use LP(x, u_{d}, π) with Karush-Kuhn-Tucker (“KKT”) conditions to define the optimal solution set, which is denoted by [symbol] (x, u_{d}, π).

$$𝒪𝒰 ( x , {u}_{d} , π ) = \{ \begin{matrix}\begin{matrix}\begin{matrix}\begin{matrix}{F}_{c} ( x ) {u}_{c}^{( {u}_{d} , π )} - {\tilde{u}}^{( {u}_{d} , π )} \leq h + Gx - {F}_{d} ( x ) {u}_{d} \\ {{F}_{c} ( x )}^{⊤} {λ}^{( {u}_{d} , π )} \geq - {E}^{⊤} π , {λ}^{( {u}_{d} , π )} \leq M 1\end{matrix} \\ {λ}^{( {u}_{d} , π )} ∘ ( h + Gx - {F}_{d} ( x ) {u}_{d} - {F}_{c} ( x ) {u}_{c}^{( {u}_{d} , π )} + {\tilde{u}}^{( {u}_{d} , π )} ) = 0\end{matrix} \\ {u}_{c}^{( {u}_{d} , π )} ∘ ( {{F}_{c} ( x )}^{⊤} {λ}^{( {u}_{d} , π )} + {E}^{⊤} π ) = 0 , {\tilde{u}}^{( {u}_{d} , π )} ∘ ( M 1 - {λ}^{( {u}_{d} , π )} ) = 0\end{matrix} \\ {u}_{c}^{( {u}_{d} , π )} \geq 0 , {\tilde{u}}^{( {u}_{d} , π )} \geq 0 , {λ}^{( {u}_{d} , π )} \geq 0\end{matrix} \}$$

Similarly, when β is a ray (i.e., γ in [symbol] ) we use [symbol] (x, u_{d}, γ) to denote the corresponding optimal solution set of Equation-[9] an let

$${v}_{c}^{( {u}_{d} , γ ) ,}$$

\tilde{v}^{(u}^{_{d}}^{, γ)}, and ζ^{(u}^{_{d}}^{, γ)}, be the aliases of u_{c}, ũ, and λ, respectively, to represent [symbol] . Then, [symbol] (x, u_{d}, γ) can be simply obtained by employing variables

$${v}_{c}^{( {u}_{d} , γ ) ,}$$

\tilde{v}^{(u}^{_{d}}^{, γ)} and ζ^{(u}^{_{d}}^{, γ)} in 10). Note also that primal-dual optimality condition can be used to define [symbol] (x, u_{d}, π) and [symbol] (x, u_{d}, γ) as well.

Next, we introduce an indicator function \dot{u}(ũ) based on ũ's value.

$$\dot{u} ( \tilde{u} ) = \{ \begin{matrix}0 & if \tilde{u} = 0 \\ + ∞ & if \tilde{u} \neq 0\end{matrix} \qquad ( 11 )$$

In the following, we present a single-level equivalence of Equation (8). In this equivalence the [symbol] or [symbol] set introduces many variables to represent optimality conditions, while we are only concerned with (u_{c}, ũ) or (v_{c}, \tilde{v}). Hence, we simply use “.” to collectively represent non-critical variables.
Corollary 5. Formulation 2-StgRO in (1) (and its other equivalences) is equivalent to the following single-level optimization program.

$$min {c}_{1} x + η \qquad ( 12 a )$$

$$s . t . x ∈ 𝒳 \qquad ( 12 g )$$

$$\{ η \geq {c}_{2} {y}^{( {u}_{d} , π )} - \dot{u} ( {ũ}^{( {u}_{d} , π )} ) , {y}^{( {u}_{d} , π )} \geq 0$$

$${B}_{2} {y}^{( {u}_{d} , π )} + {E}_{c} {u}_{c}^{( {u}_{d} , π )} + \dot{u} ( {ũ}^{( {u}_{d} , π )} ) \geq d - {B}_{1} x - {E}_{d} {u}_{d}$$

$$( {u}_{c}^{( {u}_{d} , π )} , {ũ}^{( {u}_{d} , π )} , \cdot ) ∈ 𝒪𝒰 ( x , {u}_{d} , π ) \} ∀ ( {u}_{d} , π ) ∈ {𝕌}_{d} \times {𝒫}_{Π}$$

$$\{ {B}_{2} {y}^{( {u}_{d} , γ )} + {E}_{c} {v}_{c}^{( {u}_{d} , γ )} + \dot{u} ( {\tilde{v}}^{( {u}_{d} , γ )} ) \geq d - {B}_{1} x - {E}_{d} {u}_{d}$$

$${y}^{( {u}_{d} , γ )} \geq 0 , ( {v}_{c}^{( {u}_{d} , γ )} , {\tilde{v}}^{( {u}_{d} , γ )} , \cdot ) ∈ 𝒪𝒱 ( x , {u}_{d} , γ ) \} ∀ ( {u}_{d} , γ ) ∈ {𝕌}_{d} \times {\text{?}}_{Π}$$

Corollary 6. Let ( [symbol] )⊆ [symbol] × [symbol] denote a set of (u_{d}, π)'s and ( [symbol] )⊆ [symbol] × [symbol] a set of (u_{d}, γ)'s. A formulation of (12) defined on ( [symbol] ) and ( [symbol] ) is a relaxation to 2-Stg RO in (1), and its optimal value is smaller than or equal to w*.

Results in Corollaries 5 and 6 generalize their counterparts for the case where [symbol] (x) is a polytope. Nevertheless, the discrete variables in [symbol] (x) significantly increase the complexity of this single-level equivalence. For every (u_{d}, π) or (u_{d}, γ), we need to introduce a set of recourse variables and associated constraints. Hence, it may be desired to limit the number of discrete variables in [symbol] (x), and convert, whenever possible, any discrete u_{d, j} into a first-stage decision variable.

### Parametric C&CG-MIU to Handle Mixed Integer DDU

In some non-limiting embodiments or aspects, the single level equivalence presented in Corollary 5 and the relaxation in Corollary 6 allow us to modify standard parametric C&CG method to handle the challenge arising from the mixed integer DDU. In such an example, standard parametric C&CG is an iterative procedure that computes between a master problem and a few subproblems. In the following, we first introduce subproblems built upon the mixed integer DDU set, and then present the overall procedure with the modified master problem.

For a given x*, the first subproblem is constructed to check feasibility. In such an example, x* is feasible if the recourse problem is feasible for all scenarios in [symbol] (x*).

$$SP 1 : {η}_{f} ( {x}^{*} ) = {max}_{( {u}_{c} , {u}_{d} ) ∈ 𝒰 ( {x}^{*} )} min \{ {1}^{⊤} \tilde{y} : {B}_{2} y + \tilde{y} \geq d - {B}_{1} {x}^{*} - {E}_{c} {u}_{c} - {E}_{d} {u}_{d} \qquad ( 13 )$$

$$y \geq 0 , \tilde{y} \geq 0 \} \qquad ( 13 )$$

As \tilde{y}≥0, it is clear that x* is feasible to 2-StgRO in (1) (e.g., including equivalences) if and only if η_{f}(x*)=0. In the case where η_{f}(x*)=0, we compute the second subproblem for maximizing the minimum value of a linear objective function over all possible scenarios, which is the original max−min substructure of (1).

$$SP 2 : {η}_{o} ( {x}^{*} ) = {max}_{( {u}_{c} , {u}_{d} ) ∈ 𝒰 ( {x}^{*} )} min \{ {c}_{2} y : y ∈ 𝒴 ( {x}^{*} , {u}_{c} , {u}_{d} ) \} \qquad ( 14 )$$

Let

$$( {u}_{o}^{*} , {π}^{*} )$$

denote its optimal solution, where

$${u}_{o}^{*} = ( {u}_{oc}^{*} , {u}_{o d}^{*} )$$

represents the worst case scenario, and π* the associated optimal dual solution to the recourse problem. Without loss of generality, π*∈ [symbol] . Note that ηₒ(x*) is the worst case performance of x* (e.g., in the case where η_{f}(x*)>0). For example, an optimal solution to 13), denoted by

$${u}_{f}^{*} = ( {u}_{fc}^{*} , {u}_{f d}^{*} ) ,$$

causes the recourse problem to be infeasible. Then, we consider in the following the third subproblem, which is the dual of the recourse problem with respect to

$${u}_{f}^{*} .$$

$$SP 3 : max \{ {( d - {B}_{1} {x}^{*} - {E}_{c} {u}_{f c}^{*} - {E}_{d} {u}_{f d}^{*} )}^{⊤} π : π ∈ Π \}$$

SP3 may be unbounded for

$$( {x}^{*} , {u}_{fc}^{*} , {u}_{fd}^{*} ) .$$

Solving it by a linear program solver will yield an extreme ray in [symbol] denoted by γ*, through which SP3 becomes infinity. Hence, by convention, we set ηₒ(x*) to +∞ in this case.

In some non-limiting embodiments or aspects, after subproblems SP1-SP3 are defined, detailed operations of the modified parametric C&CG to handle mixed integer DDU are performed. This is hereafter referred to as parametric C&CG-MIU (e.g., a modified version of the parametric Cutting Plane and Column Generation (C&CG) algorithm to handle mixed-integer DDU). Let ( [symbol] ) and ( [symbol] ) store

$$( {u}_{o d}^{*} , {π}^{*} ) and ( {u}_{f d}^{*} , {γ}^{*} )$$

obtained from solving subproblems in all previous iterations. By Corollary 6, computing the master problem, which is built upon ( [symbol] ) and ( [symbol] ), yields lower bound LB to (1). Also, a feasible x, together with ηₒ(x), provides upper bound UB. With t being the iteration counter, this algorithm iteratively refines those bounds until the optimality tolerance TOL is achieved.

### Parametric C&CG-MIU

In some non-limiting embodiments or aspects, Step 1 may set LB=−∞, UB=+∞, t=1, and set ( [symbol] ) and ( [symbol] ) by an initialization strategy.

In some non-limiting embodiments or aspects, Step 2 solves the following master problem.

$$MP \text{:} \underline{w} = min {c}_{1} x + η$$

$$s . t . x ∈ 𝒳$$

$$\{ η \geq {c}_{2} {y}^{( {u}_{d} , π )} - \dot{u} ( {\tilde{u}}^{( {u}_{d} , π} ) ) , {y}^{( {u}_{d} , π )} \geq 0$$

$${B}_{2} {y}^{( {u}_{d} , π )} + {E}_{c} {u}_{c}^{( {u}_{d} , π )} + \dot{u} ( {\tilde{u}}^{( {u}_{d} , π )} ) \geq d - {B}_{1} x - {E}_{d} {u}_{d}$$

$$( {u}_{c}^{( {u}_{d} , π )} , {\tilde{u}}^{( {u}_{d} , π )} , \cdot ) ∈ 𝒪𝒰 ( x , {u}_{d} , π ) \} ∀ ( {u}_{d} , π ) ∈ ( \text{?} )$$

$$\{ {B}_{2} {y}^{( {u}_{d} , γ )} + {E}_{c} {v}_{c}^{( {u}_{d} , γ )} + \dot{u} ( {\tilde{v}}^{( {u}_{d} , γ )} ) \geq d - {B}_{1} x - {E}_{d} {u}_{d}$$

$${y}^{( {u}_{d} , γ )} \geq 0 , ( {v}_{c}^{( {u}_{d} , γ )} , {\tilde{v}}^{( {u}_{d} , γ )} , \cdot ) ∈ 𝒪𝒱 ( x , {u}_{d} , γ ) \} ∀ ( {u}_{d} , γ ) ∈ ( \text{?} )$$

In a case where it is determined to be infeasible, infeasibility of 2-StgRO in Equation (1) is reported and then terminated. Otherwise, the system derives its optimal solution (x*, η*, ⋅), and its optimal value w. Update LB=w.

In some non-limiting embodiments or aspects, in Step 3 RO system 106 solves subproblem SP1 in (13) and derives an optimal

$$( {u}_{fc}^{*} , {u}_{fd}^{*} )$$

and η_{f}(x*).

In some non-limiting embodiments or aspects, in Step 4 RO system 106 determines cases based on η_{f}(x*)
(Case A): η_{f}(x*)=0
   (i) compute SP2 in (14) to derive

$${η}_{o} ( {x}^{*} ) , ( {u}_{oc}^{*} , {u}_{od}^{*} )$$

corresponding π*; (ii) update

$$( \text{?} ) = ( \text{?} ) ⋃ \{ ( {u}_{od}^{*} , {π}^{*} ) \} ;$$

(iii) augment master problem MP accordingly, i.e., create variables

$$( {u}_{c}^{( {u}_{od}^{*} , {π}^{*} )} , {\tilde{u}}^{( {u}_{od}^{*} , {π}^{*} )} , \cdot ) and {y}^{( {u}_{od}^{*} , {π}^{*} )} ,$$

and add the following constraints (referred to as the optimality cutting set) to MP.

$$η \geq {c}_{2} {y}^{( {u}_{od}^{*} , {π}^{*} )} - \dot{u} ( {\tilde{u}}^{( {u}_{od}^{*} , {π}^{*} )} )$$

$$( {u}_{c}^{( {u}_{od}^{*} , {π}^{*} )} , {\tilde{u}}^{( {u}_{od}^{*} , {π}^{*} )} , \cdot ) ∈ 𝒪𝒰 ( x , {u}_{od}^{*} , {π}^{*} ) , {y}^{( {u}_{od}^{*} , {π}^{*} )} \geq 0$$

(Case B): η_{f}(x*)>0
   (i) compute SP3 in Equation (15) to derive an extreme ray γ* of Π, and set ηₒ(x*)=+∞;
   (ii) update

$$( \text{?} ) = ( \text{?} ) ⋃ \{ ( {u}_{fd}^{*} , {γ}^{*} ) \} ;$$

(iii) augment master problem MP accordingly, i.e., create variables

$$( {v}_{c}^{( {u}_{fd}^{*} , {γ}^{*} )} , {\tilde{v}}^{( {u}_{fd}^{*} , {γ}^{*} )} , \cdot ) and {y}^{( {u}_{fd}^{*} , {γ}^{*} )} ,$$

and add the following constraints (e.g., referred to as the feasibility cutting set) to MP.

$${B}_{2} {y}^{( {v}_{fd}^{*} , {γ}^{*} )} + {E}_{c} {v}_{c}^{( {u}_{fd}^{*} , {γ}^{*} )} + \dot{u} ( {\tilde{v}}^{( {u}_{fd}^{*} , {γ}^{*} )} ) \geq d - {B}_{1} x - {E}_{d} {u}_{fd}^{*}$$

In some non-limiting embodiments or aspects, in Step 5 RO system 106 updates UB=min{UB, c₁x*+ηₒ(x*)}.

In some non-limiting embodiments or aspects, in Step 6 if it is determined that UB−LB≤TOL, RO system 106 returns x* and terminate. Otherwise, RO system 106 lets t=t+1 and returns to Step 2.

In some non-limiting embodiments or aspects, in Step 1, sets ( [symbol] ) and ( [symbol] ) maXbe initialized by different strategies. The naive strategy is to initialize to Ø and then populate them in the following operations. Another simple initialization strategy is to solve relaxations in Equation (4) or Equation (6), and then use the corresponding u_{d} and π (e.g., obtained from recomputing the associated recourse problem, etc.) as the first components of ( [symbol] ). Note also that we can set LB to w_{R} or w(u_{d}, u_{c}).
(ii) Given the fact that [symbol] (x, [symbol] )⊆ [symbol] (x), the feasibility cutting set in Equation (17) can be implemented using the same format as that of the optimality cutting set without causing any problem. That is, the sets can be unified into a single type of cutting set in the form of Equation (16). Hence, unless otherwise stated, we use ( [symbol] ) tGgtgrpAppmponents from both ( [symbol] ) and ( [symbol] ), and augment MP using the unified cutting sets. [symbol]
(iii) Computationally, function \dot{u}(ũ) can be realized by two approaches. The first approach simply uses linear functions \dot{u}(ũ)=M(1^{T}ũ), which are similar to the idea used in Equation (9). Another approach can be achieved by making use of a binary variable θ and an inequality as in the following.

$$\dot{u} ( \tilde{u} ) = \{ M θ \text{:} θ \leq M ( {1}^{T} \tilde{u} ) , θ ∈ \{ 0 , 1 \} \} \qquad ( 18 )$$

It can be seen from MP that \dot{u}(ũ) tends to be +∞ (i.e., θ=1) So, we only need to restrict θ to 0 whenever ũ=0, which is achieved by the inequality constraint in (18). Compared to the first approach, the second approach is rather numerically more stable.
(iv) Assuming X is an integer set, if a DDU set [symbol] (x) has the TU property, we can, according to Proposition 2, simply replace it by its continuous relaxation and employ standard parametric C&CG to compute. In some examples, a number of iterations is reduced if integral restrictions can be additionally imposed. Let u_{d} be discrete variables of the DDU that relax to continuous ones. Specifically, for [symbol] and [symbol] , in addition to constraints for optimality conditions, we impose

$${u}_{d} ∈ {ℤ}_{+}^{{m}_{u}}$$

to enforce integral optimal solutions.

### Convergence and Complexity

To analyze parametric C&CG-MIU on a consistent basis, without loss of generality, we assume that TOL=0, and set ( [symbol] ) (including both ( [symbol] ) and ( [symbol] )) is initialized by the naive strategy (i.e., it is an empty set at the beginning of parametric C&CG-MIU).

Theorem 6. Parametric C&CG-MIU will not repeatedly generate any

$$( {u}_{fd}^{*} , {γ}^{*} ) or ( {u}_{od}^{*} , {π}^{*} )$$

unless it terminates. Upon termination, it either reports that 2-StgRO in (1) is infeasible, or converges to its optimal value with an exact solution.

Proof. According to Corollaries 5) and 6), it is clear that if MP is infeasible, so is 2-Stg RO in (1). For example, assume that x*, obtained from computing MP, is infeasible to 2-StgRO, and

$$( {u}_{fd}^{*} , {γ}^{*} )$$

is derived after solving SP1 and SP3 in the current iteration. Then,

$$( {u}_{fd}^{*} , {γ}^{*} )$$

will not be derived in any following iterations. In such an example, without loss of generality, we assume x° is the first-stage solution obtained from solving MP in some following iteration. Note that a feasibility cutting set of Equation 17, defined on

$$( {u}_{fd}^{*} , {γ}^{*} )$$

has been added to MP. If

$$𝒰 ( x ° \vert {u}_{f d}^{*} ) = ∅ ,$$

then

$${u}_{f d}^{*}$$

may not appear in the solution of any subproblem in this iteration, which concludes our claim. If

$$𝒰 ( x ° \vert {u}_{f d}^{*} ) \neq ∅ ,$$

then by Lemma 5 we have

$$\dot{u} ( {\tilde{v}}^{( {u}_{fd}^{*} , {γ}^{*} )} ) = 0$$

in this feasibility cutting set. Hence, the following problem is guaranteed to be feasible.

$$min \{ 0 : {y}^{( {u}_{fd}^{*} , {γ}^{*} )} ∈ 𝒴 ( x ° , {v}_{c}^{( {u}_{fd}^{*} , {γ}^{*} )} , {u}_{fd}^{*} ) , ( {v}_{c}^{( {u}_{fd}^{*} , {γ}^{*} )} , \cdot ) ∈ 𝒪 𝒱 ( x ° , {u}_{fd}^{*} , {γ}^{*} ) \} = {min}_{( {v}_{c}^{( {u}_{fd}^{*} , {γ}^{*} )} , \cdot ) ∈ 𝒪 ( x ° , {u}_{fd}^{*} , {γ}^{*} )} min \{ 0 : {y}^{( {u}_{fd}^{*} , {γ}^{*} )} ∈ 𝒴 ( x ° , {v}_{c}^{( {u}_{fd}^{*} , 0 , {γ}^{*} )} , {u}_{fd}^{*} ) \}$$

By considering the dual of the inner minimization problem, we have

$$0 \geq {min}_{( {v}_{c}^{( {u}_{fd}^{*} , {γ}^{*} )} , \cdot ) ∈ 𝒪𝒱 ( x ° , {u}_{fd}^{*} , {γ}^{*} )} max \{ {( d - {B}_{1} x ° - {E}_{c} {v}_{c}^{( {u}_{fd}^{*} , {γ}^{*} )} - {E}_{d} {u}_{fd}^{*} )}^{⊤} γ : γ ∈ {𝒫}_{\prod } ⋃ {ℛ}_{\prod } \} \geq {min}_{( {v}_{c}^{( {u}_{fd}^{*} , {γ}^{*} )} , \cdot ) ∈ 𝒪 ( x ° , {u}_{fd}^{*} , {γ}^{*} )} \{ {( d - {B}_{1} x ° - {E}_{c} {v}_{c}^{( {u}_{fd}^{*} , {γ}^{*} )} - {E}_{d} {u}_{fd}^{*} )}^{⊤} {γ}^{*} \} = {min}_{( {v}_{c}^{( {u}_{fd}^{*} , {γ}^{*} )} , \cdot ) ∈ 𝒪 𝒱 ( x ° , {u}_{fd}^{*} , {γ}^{*} )} \{ {( d - {B}_{1} x ° - {E}_{c} {v}_{c}^{( {u}_{fd}^{*} , {γ}^{*} )} - {E}_{d} {u}_{fd}^{*} )}^{⊤} {γ}^{*} \} ,$$

where the last equality holds by the definition of OV (i.e., it is the optimal solution set of

$$LP ( x ° , {u}_{fd}^{*} , {γ}^{*} ) ) .$$

### Thus,

$$( {u}_{fd}^{*} , {γ}^{*} )$$

will not be derived by SP3.

Next, we consider the other case where MP generates feasible x*. For example, assume that x* generated by MP is feasible, and

$$( {u}_{od}^{*} , {π}^{*} )$$

is derived as an optimal solution to SP2 in the current iteration. If

$$( {u}_{od}^{*} , {π}^{*} )$$

has appeared as an optimal solution to SP2 in some previous iteration, we have UB=LB. In such an example, it is obvious that

$$𝒰 ( {x}^{*} \vert {u}_{o d}^{*} )$$

is non-empty, and

$$\dot{u} ( {\tilde{u}}^{( {u}_{od}^{*} , {π}^{*} )} ) = 0$$

in the optimality cutting set of Equation 16, defined on

$$( {u}_{od}^{*} , {π}^{*} ) ,$$

which has been a part of MP after the first time

$${y}^{( {u}_{od}^{*} , {π}^{*} )} ,$$

is generated. Let η* and,

$${y}^{* ( {u}_{od}^{*} , {π}^{*} )}$$

denote the optimal values for η and

$$( {u}_{od}^{*} , {π}^{*} )$$

respectively, of the current MP. We have

$${η}^{*} \geq {c}_{2} {y}^{* ( {u}_{od}^{*} , {π}^{*} )} \geq min \{ {c}_{2} {y}^{( {u}_{od}^{*} , {π}^{*} )} : {B}_{2} {y}^{( {u}_{od}^{*} , {π}^{*} )} \geq d - {B}_{1} {x}^{*} - {E}_{c} {u}_{c}^{( {u}_{od}^{*} , {π}^{*} )} - {E}_{d} {u}_{o d}^{*} ( {u}_{c}^{( {u}_{od}^{*} , {π}^{*} )} , \cdot ) ∈ 𝒪𝒰 ( {x}^{*} , {u}_{o d}^{*} , {π}^{*} ) , {y}^{( {u}_{od}^{*} , {π}^{*} )} \geq 0 \} = {min}_{( {u}_{c}^{( {u}_{od}^{*} , {π}^{*} )} , \cdot ) ∈ 𝒪 𝒰 ( {x}^{*} , {u}_{od}^{*} , {π}^{*} )} {max}_{π ∈ {𝒫}_{\prod }} \{ {( d - {B}_{1} {x}^{*} - {E}_{c} {u}_{c}^{( {u}_{od}^{*} , {π}^{*} )} - {E}_{d} {u}_{o d}^{*} )}^{⊤} π \} \geq {}_{( {u}_{c}^{( {u}_{od}^{*} , {π}^{*} )} , \cdot ) ∈ 𝒪 𝒰 ( {x}^{*} , {u}_{od}^{*} , {π}^{*} )} min {( d - {B}_{1} {x}^{*} - {E}_{c} {u}_{c}^{( {u}_{od}^{*} , {π}^{*} )} - {E}_{d} {u}_{o d}^{*} )}^{⊤} {π}^{*} = {max}_{{}_{( {u}_{c}^{( {u}_{od}^{*} , {π}^{*} )} , \cdot ) ∈ 𝒪 𝒰 ( {x}^{*} , {u}_{od}^{*} , {π}^{*} )}} {( d - {B}_{1} {x}^{*} - {E}_{c} {u}_{c}^{( {u}_{od}^{*} , {π}^{*} )} - {E}_{d} {u}_{o d}^{*} )}^{⊤} {π}^{*} = max \{ {( d - {B}_{1} {x}^{*} - {E}_{c} {u}_{c} - {E}_{d} {u}_{od}^{*} )}^{⊤} {π}^{*} : {F}_{c} ( {x}^{*} ) {u}_{c} \leq h + Gx - {F}_{d} ( {x}^{*} ) {u}_{od}^{*} , {u}_{c} \geq 0 \} = {max}_{{u}_{d} = {u}_{od}^{*} , {u}_{c} ∈ 𝒰 ( {x}^{*} \vert {u}_{od}^{*} )} {max}_{π ∈ \prod } \{ {( d - {B}_{1} {x}^{*} - {E}_{c} {u}_{c} - {E}_{d} {u}_{od}^{*} )}^{⊤} π \} = {η}_{o} ( {x}^{*} )$$

In some non-limiting embodiments or aspects, the first equality follows the duality of recourse problem, the second and third equalities hold by the definition of

$$𝒪𝒰 ( {x}^{*} , {u}_{od}^{*} , {π}^{*} ) ,$$

and the last two equalities follow from the claim statement that

$$( {u}_{od}^{*} , {π}^{*} )$$

is an optimal solution of SP2 (with the dual of recourse). Hence, we have LB=c₁x*+η*≥c₁x*+ηₒ (x*)≥UB, which leads to the desired conclusion.

In some non-limiting embodiments or aspects, since both sets [symbol] and [symbol] ∪ [symbol] are fixed and finite, it is straightforward to conclude that parametric C&CG-MIU algorithm will terminate by either reporting the infeasibility of 2-StgRO or converging to an exact solution after a finite number of iterations.

In some non-limiting embodiments or aspects, according to the proof of Theorem 6, we can easily bound the number of iterations.

For example, Corollary 7. The number of iterations of parametric CεCG-MIU before termination is bounded by | [symbol] |×(| [symbol] |+| [symbol] |+| [symbol] |). Hence, the algorithm is of

$$O ( \vert {𝕌}_{d} \vert \times ( \begin{matrix}{n}_{y} + {μ}_{y} \\ {μ}_{y}\end{matrix} ) )$$

iteration complexity, where μ_{y} denotes the number of rows of matrix B₂ in [symbol] (x,u).

The next result follows easily from structures of feasibility and optimality cutting sets and derivations of lower and upper bounds.

Proposition 7. (i) If solution x* of MP is infeasible according to SP1 and SP3 and a corresponding feasibility cutting set is included in MP, then it will not be generated by MP in the following iterations.
(ii) If x* is an optimal solution to MP in both iterations t₁ and t₂ with t₁<t₂, then the parametric CECG-MIU algorithm terminates and x* is optimal to 2-Stg RO.

Consequently, we have the following bound on the iteration complexity.
Corollary 8. If set X is discrete and of a finite number of elements, then the number of iterations of parametric CESCG-MIU before termination is bounded by |X| (i.e., the algorithm is of O(|X|) iteration complexity).
Lemma 8. Assume that [symbol] (x) includes RHS decision dependence. Consider

$$L P ( {x}^{0} , {u}_{d}^{*} , β )$$

for fixed

$$( {u}_{d}^{*} , β ) ,$$

and basis [symbol] with ũ∉ [symbol] that is an optimal basis (i.e., its basic solution (BS) with respect to

$$\tilde{𝒰} ( {x}^{0} \vert {u}_{d}^{*} )$$

is feasible and optimal). If [symbol] 's BS with respect to

$$\tilde{𝒰} ( {x}^{1} \vert {u}_{d}^{*} )$$

is feasible (i.e., a basic feasible solution), it is also optimal to

$$L P ( {x}^{1} , {u}_{d}^{*} , β ) .$$

Moreover, if B⁰ yields the unique optimal solution to

$$L P ( {x}^{0} , {u}_{d}^{*} , β ) ,$$

it also yields the unique one to

$$LP ( {x}^{1} , {u}_{d}^{*} , β ) .$$

Following this lemma, we study the consequence of repeated bases. Without loss of generality, we assume that the unified cutting sets in the form of Equation (16) are supplied to MP to simpify our exposition.

Theorem 9. Let

$${\hat{𝕌}}_{d}^{t}$$

be the set of all discrete u_{od} and u_{fd} appeared in MP at the end of iteration t, and for each

$${u}_{d} ∈ {\hat{𝕌}}_{d}^{t} ,$$

let

$${ℬ}_{{u}_{d}}^{t}$$

be the collection of bases obtained from the sets [symbol] (x, u_{d}, ⋅) and [symbol] (x, u_{d}, ⋅) at the end of iteration t. For any iterations t₁<t₂, if

$${\hat{𝕌}}_{d}^{{t}_{1}} = {\hat{𝕌}}_{d}^{{t}_{2}} , and ∀ {u}_{d} ∈ {\hat{𝕌}}_{d}^{{t}_{1}} , {𝔅}_{{u}_{d}}^{{t}_{1}} = {𝔅}_{{u}_{d}}^{{t}_{2}} ,$$

parametric CECG-MIU terminates at t₂, and x^{t}^{₁}, an optimal solution to MP in iteration t₁, is optimal to 2-Stg RO.

In some non-limiting embodiments or aspects, let (x^{t}, η^{t}, ⋅) denote the optimal solution of MP in iteration t. Since

$${\hat{𝕌}}_{d}^{{t}_{1}} = {\hat{𝕌}}_{d}^{{t}_{2}} ,$$

there exists

$${u}_{d}^{*} ∈ {\hat{𝕌}}_{d}^{{t}_{1}}$$

such that

$$𝒰 ( {x}^{{t}_{2} - 1} \vert {u}_{d}^{*} ) \neq ∅ .$$

In such an example,

$$𝒰 ( {x}^{{t}_{2} - 1} \vert {u}_{d}^{*} ) \neq ∅ ,$$

otherwise a new u_{d} may be generated from subproblems in iteration t₂−1, which leads to

$${\hat{𝕌}}_{d}^{{t}_{1}} \neq {\hat{𝕌}}_{d}^{{t}_{2}} .$$

In addition, starting from iteration t₂, for all x∈X, there exists

$${u}_{d}^{*} ∈ {\hat{𝕌}}_{d}^{{t}_{1}}$$

such that

$$𝒰 ( x \vert {u}_{d}^{*} ) \neq ∅ .$$

Otherwise, such x renders the objective value of MP to −∞ and

$${\hat{𝕌}}_{d}^{{t}_{1}} = {\hat{𝕌}}_{d}^{{t}_{2}}$$

does not hold.

In some non-limiting embodiments or aspects, as MP is finite in iteration t₂, it is sufficient to examine any

$${u}_{d}^{*} ∈ {\hat{𝕌}}_{d}^{{t}_{2}}$$

whose associated

$${\tilde{u}}^{{u}_{d}^{*} , π} = 0$$

for some π. Hence, suppose

$$( {u}_{d}^{*} , {π}^{*} ) ∈ ( \text{?} )$$

whose associated

$${\tilde{u}}^{{u}_{d}^{*} , {π}^{*}} = 0 , and {𝔹}_{{u}_{d}^{*}} ∈ {𝔅}_{{u}_{d}^{*}}^{{t}_{1}} = {𝔅}_{{u}_{d}^{*}}^{{t}_{2}}$$

yields an optimal solution belonging to set

$$𝒪𝒰 ( {x}^{{t}_{2}} , {u}_{d}^{*} , {π}^{*} ) .$$

By Lemma 8 given that

$${𝔹}_{{u}_{d}^{*}}$$

is feasible to

$$𝒰 ( {x}^{{t}_{1}} \vert {u}_{d}^{*} ) ,$$

an optimal solution is defined in

$$𝒪𝒰 ( {x}^{{t}_{1}} , {u}_{d}^{*} , {π}^{*} ) .$$

It follows that (x^{t}^{₁}, η^{t}^{₁}, ⋅) is feasible (and optimal) to MP in t₂, which, according to Proposition 7. (ii), terminates the algorithm with x^{t}^{₁} being an optimal solution.

In some non-limiting embodiments or aspects, when each possible combination of bases is finite, the next result follows.
Corollary 9. The number of iterations of parametric C [symbol] CG-MIU before termination is bounded by

$$\vert {𝕌}_{d} \vert \times {22}^{( \begin{matrix}{n}_{u} + {μ}_{u} \\ {μ}_{u}\end{matrix} )} ,$$

i.e., the algorithm is of

$$O ( \vert {𝕌}_{d} \vert \times 2 ( \begin{matrix}{n}_{u} + {μ}_{u} \\ {μ}_{u}\end{matrix} ) )$$

iteration complexity, where μᵤ is the number of constraints in set [symbol] (x).

The result in Theorem 9 may be improved if LP(x, u_{d}, β) always has a unique optimal solution for any (u_{d}, β) with u_{d} ∈ [symbol] and β∈ [symbol] ∪ [symbol] , which is referred to as the unique optimal solution (or “uniqueness” for short) property.
Theorem 10. Assume that LP(x, u_{d}, β) has the uniqueness property, and let

$${𝔹}_{{u}_{d}^{t}}$$

be the basis of

$$𝒰 ( x \vert {u}_{d}^{t} )$$

associated with optimal solution

$$( {u}_{c}^{t} , {u}_{d}^{t} )$$

of SP1 or SP2 in iteration. If 2tuple

$$( {u}_{d}^{t} , {𝔹}_{{u}_{d}^{t}} )$$

has appeared in some previous iteration, parametric C [symbol] CG-MIU terminates.
Proof. Assume the repeat happens in iterations t₁ and t₂ with t₁<t₂, and let x^{t}^{₁}, x^{t}^{₂} be the first-stage solutions of MP,

$$( {u}_{c}^{{t}_{1}} , {u}_{d}^{t} ) , ( {u}_{c}^{{t}_{2}} , {u}_{d}^{t} )$$

be the worst case scenarios from solving either SP1 or SP2 subproblem, and π^{t}^{₁} and π^{t}^{₂} be the corresponding extreme points or rays of H obtained in those iterations, respectively. Then

$$𝒰 ( {x}^{{t}_{1}} \vert {u}_{d}^{t} ) \neq ∅ , 𝒰 ( {x}^{{t}_{2}} \vert {u}_{d}^{t} ) = ∅ , and {𝔹}_{{u}_{d}^{t}}$$

defines a basic feasible solution to both of them.

In the above example, Since

$${𝔹}_{{u}_{d}^{t}}$$

defines the optimal solution

$$( {u}_{c}^{{t}_{1}} , 0 )$$

of

$$LP ( {x}^{{t}_{1}} , {u}_{d}^{t} , {π}^{{t}_{1}} ) ,$$

by Lemma 8 it also defines the optimal solution of

$$L P ( {x}^{{t}_{2}} , {u}_{d}^{t} , {π}^{{t}_{1}} ) .$$

### It is

$$( {u}_{c}^{{t}_{2}} , 0 ) ,$$

according to the assumption that

$${𝔹}_{{u}_{d}^{t}}$$

defines the optimal solution of

$$LP ( {x}^{{t}_{2}} , {u}_{d}^{t} , {π}^{{t}_{2}} ) .$$

Note that a cutting set with

$$𝒪𝒰 ( x , {u}_{d}^{t} , {π}^{{t}_{1}} ) or 𝒪𝒱 ( x , {u}_{d}^{t} , {π}^{{t}_{1}} )$$

has been added to MP in iteration t₁. Hence we have

$$𝒪𝒰 ( {x}^{{t}_{2}} , {u}_{d}^{t} , {π}^{{t}_{1}} ) = \{ ( {u}_{c}^{{t}_{2}} , 0 , \cdot ) \}$$

$$or$$

$$𝒪𝒱 ( {x}^{{t}_{2}} , {u}_{d}^{t} , {π}^{{t}_{1}} ) = \{ ( {u}_{c}^{{t}_{2}} , 0 , \cdot ) \} .$$

If the unified cutting sets are adopted, we have

$$LB = {c}_{1} {x}^{{t}_{2}} + η \geq {c}_{1} {x}^{{t}_{2}} + min \{ {c}_{2} y : y ∈ 𝒴 ( {x}^{{t}_{2}} , {u}_{c}^{{t}_{2}} , {u}_{d}^{t} ) \} = {c}_{1} {x}^{{t}_{2}} + {η}_{o} ( {x}^{{t}_{2}} ) = UB$$

Actually, as shown in, without loss of generality, to modify any β slightly to ensure a unique optimal solution in the execution of parametric C&CG-MIU.
Corollary 10. If LP(x, u_{d}, β) has the uniqueness property, then the number of iterations required for parametric C [symbol] CG-MIU before termination is bounded by

$$\vert {𝕌}_{d} \vert \times ( \begin{matrix}{n}_{u} + {μ}_{u} \\ {μ}_{u}\end{matrix} ) .$$

Therefore, the algorithm is of

$$O ( min \{ \vert {𝕌}_{d} \vert \times ( \begin{matrix}{n}_{y} + {μ}_{y} \\ {μ}_{y}\end{matrix} ) , \vert 𝒳 \vert , \vert {𝕌}_{d} \vert \times ( \begin{matrix}{n}_{u} + {μ}_{u} \\ {μ}_{u}\end{matrix} ) \} )$$

iteration complexity.

### Handling MIP Recourse by a Nested Parametric C&CG

In some non-limiting embodiments or aspects, a nested parametric C&CG method improves (e.g., generalizes, strengthens, etc.) a nested basic C&CG developed to handle 2-StgRO with MIP recourse in the context of DIU. For example, two inner C&CG subroutines, one for feasibility and one for optimality, respectively, are provided. In such an example, the first inner C&CG subroutine for feasibility eliminates a dependence on the relatively complete recourse property, which has been assumed to ensure the algorithm's applicability. Another improvement provides that both subroutines have a two-phase structure to ensure that an [symbol] set captures worst-case scenarios of [symbol] (x) precisely. The outer parametric C&CG procedure provides the main framework on top of those inner subroutines.

### Inner C&CG Subroutine for Feasibility

In some non-limiting embodiments or aspects, a fixed x* is given. In such an example, the following max−min problem is provided to investigate the feasibility issue of x*. It resembles the max−min portion of 2-StgRO and includes a variable \tilde{y} and a modified objective function,

$${η}_{f} ( {x}^{*} ) = {max}_{u ∈ 𝒰 ( {x}^{*} )} {min}_{( {y}_{c} , {y}_{d} , \tilde{y} ) ∈ \tilde{𝒴} ( {x}^{*} , u )} \tilde{y} \qquad ( 26 )$$

$$\tilde{𝒴} ( {x}^{*} , u ) = \{ {B}_{2 , c} {y}_{c} + {B}_{2 , d} {y}_{d} + 1 \tilde{y} \geq d - {B}_{1} {x}^{*} - Eu , {y}_{c} \geq 0 , {y}_{d} ∈ {𝕐}_{d} , \tilde{y} \geq 0 \} .$$

Lemma 14. A given x* is feasible with respect to [symbol] (x*) if and only if η_{f}(x*)=0. If η_{f}(x*)>0,xx* is infeasible to an optimal u of 26.

In some non-limiting embodiments or aspects, [symbol] (x*) is bounded and it is clear that η_{f}(x*) is of a finite value. Also, there is no feasibility issue associated with this model. Indeed, by enumerating choices of discrete variables and through duality, (26) can be reformulated with a max-min-max structure as that in (20b), which is solvable by basic C&CG. We next exploit this structure to develop an inner C&CG subroutine. In addition to x*, we further assume that some u* ∈ [symbol] (x*) is given to define inner subproblem ISP_{f}, which is actually the minimization problem of \sqrt{26}).

$${ISP}_{f} : {r}_{f} ( {x}^{*} , {u}^{*} ) = min \{ \tilde{y} : ( {y}_{c} , {y}_{d} , \tilde{y} ) ∈ \tilde{𝒴} ( {x}^{*} , {u}^{*} ) \} \qquad ( 27 )$$

For this MIP program, RO system 106 directly computes its optimal value r_{f}(x*, u*) and optimal

$$( {y}_{c}^{*} , {y}_{d}^{*} , {\tilde{y}}^{*} ) .$$

Then, we define the inner master problem, which can be seen as in the form of Equation (20c) with respect to the objective function of 26 and

$${\hat{𝕐}}_{d} = \{ {y}_{d}^{1} , … , {y}_{d}^{\vert {\hat{𝕐}}_{d} \vert} \} ,$$

a subset of

[symbol]

$${IMP}_{f} : {\hat{η}}_{f} ( {x}^{*} , {\hat{𝕐}}_{d} ) = max {\hat{η}}_{f} \qquad ( 28 a )$$

$$s . t . u ∈ 𝒰 ( {x}^{*} ) \qquad ( 28 b )$$

$$\{ {\hat{η}}_{f} \leq min \{ {\tilde{y}}^{t} : {B}_{2 , c} {y}_{c}^{t} + 1 {\tilde{y}}^{t} \geq d - {B}_{1} {x}^{*} - E u - {B}_{2 , d} {y}_{d}^{t} \qquad ( 28 b )$$

$${y}_{c}^{t} \geq 0 , {\tilde{y}}^{t} \geq 0 \} \} t = 1 , … , \vert {\hat{𝕐}}_{d} \vert \qquad ( 28 c )$$

Corollary 12. If \hat{η}_{f}(x*, [symbol] )=0 for some [symbol] , we have η_{f}(x*)=0, i.e., x* is feasible for [symbol] (x*). If r_{f}(x*, u*)>0 for some u*, we have η_{f}(x*)>0, i.e., x* is infeasible for [symbol] (x*).

In this example, the relatively complete recourse property is often assumed in the literature of multistage MIPs to circumvent the challenge of detecting and resolving the infeasibility issue of an MIP recourse for a first-stage solution. Specific to two-stage RO with MIP recourse, the linear program portion of the recourse problem defined on y_{c} is feasible for any possible 3-tuple (x, u, y_{d})∈X× [symbol] (x)× [symbol] . Now, with the preceding subproblems and the following subroutine for feasibility, the infeasibility of x can be detected. Then, it can be addressed rigorously by implementing appropriate cutting sets in the outer C&CG procedure. Hence, this relatively complete recourse assumption is not needed anymore. DDU generalizes DIU, so it is clear that this subroutine can also be supplied to the nested basic C&CG to expand its solution capacity for DIU-based RO.

Constraints in (28c) can be reformulated and simplified using duality as

$$\{ {\hat{η}}_{f} \leq {( d - {B}_{1} {x}^{*} - E u - {B}_{2 , d} {y}_{d}^{t} )}^{⊤} {π}^{t} , {B}_{2 , c}^{⊤} {π}^{t} \leq 0 , {1}^{⊤} {π}^{t} \leq 1 , {π}^{t} \geq 0 \} , t = 1 , … , \vert {\hat{𝕐}}_{d} \vert . \qquad ( 29 )$$

Then, problem IMP_{f} is converted into a bilinear MIP since it contains the product between u and π^{t}. It is currently solvable for some professional MIP solvers, while the computational performance might not be satisfactory. Actually, the relatively complete recourse property naturally holds for the LP portion of minimization problem of (26), i.e., feasible for x* and (u, y_{d})∈ [symbol] (x*)× [symbol] . Hence, we can replace the minimization problem in 28c) by its (linearized) KKT conditions, which often yields a computationally more friendly formulation. Note that for either approach, computing IMP_{f} generates optimal values for π^{t} for all t. (iii) It is worth mentioning that non-zero extreme points of the feasible set of (29) are normalized extreme rays of Ð. This insight directly links ( [symbol] ) derived in the next algorithm to those appeared in (25), and therefore helps to define corresponding cutting sets.

In the above, problems ISP_{f} and IMP_{f} are solved in a dynamic and iterative fashion to detect the feasibility issue of x*. Nevertheless, we might not obtain sufficient y_{d} 's (and associated π's) that precisely capture the set of worst-case scenarios within [symbol] (x*). To address such a situation, we introduce the following correction problem ICP_{f} to retrieve at least one missing y_{d}.

$${ICP}_{f} : {c}_{f} ( {x}^{*} , ( \text{?} ) ) = min \{ \tilde{y} : ( {y}_{c} , {y}_{d} , \tilde{y} ) ∈ \tilde{𝒴} ( {x}^{*} , u ) , ( u , \cdot ) ∈ 𝒪𝒰 ( {x}^{*} , ( \text{?} ) ) \} \qquad ( 30 )$$

In some non-limiting embodiments or aspects, solving Equation (28) produces π^{t} for each

$${y}_{d}^{t} .$$

If set ( [symbol] ) in (30) is same as the one obtained from computing Equation (28), it is clear that c_{f}(x*, [symbol] )) is less than or equal to \hat{η}_{f}(x*, [symbol] ). As an example, if c_{f}(x, [symbol] ))=0 and \hat{η}_{f}(x*, [symbol] )>0, it indicates that we are able to, by leveraging some y_{d} ∉ [symbol] , convert au∈ [symbol] (x*, [symbol] )) to a feasible scenario for x*. In such a scenario, it has been deemed infeasible for x* if the discrete recourse decision is restricted to [symbol] . This situation clearly requires us to expand [symbol] to eliminate the discrepancy.

In some non-limiting embodiments or aspects, the following detailed steps are determined for the inner C&CG subroutine for feasibility. The ICP_{f} is called after the complete iterative procedure executes between ISP_{f} and IMP_{f}, which renders this subroutine to have two phases. The explicit expression for cutting set in Step 5 takes the form of Equation 28c.

### Inner C&CG Subroutine for Feasibility—(ISF-C&CG)

### Phase I

With regard to Step 1, RO system 106 sets [symbol] by an initialization strategy.

With regard to Step 2 Solve inner master problem IMP_{f} defined with respect to [symbol] , and derive optimal \hat{η}_{f} (X*, [symbol] ), and optimal solution (u*, π¹*, . . . , π^{|} [symbol] ^{|}*,).

With regard to Step 3 If \hat{η}_{f}(x*, [symbol] )=0, set η_{f}(x*)=0 and terminate the subroutine.

With regard to Step 4 For given (x*, u*), solve inner subproblem ISP_{f}, derive optimal value r_{f} (x*, u*) and solution

$$( {y}_{c}^{*} , {y}_{d}^{*} , \tilde{y} ) .$$

With regard to Step 5 If r_{f}(x*, u*)>0, define

$$( \text{?} ) ≡ \{ ( {y}_{d}^{1} , {π}^{1 *} ) , … , ( {y}_{d}^{\vert {\hat{𝕐}}_{d} \vert} , {π}^{\vert {\hat{𝕐}}_{d} \vert *} ) \}$$

and go to Phase II. Otherwise, update

$${\hat{𝕐}}_{d} = {\hat{𝕐}}_{d} ⋃ \{ {y}_{d}^{*} \}$$

### and go to Step 2.

### Phase II

With regard to Step 6, a correction problem (e.g., for feasibility) ICP_{f} derives its optimal value c_{f} (x*, ( [symbol] ) optimal solution

$$( {u}^{*} , {y}_{d}^{*} , \cdot ) ,$$

and corresponding π* by generating:

$$max \{ {( d - {B}_{1} {x}^{*} - {Eu}^{*} - {B}_{2 , d} {y}_{d}^{*} )}^{T} π \text{:} {B}_{2 , c}^{T} π \leq 0 , {1}^{T} π \leq 1 , π \geq 0 \}$$

With regard to Step 7, if

$${c}_{f} ( {x}^{*} , ( \text{?} ) = 0 ,$$

then when

$$( \text{?} ) = ( \text{?} ) ⋃ \{ ( {y}_{d}^{*} , {π}^{*} ) \}$$

RO system 106 returns to Step 6. Otherwise, RO system 106 sets η_{f}=r_{f}(x*, u*), returns ( [symbol] ), and terminates.

Further, a single-dimension variable \tilde{y} is unnecessary to examine feasibility of x*. It is introduced to help us understand the transition between MIP and LP recourse, and to simplify our convergence analysis for the main solution algorithm. Indeed, similar to Equation (13), a multi-dimensional \tilde{y} is probably more effective in the feasibility examination, especially when the recourse problem has equality constraints. Certainly some simple changes should be made in defining sub-master and correction problems for ISF-CECG if \tilde{y} is employed.

Again, different initialization strategies can be applied to set [symbol] in Step 1. In addition to the naive strategy, another one is to set [symbol] by inheriting some or all y_{d}'s contained in [symbol] from the previous ISF-C&CG execution, referred to as the “inheritance initialization”. We note that it may help us reduce the number of iterations involved, but computationally is not as stable as the naive one. After carrying out ISF-C&CG, if η_{f}(x*)=0 we will execute next the inner C&CG subroutine for optimality, which is described in the following. For the other case where η_{f}(x*)>0, we will generate one cutting set to strengthen the master problem of the main outer procedure.

### Inner C&CG Subroutine for Optimality

In some non-limiting embodiments or aspects, after examination based on the previous inner subroutine has been passed, development of the subroutine for optimality to compute ηₒ(x*), the worst case performance of x* as in 20. The inner subproblem for this subroutine is simply the recourse problem for given (x*, u*)

$${ISP}_{o} : {r}_{o} ( {x}^{*} , {u}^{*} ) = {min}_{( {y}_{c} , {y}_{d} ) ∈ 𝒴 ( {x}^{*} , {u}^{*} )} ( {c}_{2 , c} {y}_{c} + {c}_{2 , d} {y}_{d} ) \qquad ( 31 )$$

Similar to (28), inner master problem IMPₒ is defined with respect to subset [symbol] .

$${IMP}_{o} : {\hat{η}}_{o} ( {x}^{*} ) = max {\hat{η}}_{o} \qquad ( 32 a )$$

$$s . t . u ∈ 𝒰 ( {x}^{*} ) \qquad ( 32 b )$$

$$\{ {\hat{η}}_{o} \leq {c}_{2 , d} {y}_{d}^{t} + min \{ {c}_{2 , c} {y}_{c}^{t} : {B}_{2 , c} {y}_{c}^{t} \geq d - {B}_{1} x - Eu - {B}_{2 , d} {y}_{d}^{t} \qquad ( 32 b )$$

$${y}_{2 , c} \geq 0 \} \} t = 1 , … , \vert {\hat{𝕐}}_{d} \vert \qquad ( 32 c )$$

By making use of duality, constraints in (32c) can be replaced by

$$\{ {\hat{η}}_{o} \leq {c}_{2 , d} {y}_{d}^{t} + {( d - {B}_{1} x - Eu - {B}_{2 , d} {y}_{d}^{t} )}^{T} {π}^{t} , {B}_{2 , c}^{T} {π}^{t} \leq {c}_{2 , c}^{T} , {π}^{t} \geq 0 \}$$

$$t = 1 , … , \vert {\hat{𝕐}}_{d} \vert .$$

This reformulation holds even if some of lower-level minimization problem is infeasible, where the dual problem is unbounded. Then, IMPₒ is converted into a mixed integer bilinear program, computable by some professional solvers. Also, if the relatively complete recourse property holds, every minimization problem can be replaced by its (linearized) KKT conditions, converting IMPₒ into an MIP that probably is computationally more friendly.

Similar to the feasibility subroutine, the correction problem for optimality, i.e., ICPₒ, is introduced next to help us precisely capture the set of worst-case scenarios within in [symbol] (x*).

$${ICP}_{o} : {c}_{o} ( {x}^{*} , ( \text{?} ) ) = min \{ {c}_{2 , c} {y}_{c} + {c}_{2 , d} {y}_{d} : ( {y}_{c} , {y}_{d} ) ∈ 𝒴 ( {x}^{*} , u ) , ( u , \cdot ) ∈ 𝒪𝒰 ( {x}^{*} , ( \text{?} ) ) \} .$$

### Inner C&CG Subroutine for Optimality-(ISO-C&CG)

### Phase I

Step 1 Set LB=−∞, UB=+∞, and set [symbol] by an initialization strategy.
Step 2 Solve inner master problem IMPₒ defined with respect to [symbol] , and derive optimal value \hat{η}ₒ (x*), optimal solution (u*, π¹*, . . . , π^{|} [symbol] ^{|}*, ⋅). Update UB=\hat{η}ₒ(x*).
Step 3 For given (x*, u*), solve inner subproblem ISPₒ, and derive optimal value rₒ (x*, u*), and optimal solution

$$( {y}_{c}^{*} , {y}_{d}^{*} ) .$$

Update LB=max{LB, rₒ (x*, u*)}.
Step 4 If UB−LB≤TOL, create

$$( \text{?} \text{≡≡} \{ ( {y}_{d}^{1} , {π}^{1 *} ) , … , ( {y}_{d}^{\vert {\hat{𝕐}}_{d} \vert} , {π}^{\vert {\hat{𝕐}}_{d} \vert *} ) \}$$

and go to Phase II. Otherwise, update

$${\hat{𝕐}}_{d} = {\hat{𝕐}}_{d} ⋃ \{ {y}_{d}^{*} \}$$

### and go to Step 2.

### Phase II

Step 5 Solve correction problem (for optimality) ICPₒ, derive its optimal value cₒ (x*, ( [symbol] )), optimal solution

$$( {u}^{*} , {y}_{d}^{*} , \cdot ) ,$$

and corresponding π* obtained from computing

$$max \{ {( d - {B}_{1} {x}^{*} - {Eu}^{*} - {B}_{2 , d} {y}_{d}^{*} )}^{T} π : {B}_{2 , c}^{T} π \leq {c}_{2 , c}^{T} , π \geq 0 \}$$

Step 6 If c₀(x*, ( [symbol] ))<LB, update

$$( \text{?} ) = ( \text{?} ) ⋃ \{ ( {y}_{d}^{*} , {π}^{*} ) \}$$

### and go to Step 5.

Otherwise, set ηₒ(x*)=UB, return ( [symbol] ), and terminate.

Similar to ISF-C&CG, different initialization strategies can be applied to set [symbol] . A useful one is to populate it with some y_{d} 's generated in ISF-C&CG upon exit, which are deemed effective in dealing with u. For inner C&CG subroutines of both feasibility and optimality, every call of subproblem or correction problem (except the last call) generates a new y_{d} ∈Y_{d}. So, the next iteration complexity result simply follows.
Proposition 15. For a given x*, the number of iterations, including those from both Phase I and Phase II, for either inner CECGG subroutine is of O(|Y_{d}|).

### The Main Outer C&CG Procedure

The primary component of the outer C&CG procedure is its master problem. We present it with the unified cutting sets in the following. Assume that ( [symbol] ) is the set of ( [symbol] )'s obtained from inner C&CG subroutines (including both feasibility and optimality ones) in all previous iterations, as well as from initialization. We have

$$OMP : \underline{w} = min {c}_{1} x + η \qquad ( 33 a )$$

$$s . t . x ∈ 𝒳 \qquad ( 33 b )$$

$$\{ η \geq {c}_{2 , c} {y}_{c}^{\text{?}} + {c}_{2 , d} {y}_{d}^{\text{?}} \qquad ( 33 c )$$

$${B}_{2 , c} {y}_{c}^{\text{?}} + {B}_{2 , d} {y}_{d}^{( \text{?}} \geq d - {B}_{1} x - Eu \qquad ( 33 \sim d )$$

$${y}_{c}^{\text{?}} \geq 0 , {y}_{d}^{\text{?}} ∈ {𝕐}_{d} \qquad ( 33 e )$$

$$( u , \cdot ) ∈ 𝒪𝒰 ( x , ( \text{?} ) ) \} ∀ ( \text{?} ) ∈ ( \text{?} ) . \qquad ( 33 f )$$

### Outer C&CG Procedure

Step 1 Set LB=−∞, UB=+∞, and set ( [symbol] ) by an initialization strategy.
Step 2 Solve outer master problem OMP defined with respect to ( [symbol] , \hat{π}). If infeasible, report the infeasibility of 2-StgRO and terminate. Otherwise, derive optimal value w, optimal solution (x*, ⋅) and update LB=w.
Step 3 For given x*, call the inner subroutine for feasibility ISF-C&CG, and obtain η_{f}(x*), as well as ( [symbol] ) if η_{f} (x*)>0.
Step 4 Cases based on η_{f}(x*).
(Case A): η_{f}(x*)>0
Update ( [symbol] )=( [symbol] )∪{( [symbol] )}.
(Case B): η_{f}(x*)=0
Call the inner subroutine for optimally ISO-C&CG, obtain ηₒ (x*) and ( [symbol] ), Update ( [symbol] )=( [symbol] )∪{ [symbol] )} and UB=min{UB, \hat{η}₀ (x*)}.
Step 5 If UB−LB≤TOL, return x* and terminate. Otherwise, go to Step 2.

In some non-limiting embodiments or aspects, various initialization strategies can be applied to set ( [symbol] ). For example, the naive one is to set it as an empty set. Also, as showed in the next section, the linear program relaxation of the recourse problem can be used to generate effective ( [symbol] )'s which also helps to yield valid lower and upper bounds to develop an approximation scheme.

### Convergence and Complexity

Compared to other parametric C&CG variants, the analyses of convergence and complexity issues for the aforementioned nested parametric C&CG are rather different. One main reason is the sophisticated structure of LP(x, ( [symbol] )) in (24). Note that its optimal solution generally is not an extreme point or not defined by a basis of [symbol] (x). Actually, its optimal solution is determined by, in addition to [symbol] (x), all (y_{d}, π)'s in set ( [symbol] ). Hence, our convergence and complexity analyses main depend on ( [symbol] ). Again, we assume that TOL=0 for all involved procedures.
Theorem 16. The aforementioned nested parametric CεCG will not repeatedly generate any ( [symbol] ) unless it terminates. Upon termination, it either reports that 2-StgRO in (1) is infeasible, or converges to its optimal value with an exact solution.
Proof. We first consider the feasibility issue. Note that 2-StgRO is infeasible if OMP becomes infeasible.
Claim 1: If ( [symbol] )* has been derived by one call of ISF-C&CG in some outer iteration, it will not be produced in any following iterations.
Proof of Claim 1: Since ( [symbol] )** has already been derived by ISF-C&CG, the formulation of OMP includes the cutting set in any following iteration.

$$\{ η \geq {c}_{2 , c} {y}_{c}^{( {\text{?}}^{*}} + {c}_{2 , d} {y}_{d}^{( {\text{?}}^{*}} {y}_{c}^{( {\text{?}}^{*}} \geq 0 , {y}_{d}^{( {\text{?}}^{*}} ∈ {𝕐}_{d} , ( u , \cdot ) ∈ 𝒪𝒰 ( x , ( {\text{?}}^{*} ) \} .$$

Consider x* obtained from computing OMP in one such iteration. We have

$$0 = min \{ \tilde{y} : {B}_{2 , c} {y}_{c} + {B}_{2 , d} {y}_{d} + 1 \tilde{y} \geq d - {B}_{1} {x}^{*} - Eu {y}_{c} \geq 0 , {y}_{d} ∈ {𝕐}_{d} , \tilde{y} \geq 0 , ( u , \cdot ) ∈ 𝒪𝒰 ( {x}^{*} , {( \text{?} )}^{*} ) \} ,$$

which is c_{f}(x*_{d}, ( [symbol] )*) if ( [symbol] )* is output by ISF-C&CG. Hence, once ISF-C&CG is called, it either reports η_{f}(x*)=0 or yields set ( [symbol] ) different from ( [symbol] )*to generate a new feasibility cutting set.
Claim 2: Assume that x* generated by OMP is feasible, and ( [symbol] )* is then derived by subroutine ISO-C&CG in the current iteration. If ( [symbol] )* has been obtained by ISOC&CG in some previous iteration, we have UB=LB.
Proof of Claim 2: As ( [symbol] )* has already been previously identified by ISO-C&CG, OMP has its corresponding cutting set (34) since then. After computing OMP in the current iteration we have

$$LB \geq {c}_{1} x * + \{ {c}_{2 , c} {y}_{c} + {c}_{2 , d} {y}_{d} : ( u , \cdot ) ∈ 𝒪𝒰 ( x * , ( \text{?} ) \text{*)} , ( {y}_{c} , {y}_{d} ) ∈ 𝒴 ( x , u ) \}$$

$$= {c}_{1} x * + {c}_{o} ( x * , ( \text{?} ) \text{*)} = {c}_{1} x * + {η}_{o} ( x \text{*)} \geq UB .$$

Hence, it leads to UB=LB.

Since both [symbol] and the set of extreme points and rays of D are fixed and finite, it follows that the nested parametric C&CG will terminate by either reporting the infeasibility of 2-Stg RO or converging to an exact solution after a finite number of iterations.

Given the structure of Ð and Remark 6 (iii), the number of ( [symbol] )'s is bounded by (| [symbol] |+| [symbol] |+1 [symbol] ^{|}. So, we can easily bound the number of iterations of this algorithm.
Corollary 13. The number of iterations of the algorithm before termination is bounded by (| [symbol] |+| [symbol] |+1 [symbol] ^{|}. Hence, the algorithm is of

$$O ( {( \begin{matrix}{n}_{{y}_{c}} + {μ}_{y} \\ {μ}_{y}\end{matrix} )}^{\vert {𝕐}_{d} \vert} )$$

iteration complexity.

Similar to other variants, this nested one converges if the first-stage solution repeats.

Proposition 17. If x* is an optimal solution to OMP in both iterations t₁ and t₂ with t₁<t₂, the nested parametric CESCG terminates and x* is optimal to 2-StgRO. Hence, if X is a finite set, the algorithm is of

$$O ( min \{ {( \begin{matrix}{n}_{{y}_{c}} + {μ}_{y} \\ {μ}_{y}\end{matrix} )}^{\vert {𝕐}_{d} \vert} , \vert 𝒳 \vert \} )$$

iteration complexity.

### Complex Two-Stage RO

In some non-limiting embodiments or aspects, mixed integer DDU and recourse with nested C&CG can be extended to compute a general case exactly. Also, parametric C&CG-MIU can be extended as an alternative method to derive approximate solutions. The method eliminates repetitions.

### Extending Nested C&CG for Exact Computation

In some non-limiting embodiments or aspects, modifications on the nested parametric C&CG are mainly made to its main outer C&CG procedure. For the two inner subroutines, almost no change needs to be made, except that mixed integer [symbol] (x) is employed and two correction problems are revised accordingly.

In some non-limiting embodiments or aspects, (u_{d}*, u_{c}*) denotes the optimal solution and ( [symbol] ) outputs from a subroutine either for feasibility (i.e., ISF-C&CG) or for optimality (i.e., ISO-C&CG) in one iteration. Similar to equations (9) and (24), the following optimization LP(x, u_{d}*, ( [symbol] )) supports the development of the main outer procedure, recalling [symbol] has been defined in Section 3.1.

$$\hat{η} ( x , {u}_{d}^{*} , ( \text{?} ) ) = max \{ \hat{η} - M ( {1}^{T} \tilde{u} ) : ( {u}_{c} , \tilde{u} ) ∈ \tilde{𝒰} ( x \vert {u}_{d}^{*} ) \}$$

$$\hat{η} \leq {c}_{2 , d} {y}_{d}^{t} + {( d - {E}_{d} {u}_{d}^{*} - {B}_{1} x - {E}_{c} {u}_{c} - {B}_{2 , d} {y}_{d}^{t} )}^{T} {π}^{t} , t = 1 , … , \vert {\hat{𝕐}}_{d} \vert \}$$

In such an example, KKT conditions or strong duality can characterize an optimal solution set.

$$𝒪𝒰 ( x , {u}_{d}^{*} , ( \text{?} ) ) = \{ \begin{matrix}\hat{η} \leq {c}_{2 , d}^{T} {y}_{d}^{T} + {( d - {E}_{d} {u}_{d}^{*} - {B}_{2 , d} {y}_{d}^{T} - {B}_{1} x - {E}_{c} {u}_{c} )}^{T} {π}^{t} , \\ t = 1 , … , \vert {\hat{𝕐}}_{d} \vert \\ {F}_{c} ( x ) {u}_{c} - \tilde{u} \leq h + Gx - {F}_{d} ( x ) {u}_{d}^{*} \\ {F}_{c}^{T} ( x ) λ + {\sum }_{t = 1}^{\vert {\hat{𝕐}}_{d} \vert} {E}_{c}^{T} {π}^{t} {μ}^{t} \geq 0 \\ M 1 - λ \geq 0 \\ {\sum }_{t = 1}^{\vert {\hat{𝕐}}_{d} \vert} {μ}^{t} = 1 \\ {μ}^{t} ( {c}_{2 , d}^{T} {y}_{d}^{T} + {( d - {E}_{d} {u}_{d}^{*} - {B}_{1} x - {E}_{c} {u}_{c} - {B}_{2 , d} {y}_{d}^{T} )}^{T} {π}^{t} - \hat{η} ) = 0 , \\ t = 1 , … , \vert {\hat{𝕐}}_{d} \vert \\ λ ∘ ( h + Gx - {F}_{d} ( x ) {u}_{d}^{*} - {F}_{c} ( x ) {u}_{c} + \tilde{u} ) = 0 \\ {u}_{c} ∘ ( {F}_{c}^{T} ( x ) λ + {\sum }_{t = 1}^{\vert {\hat{𝕐}}_{d} \vert} {E}_{c}^{T} {π}^{t} {μ}^{t} ) = 0 \\ \tilde{u} ∘ ( M 1 - λ ) = 0 \\ {u}_{c} \geq 0 , \tilde{u} \geq 0 , λ \geq 0 , {μ}^{t} \geq 0 , t = 1 , … , \vert {\hat{𝕐}}_{d} \vert\end{matrix} \}$$

For example, with the [symbol] set, the two correction problems for the feasibility and optimality subroutines, respectively, are defined as follows:

$${ICP}_{f} : {c}_{f} ( x * , {u}_{d}^{*} , ( \text{?} ) = min \{ y : ( {y}_{c} , {y}_{d} , \tilde{y} ) ∈ \tilde{𝒴} ( x * , {u}_{c} , {u}_{d}^{*} ) , ( {u}_{c} , \cdot ) ∈ 𝒪𝒰 ( x * , {u}_{d}^{*} , \text{?} ) ) \}$$

$${ICP}_{o} : {c}_{o} ( x * , {u}_{d}^{*} , ( \text{?} ) ) = min \{ {c}_{2 , c} {y}_{c} + {c}_{2 , d} {y}_{d} : ( {y}_{c} , {y}_{d} \} ∈ 𝒴 ( x * , {u}_{c} , {u}_{d}^{*} , ) , ( {u}_{c} , \cdot ) ∈ 𝒪𝒰 ( x * , {u}_{d}^{*} , \text{?} ) ) \}$$

In such an example, (̅ [symbol] ,̅ [symbol] \overline{, \hat{π}))} may denote one or more sets of (u_{d}, ( [symbol] )) obtained from executions of subroutines (e.g., including those from initialization if applicable). Then, the master problem OMP mainly consists of (unified) cutting sets defined with respect to each component of (̅ [symbol] ,̅ [symbol] \overline{, \hat{π}))}, in addition x∈X. By making use of [symbol] (x, u_{d}, ( [symbol] ) and \dot{u}(ũ) defined in (11), the unified cutting sets are

$$\{ η \geq {c}_{2 , c} {y}_{c}^{( {u}_{d ,} \text{?} )} + {c}_{2 , d} {y}_{d}^{( {u}_{d} \text{?} )} )$$

$${B}_{2 , c} {y}_{c}^{( {u}_{d ,} ( \text{?} ) )} + {B}_{2 , d} {y}_{d}^{( {u}_{d ,} \text{?} )} ) + {E}_{c} {u}_{c}^{( {u}_{d ,} \text{?} )} ) + \dot{u} ( {ũ}^{( {u}_{d ,} \text{?} )} ) \geq d - {E}_{d} {u}_{d} - {B}_{1} x$$

$${y}_{c}^{( {u}_{d ,} \text{?} )} \geq 0 , {y}_{d}^{( {u}_{d ,} ( \text{?} ) )} ∈ {𝕐}_{d}$$

$$( {u}_{c}^{( {u}_{d ,} \text{?} )} , \cdot ) ∈ 𝒪𝒰 ( x , {u}_{d} , ( \text{?} ) ) \} ∀ ( {u}_{d} , ( \text{?} ) ) ∈ \overline{( {\hat{𝕌}}_{d} , ( {\hat{𝕐}}_{d} , \hat{π} ) )}$$

In some non-limiting embodiments or aspects, whenever one call of some inner subroutine is completed and

$$( {u}_{d}^{*} , ( \text{?} ) )$$

is output, we expand set

$$\overline{( {\hat{𝕌}}_{d} , ( {\hat{𝕐}}_{d} , \hat{π} ) )} = \overline{( {\hat{𝕌}}_{d} , ( {\hat{𝕐}}_{d} , \hat{π} ) )} ⋃ \{ ( {u}_{d}^{*} , ( \text{?} ) ) \}$$

and then augment OMP in the following iteration of the main outer procedure.

In some non-limiting embodiments or aspects, during convergence of this variant, a new (u_{d}, ( [symbol] )) may be generated in every iteration by inner subroutines, or alternatively, LB=UB, leading to convergence. Since the total numbers of u_{d}, y_{d} and π are finite, respectively, the total number of distinct (u_{d}, [symbol] ) is finite. Such a result ensures the finite convergence, as well as can be used to bound the iteration complexity.

For example, in each iteration of the algorithm, a new combination of variables may be generated. These combinations are generated by inner subroutines or processes within the algorithm. Each iteration aims to improve the solution until convergence is reached.

In some non-limiting embodiments or aspects, the algorithm's convergence is determined by the relationship between the lower bound (LB) and the upper bound (UB) of the objective function. If LB equals UB, the algorithm converges, meaning it has found the optimal solution or has reached a point where no further improvement is possible.

In some non-limiting embodiments or aspects, the total number of distinct combinations of (̅ [symbol] ,̅ (̅ [symbol] \overline{, \hat{π}))} is finite to ensure that the algorithm's convergence is finite as well. In other words, the algorithm will eventually converge to the optimal solution within a finite number of iterations.

In some non-limiting embodiments or aspects, knowing that the total number of distinct combinations is finite allows us to bound the iteration complexity of the algorithm. By understanding the maximum number of possible combinations, we can estimate the maximum number of iterations required for the algorithm to converge. This helps in analyzing and optimizing the algorithm's performance.

### Modifying Parametric C&CG-MIU for Approximation

In some non-limiting embodiments or aspects, standard parametric C&CG can be applied, with rather simple changes, to approximately compute 2-Stg RO with polytope DDU and MIP recourse. In particular, both lower and upper bounds on the objective function value of the approximate solution are available in the algorithm execution, providing a quantitative evaluation for the approximation quality. Following that strategy, we modify parametric C&CG-MIU accordingly so that it handles 2-StgRO with mixed integer DDU and MIP recourse. When mixed integer DDU reduces to a polytope, it also reduces to that approximation variant of standard parametric C&CG. We assume that the relatively complete recourse property holds, i.e., the continuous portion of the recourse problem is feasible for (x, (u_{c}, u_{d}), y_{d}) ∈X× [symbol] (x)× [symbol] , allowing us to skip Step 3 and Step 4 (Case B) of parametric C&CG-MIU.

In some non-limiting embodiments or aspects, modifications to parametric C&CG-MIU are for constructing its subproblems. For example, the minimization recourse problem of SP2 in Equation (14) by the LP relaxation of the MIP recourse, we arrive at the following SP2.

$$SP 2 : {max}_{( {u}_{c} , {u}_{d} ) ∈ 𝒰 ( x \text{*)}} min \{ {c}_{2} y : y ∈ {𝒴}_{r} ( x * , u ) \} \qquad ( 35 )$$

In some non-limiting embodiments or aspects, a new subproblem, referred to as SP4.

$$SP 4 : {\tilde{η}}_{o} ( {x}^{*} , {y}_{d}^{*} ) = {max}_{( {u}_{c} , {u}_{d} ) ∈ 𝒰 ( x \text{*)}} min \{ {c}_{2 , c} {y}_{c} + {c}_{2 , d} {y}_{d}^{*} : {y}_{c} ∈ 𝒴 ( x * , u , {y}_{d}^{*} ) \} \qquad ( 36 )$$

Then, in Step 4 (Case A), we compute SP2 in (35), instead of the one in \sqrt{14}), to derive optimal

$$( {u}_{oc}^{*} , {u}_{od}^{*} )$$

and corresponding extreme point π* of the dual problem associated with [symbol] (x*, u), and perform remaining operations in this step. Note that cutting set in the form of 16 is defined with variables

$$( {y}_{c}^{( {u}_{od}^{*} , π \text{*)}} , {y}_{d}^{( {u}_{od}^{*} , π \text{*)}} ) .$$

Hence, integer restriction on

$${y}_{d}^{( {u}_{od}^{*} , π \text{*)}}$$

should be annexed to this cutting set. Regardless of that [symbol] replaces [symbol] in SP2, we have

$$𝒪𝒰 ( x , {u}_{od}^{*} , π \text{*)} ∈ 𝒰 ( x ) .$$

The generated cutting sets are valid, and the resulting master problem keeps being an effective relaxation to 2-StgRO. Therefore, the optimal value of master problem remains a valid lower bound.

A critical change is made in Step 5 where we compute the upper bound. Given

$$( {u}_{oc}^{*} , {u}_{od}^{*} )$$

output from Step 4, we solve the original MIP recourse problem defined on

$$𝒴 ( x * , ( {u}_{oc}^{*} , {u}_{od}^{*} ) )$$

and derive its optimal solution

$$( {y}_{c}^{*} , {y}_{d}^{*} ) .$$

### With

$$( x * , {y}_{d}^{*} ) ,$$

we then compute SP4 in (36) and obtain its optimal value

$${\tilde{η}}_{o} ( x * , {y}_{d}^{*} ) .$$

Clearly, by fixing y_{d} to

$${y}_{d}^{*} , {\tilde{η}}_{o} ( x * , {y}_{d}^{*} )$$

is larger than or equal to the actual ηₒ(x*), i.e., x*'s worst case performance defined with the original MIP recourse. It indicates that

$${c}_{1} x * + {\tilde{η}}_{o} ( x * , {y}_{d}^{*} )$$

is an effective upper bound to 2-StgRO. Hence, we adopt

$$UB = min \{ UB , {c}_{1} x * + {\tilde{η}}_{o} ( x * , {y}_{d}^{*} ) \}$$

to update UB in Step 5.

With both LB and UB being available in the execution of this algorithm, a quantitative evaluation on the quality of the approximate solution is provided. As for the termination, we can stop the algorithm once (i) a desired gap between LB and UB is achieved (which nevertheless may not be achievable); or (ii) a repeated x* is output from master problem; or (iii) a pre-defined limit on the number of iterations is reached. Actually, according to our numerical study, this approximation scheme often produces strong solutions with small amount of computational expenses, demonstrating a desirable advantage in computing practical-scale instances.

### Computational Study and Analysis

In some non-limiting embodiments or aspects, the performance of certain algorithms in solving robust facility location problems is provided.

The experiment is conducted using Julia programming language with JuMP (Julia for Mathematical Programming) and Gurobi 9.1, a professional mixed integer programming (MIP) solver. The experiments are run on a Windows PC with specific hardware specifications (E5-1620 CPU and 32 GB RAM). The parameter M is set to 10,000.

The relative optimality tolerance for the algorithms is set to 0.5%. This tolerance level indicates the acceptable deviation of the obtained solution from the optimal solution. Additionally, a time limit of 3,600 seconds (1 hour) is set for the solver to find a solution. If the solver exceeds this time limit, it may terminate without providing a solution.

Test instances are generated for three variants of robust facility location problems. Each variant differs in the characteristics of the robust facility location problems. The variants include: a mixed integer DDU set and a linear program recourse, a polytope DDU set and a mixed integer recourse, and mixed integer structures in both the DDU set and recourse.

The objective of the computational study is to demonstrate the modeling capabilities of mixed integer sets and evaluate the computational performance of the algorithms in solving robust facility location problems under different conditions. This includes assessing the efficiency of the algorithms in finding near-optimal solutions within the specified time limits and optimality tolerances.

### Capturing Induced Demand by Mixed Integer DDU

Consider the robust facility location model with uncertain induced demand. The first-stage decision determines the locations and service capacities of facilities. Then, after the demand is realized, service decision for each client-facility pair is made in the second-stage.

$$RFL - L : {min}_{( {x}_{c} , {x}_{d} ) ∈ X} {\sum }_{j ∈ J} ( {f}_{j} {x}_{d , j} + {a}_{j} {x}_{c , j} ) + ρ {max}_{u ∈ {𝒰}^{I} ( x )} {min}_{y ∈ 𝒴 ( x , u )} {\sum }_{i ∈ I} {\sum }_{j ∈ J} {c}_{ij} {y}_{ij} \qquad ( 37 a )$$

Set I is the set of client sites, and J⊆I consists of potential facility sites. Variable x_{d, j} is binary that takes 1 if a facility is built at site j and 0 otherwise; x_{c, j} determines the service capacity of facility at site j; and yᵢⱼ denotes the quantity of client i's demand served by facility at j. Parameters fⱼ and aⱼ are construction and unit capacity cost, respectively; cᵢⱼ is the unit transportation or service cost between client i and facility j; and coefficient ρ integrates two stages' costs together. The first and second-stages feasible sets are

$$X = \{ ( {x}_{c} , {x}_{d} ) ∈ {ℝ}_{+}^{\vert J \vert} \times {\{ 0 , 1 \}}^{\vert J \vert} : {\underline{A}}_{j} {x}_{d , j} \leq {x}_{c , j} \leq {\overline{A}}_{j} {x}_{d , j} ∀ j ∈ J \} , and \qquad ( 37 c )$$

$$𝒴 ( x , u ) = \{ y ∈ {ℝ}_{+}^{\vert I \vert \times \vert J \vert} : {\sum }_{j ∈ J} {y}_{ij} \geq {u}_{i} ∀ i ∈ I , {\sum }_{i ∈ I} {y}_{ij} \leq {x}_{c , j} ∀ j ∈ J \}$$

with Aⱼ and Āⱼ being the lower and upper bounds for the service capacity if a facility is installed at site j.

Let u denote the actual demand with uᵢ=uᵢ+ũᵢ, which are its nominal and induced demands for client i, respectively. It is often the case in practice that ũᵢ is related to facilities built at its neighboring sites j∈J(i), while such a connection may not be described precisely, assuming that two independent consulting services are employed to investigate such a connection, each of which provides an interval estimation on the contribution of a facility on ũᵢ, the two intervals are denoted by

$$[ {\underline{ζ}}_{j}^{i} , {\overline{ζ}}_{j}^{i} ] and [ {\underline{ξ}}_{j}^{i} , {\overline{ξ}}_{j}^{i} ] ,$$

which are typically different, for j∈J(i) and all i, respectively. Hence, we have

$${\sum }_{j ∈ J ( i )} {\underline{ζ}}_{j}^{i} {x}_{d , j} \leq {\tilde{u}}_{i} \leq {\sum }_{j ∈ J ( i )} {\overline{ζ}}_{j}^{i} {x}_{d , j} , and {\sum }_{j ∈ J ( i )} {\underline{ξ}}_{j}^{i} {x}_{d , j} \leq {\tilde{u}}_{i} \leq {\sum }_{j ∈ J ( i )} {\overline{ξ}}_{j}^{i} {x}_{d , j} , ∀ i ∈ I .$$

One approach is to construct an interval that just contains both estimation intervals to build a safe one, e.g.,

$$min \{ {\sum }_{j ∈ J ( i )} {\underline{ζ}}_{j}^{i} {x}_{d , j} , {\sum }_{j ∈ J ( i )} {\underline{ξ}}_{j}^{i} {x}_{d , j} \} \leq {\tilde{u}}_{i} \leq max \{ {\sum }_{j ∈ J ( i )} {\overline{ζ}}_{j}^{i} {x}_{d , j} , {\sum }_{j ∈ J ( i )} {\overline{ξ}}_{j}^{i} {x}_{d , j} \} , ∀ i ∈ I \qquad ( 38 )$$

which nevertheless may be an overestimation. As another strategy, we believe that one of those two estimations should be correct, but we just do not know which is that one. Moreover, we probably do not want to rely on any particular consulting service for all clients, which can be achieved by limiting the dependence on either one.

A mixed integer DDU set.

$${𝒰}^{I} ( x ) = \{ ( u , δ ) : {u}_{i} = {\underline{u}}_{i} + {\tilde{u}}_{i} ∀ i ∈ I \qquad ( 39 a )$$

$${\tilde{u}}_{i} \geq {δ}_{i}^{1} {\sum }_{j ∈ J ( i )} {\underline{ζ}}_{j}^{i} {x}_{d , j} + {δ}_{i}^{2} {\sum }_{j ∈ J ( i )} {\underline{ξ}}_{j}^{i} {x}_{d , j} ∀ i ∈ I \qquad ( 39 b )$$

$${\tilde{u}}_{i} \leq {δ}_{i}^{1} {\sum }_{j ∈ J ( i )} {\overline{ζ}}_{j}^{i} {x}_{d , j} + {δ}_{i}^{2} {\sum }_{j ∈ J ( i )} {\overline{ξ}}_{j}^{i} {x}_{d , j} ∀ i ∈ I \qquad ( 39 c )$$

$${δ}_{i}^{1} + {δ}_{i}^{2} = 1 ∀ i ∈ I , {\sum }_{i ∈ I} {δ}_{i}^{h} \leq {k}_{h} h = 1 , 2 \qquad ( 39 ∼ d )$$

$${\sum }_{i ∈ I} {\tilde{u}}_{i} \leq α {\sum }_{j ∈ J} {x}_{c , j} , {δ}_{i}^{1} , {δ}_{i}^{2} ∈ \{ 0 , 1 \} ∀ i ∈ I \qquad ( 39 e )$$

Using binary variables

$${δ}_{i}^{1} and {δ}_{i}^{2} ,$$

constraints in 39 d indicate that estimation from only one consulting service will be adopted for every client, while reliance on a particular consulting service across all i's is restricted by some limit. The constraint in 39e bounds the total induced demand by a multiple of the total installed capacities. To demonstrate the impact of mixed integer DDU, we also consider the following polytope DDU for comparison.

$${𝒰}^{c} ( x ) = \{ u : 39 a , 338 , 39 e \} \qquad ( 40 )$$

In some non-limiting embodiments or aspects, for a problem with 40 sites, with data on their locations, distances and nominal demands. The set J(i) contains all sites within 6 distance units to i. Construction cost fⱼ is set to the product between total demand of sites in J(i) and a random number between 0.4 and 2.4, unit capacity cost aⱼ is a random number between 0.3 and 0.5; capacity bounds Aⱼ and Āⱼ are set as 10% and 100% of the total demand in set J(j), respectively. In the DDU sets,

$${\underline{ζ}}_{j}^{i} and {\overline{ζ}}_{j}^{i}$$

are set to 1% and 3% of the total demand in set J(j), ξ̅ⱼ and ξⱼ are (1+r) of their ζⱼ counterparts with r being a changing parameter, and α is chosen to be 0.5. Also, coefficient ρ is set to 1.

Instances of RFL-L model with uncertainty sets [symbol] (x) and [symbol] (x) under different r and k₂ values (with k₁ fixed to 40) are computed. Results are shown in Table 1, including lower and upper bounds upon termination, relative gaps between those bounds, number of iterations, and computational time in seconds.

The analysis demonstrates the effectiveness of using mixed integer programming techniques to address uncertainty in facility location problems and highlights the trade-offs between solution quality and computational efficiency.

TABLE 1
Computational Results of RFL-L with [symbol] (x) or [symbol] (x)

| | [symbol] (x)/ Standard Parametric C&CG | | | | | [symbol] (x)/ Parametric C&CG-MIU | | | | | |
|---|---|---|---|---|---|---|---|---|---|---|---|
| r | LB | UB | Gap | Iter | Time(s) | k₂ | LB | UB | Gap | Iter | Time(s) |
| | | | | | | 1 | 22859.55 | 22859.80 | 0.00% | 3 | 118.88 |
| | | | | | | 2 | 22861.66 | 22863.50 | 0.01% | 3 | 80.38 |
| 0.1 | 23410.39 | 23410.39 | 0.00% | 3 | 114.30 | 3 | 22865.35 | 22867.15 | 0.01% | 3 | 81.58 |
| | | | | | | 4 | 22866.63 | 22870.41 | 0.02% | 3 | 130.12 |
| | | | | | | 5 | 22869.58 | 22873.55 | 0.02% | 3 | 76.59 |
| 0.2 | 24067.47 | 24067.47 | 0.00% | 3 | 90.80 | 1 | 22863.48 | 22863.98 | 0.00% | 3 | 108.31 |
| | | | | | | 2 | 22867.70 | 22871.37 | 0.02% | 3 | 129.03 |
| | | | | | | 3 | 22875.07 | 22878.67 | 0.02% | 3 | 150.62 |
| | | | | | | 4 | 22876.81 | 22885.19 | 0.04% | 3 | 75.25 |
| | | | | | | 5 | 23204.73 | 23205.80 | 0.00% | 5 | 261.47 |
| 0.3 | 24169.91 | 24169.92 | 0.00% | 2 | 99.85 | 1 | 22867.41 | 22868.15 | 0.00% | 3 | 107.07 |
| | | | | | | 2 | 22873.74 | 22879.24 | 0.02% | 3 | 78.50 |
| | | | | | | 3 | 23196.41 | 23204.24 | 0.03% | 5 | 192.13 |
| | | | | | | 4 | 23259.56 | 23264.87 | 0.02% | 5 | 258.62 |
| | | | | | | 5 | 23414.51 | 23417.67 | 0.01% | 5 | 114.75 |
| 0.4 | 24640.30 | 24640.31 | 0.00% | 2 | 167.50 | 1 | 22871.34 | 22872.33 | 0.00% | 3 | 110.65 |
| | | | | | | 2 | 23195.18 | 23201.48 | 0.03% | 4 | 239.47 |
| | | | | | | 3 | 23406.38 | 23408.18 | 0.01% | 5 | 141.45 |
| | | | | | | 4 | 23433.39 | 23447.23 | 0.06% | 4 | 171.22 |
| | | | | | | 5 | 23452.71 | 23460.94 | 0.04% | 4 | 91.64 |
| 0.5 | 25636.39 | 25636.4 | 0.00% | 2 | 281.45 | 1 | 22875.27 | 22876.50 | 0.01% | 3 | 114.73 |
| | | | | | | 2 | 23210.01 | 23211.20 | 0.01% | 3 | 154.43 |
| | | | | | | 3 | 23437.45 | 23444.53 | 0.03% | 4 | 153.94 |
| | | | | | | 4 | 23442.98 | 23462.16 | 0.08% | 3 | 134.08 |
| | | | | | | 5 | 23624.46 | 23649.00 | 0.10% | 3 | 155.10 |

From Table 1, it is obvious that the cost associated with [symbol] (x) is always higher than that with [symbol] (x). It is sensible as [symbol] (x), is defined on top of Equation (38), which is a larger decision dependent interval containing both estimation intervals and should yield a more conservative solution. A significant difference can often be seen between the costs with [symbol] (x) and [symbol] (x), respectively. Note that when two consulting services provide quite different estimations, e.g., r=0.5, the cost with [symbol] (x) may be 12% more than that with [symbol] (x), indicating that RFL-L with [symbol] (x) derives a less conservative solution. Finally, regarding the computational expenses for those two types of DDU sets, mixed integer DDU does not necessarily demand for a much longer computational time. Nevertheless, due to the more sophisticated structure underlying [symbol] (x), parametric C&CG-MIU typically needs more iterations to converge.

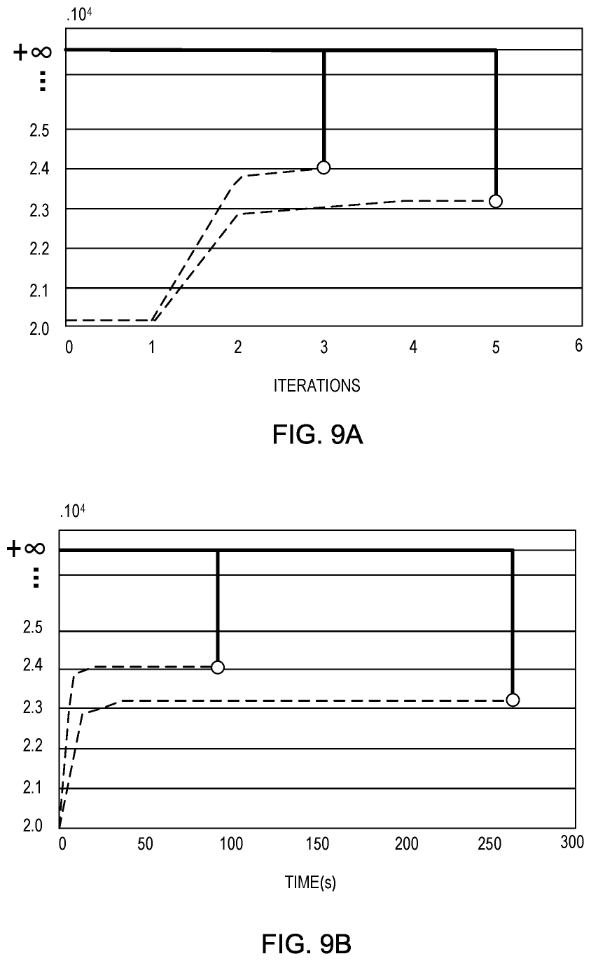

FIG. 9 illustrates the convergence behaviors of the algorithms over iterations as shown in FIG. 9A and the convergence behaviors of the algorithms over time as shown in FIG. 9B. The problem instances are represented by the specific parameters r=0.2 with k₂=5 for [symbol] (x) and [symbol] (x). The solid lines represent the upper bounds, while the dashed lines represent the lower bounds. The algorithms start with lower bounds calculated using Equation (4). Their starting lower bounds are w_{R} calculated according to equation (4). It can be observed that algorithms for [symbol] (x) and [symbol] (x) are efficient as both of them have a quick converge behavior. Between them, parametric C&CG-MIU for [symbol] (x) requires more iterations to converge. Especially, more subproblems are needed to ensure a feasible (actually optimal) solution.

$$= - {𝒰}^{1} ( x ) , r = 0.4 , {k}_{2} = 5 , -= - {𝒰}^{C} ( x )$$

### Modeling Decisions of Temporary Facility by MIP Recourse

Assuming that temporary facilities of fixed capacities can be built in the second-stage to serve clients, we modify RFL-L in Section 6.1 to a new variant RFL-I as in the following

$$RFL - I : {min}_{( {x}_{c} , {x}_{d} ) ∈ X} {\sum }_{j ∈ J} ( {f}_{j} {x}_{d , j} + {a}_{j} {x}_{c , j} ) + {max}_{u ∈ 𝒰 ( x )} {min}_{( y , z ) ∈ {𝒴}^{I} ( x , u )} {\sum }_{i ∈ I} {\sum }_{j ∈ J} {c}_{ij} {y}_{ij} + {\sum }_{j ∈ J} {f}_{j}^{+} {z}_{j}$$

where binary variable zⱼ denotes the construction decision of a temporary facility at site j, and

$${f}_{j}^{+}$$

is its fixed cost. Hence, the feasible set of the recourse problem is changed to

$${𝒴}^{I} ( x , u ) = \{ ( y , z ) ∈ {ℝ}_{+}^{\vert I \vert \times \vert J \vert} \times {B}^{\vert J \vert} : {\sum }_{j ∈ J} {y}_{ij} \geq {u}_{i} ∀ i ∈ I , {\sum }_{i ∈ I} {y}_{ij} \leq {x}_{c , j} + {h}_{j} {z}_{j} ∀ j ∈ J \}$$

with hⱼ denoting the capacity associated with the temporary facility at j.

Modifying the set of instances adopted in FIG. 9A, we set hⱼ to some number between 30 to 80 depending on the nominal demand of site j. Specifically, the higher uⱼ is, the larger hⱼ we have. Let ā denote the largest unit capacity cost among all aⱼ's. Then, we set fixed cost

$${f}_{j}^{+} = 5 {h}_{j} \overline{a} .$$

The rest parameters are the same as those in Section 6.1. Instances of RFL-I for [symbol] (x)= [symbol] (x) and [symbol] (x)= [symbol] (x) are computed by nested and extended nested parametric C&CG, respectively, with the naive initialization strategy. All results are shown in Table 2, where column “O-iter” reports the total number of iterations for outer C&CG procedure and “I-iter” the total number of iterations for inner C&CG ones.

TABLE 2
Computational Results of RFL-I with Temporary Facilities

| | RFL-I with [symbol] (x) | | | | | | RFL-I with [symbol] (x) | | | | | | |
|---|---|---|---|---|---|---|---|---|---|---|---|---|---|
| r | LB | UB | Gap | O-iter | I-iter | T(s) | k₂ | L | U | Gap | O-iter | I-iter | T(s) |
| | | | | | | | 1 | 19453.79 | 19543.11 | 0.46% | 2 | 5 | 69.51 |
| | | | | | | | 2 | 19449.94 | 19544.91 | 0.49% | 2 | 5 | 59.97 |
| 0.1 | 19510.41 | 19510.41 | 0.0 [symbol] | 2 | 10 | 1771.99 | 3 | 19460.59 | 19546.57 | 0.44% | 2 | 5 | 58.82 |
| | | | | | | | 4 | 19462.99 | 19548.24 | 0.44% | 2 | 5 | 64.84 |
| | | | | | | | 5 | 19466.59 | 19560.05 | 0.48% | 2 | 5 | 57.91 |
| | | | | | | | 1 | 19458.07 | 19545.10 | 0.45% | 2 | 5 | 61.89 |
| 0.2 | 19563.95 | 19597.24 | 0.1 [symbol] | 2 | 10 | 121.30 | 2 | 19465.34 | 19558.89 | 0.48% | 2 | 5 | 59.41 |
| | | | | | | | 3 | 19471.52 | 19484.03 | 0.06% | 2 | 10 | 462.75 |
| | | | | | | | 4 | 19476.32 | 19490.25 | 0.07% | 2 | 10 | 314.58 |
| | | | | | | | 5 | 19476.11 | 19498.26 | 0.11% | 2 | 10 | 362.53 |
| | | | | | | | 1 | 19462.36 | 19547.10 | 0.43% | 2 | 5 | 61.56 |
| | | | | | | | 2 | 19473.04 | 19485.07 | 0.06% | 2 | 10 | 879.67 |
| 0.3 | 19616.90 | 19664.66 | 0.2 [symbol] | 2 | 10 | 134.44 | 3 | 19471.35 | 19502.96 | 0.16% | 2 | 10 | 1099.01 |
| | | | | | | | 4 | 19489.97 | 19506.85 | 0.09% | 2 | 10 | 267.01 |
| | | | | | | | 5 | 19507.21 | 19520.53 | 0.07% | 2 | 10 | 465.45 |
| | | | | | | | 1 | 19466.60 | 19559.27 | 0.47% | 2 | 5 | 58.38 |
| 0.4 | 19706.25 | 19760.07 | 0.2 [symbol] | 2 | | | 2 | 19478.80 | 19493.07 | 0.07% | 2 | 10 | 335.22 |
| | | | | | 10 | 116.48 | 3 | 19488.39 | 19507.34 | 0.10% | 2 | 10 | 341.16 |
| | | | | | | | 4 | 19510.48 | 19526.26 | 0.08% | 2 | 10 | 290.12 |
| | | | | | | | 5 | 19510.21 | 19545.91 | 0.18% | 2 | 10 | 483.04 |
| | | | | | | | 1 | 19463.22 | 19480.34 | 0.09% | 2 | 10 | 454.08 |
| | | | | | | | 2 | 19478.74 | 19507.89 | 0.15% | 2 | 10 | 506.51 |
| 0.5 | 19837.78 | 19841.37 | 0.0 [symbol] | 3 | 10 | 115.86 | 3 | 19505.48 | 19535.94 | 0.16% | 2 | 10 | 273.31 |
| | | | | | | | 4 | 19510.10 | 19548.27 | 0.20% | 2 | 10 | 236.64 |
| | | | | | | | 5 | 19550.04 | 19562.41 | 0.06% | 2 | 11 | 307.42 |

[symbol]

indicates data missing or illegible when filed

In some non-limiting embodiments or aspects, from Table 2, the benefit of adopting mixed integer DDU is much less significant, although the cost with [symbol] (x) is consistently larger than that with [symbol] (x) across all instances. This can be explained by the introduction of temporary facilities in the recourse stage. Those temporary facilities lessen the dependence on the permanent ones that are determined before demand realization, and help to mitigate the demand variability on the total cost. Accordingly, a strong and cost-effective recourse capacity is highly desired in a complex uncertain environment, especially when the randomness is hard to have a sound understanding. Moreover, almost all instances can be solved in two to three outer iterations. In general, the computational time for RFL-I with [symbol] (x) may be much longer than that for RFL-I with [symbol] (x) and than that for RFL-L with [symbol] (x). Additionally, we note that numerical gaps are often noticeable among instances of RFL-I with [symbol] (x). Those observations indicate the computational challenge arising from interacting mixed integer structures in recourse and DDU sets.

### Approximations for DDU and MIP Recourse

In some non-limiting embodiments or aspects, each instance of RFL-I is computed using the approximation variant of parametric C&CG-MIU. Regarding the termination condition, the algorithm is completed when the master problem outputs a previously generated first-stage decision. This termination condition signifies that the algorithm has reached a solution where no further improvement is possible or necessary. All computational results are reported in Table 3.

We observe that non-zero gaps between lower and upper bounds exist when the algorithm terminates, which reflects the algorithm's approximation nature. Comparing RFL-I with [symbol] (x) and with [symbol] (x), it is interesting to see that the relative gaps for the latter case are significantly smaller than those for the former one. Basically, the majority of relative gaps with [symbol] (x) are less than 10%, while such gaps with [symbol] (x) are generally between 10% and 25%. It shows that this approximation variant works very well with mixed integer DDU sets. Indeed, comparing Tables 2 and 3, it is worth highlighting that this approximation variant generally produces high quality solutions in a fast fashion, and it can scale well to handle challenging instances.

TABLE 3
Approximation Results for RFL-I with Temporary Facilities

| | RFL-I with [symbol] (x) | | | | | RFL-I with [symbol] (x) | | | | | |
|---|---|---|---|---|---|---|---|---|---|---|---|
| r | LB | UB | Gap | Iter | Time(s) | k₂ | LB | UB | Gap | Iter | Time(s) |
| 0.1 | 19452.8 | 21266.37 | 8.53% | 3 | 229.52 | 1 | 19416.93 | 20189.23 | 3.83% | 3 | 215.86 |
| | | | | | | 2 | 19416.93 | 20278.05 | 4.25% | 3 | 200.97 |
| | | | | | | 3 | 19416.93 | 20338.76 | 4.53% | 3 | 246.52 |
| | | | | | | 4 | 19416.93 | 20399.11 | 4.81% | 3 | 318.36 |
| | | | | | | 5 | 19416.93 | 20459.45 | 5.10% | 3 | 180.08 |
| 0.2 | 19506.10 | 22765.87 | 14.32% | 3 | 73.06 | 1 | 19429.06 | 20083.26 | 3.26% | 3 | 240.58 |
| | | | | | | 2 | 19429.06 | 20260.91 | 4.11% | 3 | 292.58 |
| | | | | | | 3 | 19429.06 | 20382.26 | 4.68% | 3 | 280.08 |
| | | | | | | 4 | 19429.06 | 20502.88 | 5.24% | 3 | 178.69 |
| | | | | | | 5 | 19429.06 | 20623.38 | 5.79% | 3 | 222.33 |
| 0.3 | 19560.09 | 23682.97 | 17.41% | 3 | 73.41 | 1 | 19440.38 | 20722.05 | 6.19% | 3 | 255.38 |
| | | | | | | 2 | 19440.38 | 20988.53 | 7.38% | 3 | 213.98 |
| | | | | | | 3 | 19440.38 | 21170.91 | 8.17% | 3 | 160.41 |
| | | | | | | 4 | 19440.38 | 21352.17 | 8.95% | 3 | 280.86 |
| | | | | | | 5 | 19440.38 | 21533.85 | 9.72% | 3 | 213.83 |
| 0.4 | 19650.87 | 25277.39 | 22.26% | 3 | 78.88 | 1 | 19452.07 | 20615.67 | 5.64% | 3 | 224.38 |
| | | | | | | 2 | 19452.07 | 20970.97 | 7.24% | 3 | 279.91 |
| | | | | | | 3 | 19452.07 | 21214.15 | 8.31% | 3 | 124.14 |
| | | | | | | 4 | 19452.07 | 21456.11 | 9.34% | 3 | 217.47 |
| | | | | | | 5 | 19452.07 | 21698.34 | 10.359 | 3 | 160.34 |
| | | | | | | 1 | 19463.75 | 21035.65 | 7.47% | 3 | 255.36 |
| | | | | | | 2 | 19463.75 | 21480.46 | 9.39% | 3 | 135.19 |
| 0.5 | 19717.20 | 26294.94 | 25.02% | 3 | 108.36 | 3 | 19463.75 | 21785.53 | 10.669 | 3 | 157.75 |
| | | | | | | 4 | 19463.75 | 22088.36 | 11.889 | 3 | 106.12 |
| | | | | | | 5 | 19463.75 | 22391.15 | 13.079 | 3 | 102.37 |

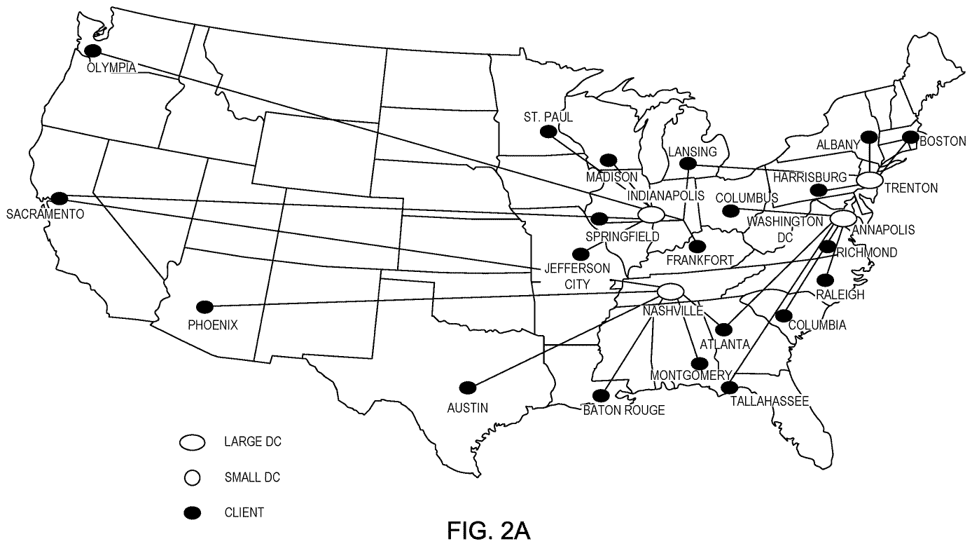

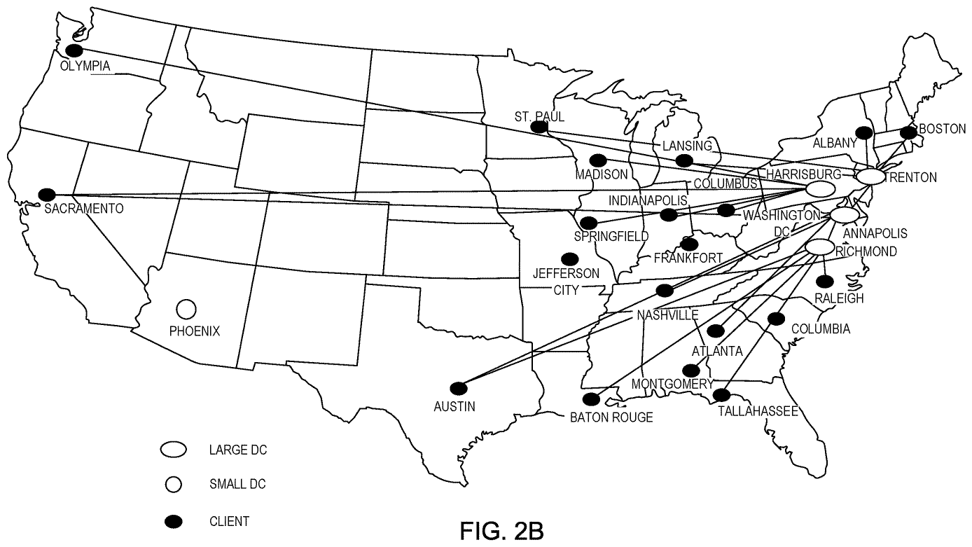

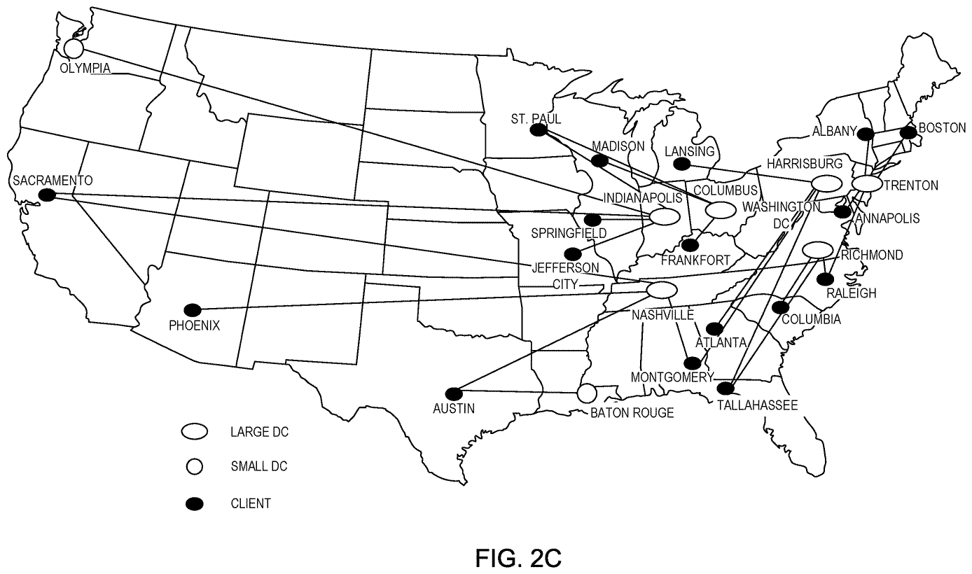

With reference to FIG. 2A-2C, in some non-limiting embodiments or aspects, one or more optimal distribution network designs are shown. In such an example, a distribution network design provides optimal system configuration and customer demand allocations. For example, emergency management is fundamental to support and maintain societal activates subject to disasters and emergencies, to minimize loss of life and property damage, and to facilitate recovery and reconstruction efforts. As a critical component, pre-emergency planning refers to the process of developing and implementing strategies and procedures to prepare for potential emergencies (including natural disasters and man-made incidents) before they actually occur. Our tool will be used to support pre- emergency planning, including the placements of various facilities and their capacities, as well as resource allocations, which certainly affects the effectiveness and the efficiency of recovery and reconstruction.

The decision-making scheme for the pre-emergency planning may consider two types of decisions, e.g., strategic decision to determine the system configuration before disasters or incidents, and the operational decision for recovery and reconstruction during and after.

The following mathematical formulation is provided:

$$max {\sum }_{i} ( {c}_{i} {x}_{i} + {p}_{i} {y}_{i} ) + {\sum }_{i} {\sum }_{j} {d}_{ij} {f}_{ij} + {ρ max}_{\begin{matrix}\sum {z}_{i} \leq k \\ {z}_{i} \leq {x}_{i} \\ {z}_{i} ∈ \{ 0 , 1 \}\end{matrix}} min {\sum }_{i} {\sum }_{j} {d}_{ij}^{′} {g}_{ij}$$

where i, j are indices for possible location sites for service facilities and service regions, respectively; variable (xᵢ, yᵢ, fᵢⱼ) are binary location variables, continuous capacity variables, and routine service effort between i and j; binary variable zᵢ denotes an occurrence of a major disaster at site i, if zᵢ=1; and continuous variable gᵢⱼ represents the recovery and reconstruction effort made during and after disasters/incidents. Parameters

$${c}_{i} , {p}_{i} , {d}_{ij} , {d}_{ij}^{′}$$

denote the fixed construction cost, unit capacity cost, unit service cost before disasters/incidents and during/after disasters/incidents, respectively. Parameter ρ unify those costs together.

In some non-limiting embodiments or aspects, the set U(x)={Σzᵢ≤k, zᵢ≤xᵢ, zᵢ ∈{0,1}}captures all possible scenarios with up to k disasters/incidents, often called the uncertainty set. In some examples, U(x) is a set determined by x, an actual DDU set. In such examples, the set may be reformulated into a DIU set that may be solved by classical methods.

In some non-limiting embodiments or aspects, with reference to FIG. 2A-2C, one or more optimal distribution network designs are shown. In such an example, a distribution network design provides optimal system configuration and customer demand allocations are provided.

In some non-limiting embodiments or aspects, with reference to FIG. 2A, a “Capacitated Distribution Network Design with Mixed Integer DDU” is shown, which comprises a Total Cost: $18,839 K, CPU Time: 7 seconds (by MIU-parametric CCG, 2023 paper). The figure shows and describes the outcome of an optimization problem related to designing a capacitated distribution network using mixed integer DDU.

In some non-limiting embodiments or aspects, the capacitated distribution network design refers to the optimization problem of designing a distribution network, which involves making decisions about the location and capacity of facilities (e.g., warehouses, distribution centers, etc.) and the routing of products to fulfill customer demand while considering capacity constraints.

In some non-limiting embodiments or aspects, two-stage RO with mixed integer DDU refers to the approach used to model uncertainty in optimization problems where the uncertainty depends on the decisions made. In this example, the uncertainties in factors such as demand, supply, or transportation costs are modeled using mixed integer variables.

In some non-limiting embodiments or aspects, the total cost (i.e., $18,839) represents the total cost associated with the designed distribution network. The total cost includes expenses related to facility setup, transportation, inventory holding, and/or the like.

In some non-limiting embodiments or aspects, the CPU Time: 7 seconds, indicates the computational time required to solve the optimization problem using a specific algorithm or method. In this example, the problem was solved using a parametric C&CG algorithm with mixed integer variables, and it took 7 seconds to obtain the solution.

In some non-limiting embodiments or aspects with reference to FIG. 2B, a “Capacitated Distribution Network Design with Continuous DDU” is shown, which includes total cost: $21,274, CPU time: 4 seconds (by parametric CCG, 2022 paper)”. In this example, the results indicate an optimization problem related to designing a capacitated distribution network, using a method referred to as continuous DDU.

In some non-limiting embodiments or aspects, the optimization problem of designing a distribution network involves decisions on the location and capacity of facilities (e.g., warehouses, distribution centers) and the routing of products to meet customer demand while considering capacity constraints.

Continuous DDU refers to the approach used to model uncertainty in optimization problems where the uncertainty depends on the decisions made. In this example, uncertainties in factors such as demand, supply, or transportation costs are continuous and depend on the decisions made in designing the network.

With reference to FIG. 2B, cost of $21,274, represents the total cost associated with the designed distribution network. The total cost includes expenses related to facility setup, transportation, inventory holding, and any other relevant factors.

CPU Time: 4 seconds indicates the computational time required to solve the optimization problem using a specific algorithm or method. In this case, the problem was solved using a parametric C&CG algorithm, and it took 4 seconds to obtain the solution. The provided information summarizes the outcome of an optimization problem related to distribution network design, including the total cost of the designed network and the computational time required to obtain the solution using the specific optimization method.

In some non-limiting embodiments or aspects, with reference to FIG. 2C, “Capacitated Distribution Network Design with DID” Total Cost: $32,451 K, CPU Time: 712 seconds (by basic CCG, 2013 paper) describes the outcome of an optimization problem related to designing a capacitated distribution network using a method known as Decision-Independent Demand (“DID”).

This example refers to the optimization problem of designing a distribution network, which involves making decisions about the location and capacity of facilities (e.g., warehouses, distribution centers) and the routing of products to fulfill customer demand while considering capacity constraints.

In this example, the DID is an approach used to model uncertainty in optimization problems where the uncertainty depends on the decisions made. In this context, it implies that uncertainties in factors such as demand, supply, or transportation costs are dependent on the decisions made in designing the network.

The total cost: $32,451, represents the cost associated with the designed distribution network. The total cost includes expenses related to facility setup, transportation, inventory holding, and any other relevant factors.

The CPU Time: 712 seconds indicates that the computational time required to solve the optimization problem using the specific algorithm or method. In this case, the problem was solved using a basic C&CG algorithm, and it took 712 seconds (or approximately 11.87 minutes) to obtain the solution.

The three problems describe uncertainty in distribution network design but use different methods and uncertainty models. Problem 2 (i.e., Continuous DDU) and Problem 1 (i.e., Mixed Integer DDU) show improvements in both total cost and computational time compared to Problem 3 (i.e., DID). Problem 1 shows the lowest total cost and reasonable computational time. For example, Problem 1 (“Mixed Integer DDU”) utilizes mixed integer variables for decision-dependent uncertainty modeling, which may lead to more accurate representations of real-world scenarios.

Problem 3 (i.e., DID) has the highest total cost and longest computational time among the three problems. Problem 2 (i.e., Continuous DDU) and Problem 1 (i.e., Mixed Integer DDU) exhibit significant improvements in total cost and computational time compared to Problem 3. Such an example indicates an effectiveness of continuous and mixed integer decision-dependent uncertainty modeling approaches. Problem 1 (i.e., Mixed Integer DDU) further enhances the optimization solution by incorporating mixed integer variables, potentially providing more precise solutions for complex distribution network design problems.

Overall, Problems 1 and 2 demonstrate advancements over Problem 3 in terms of both solution quality and computational efficiency, with Problem 1 offering the most improved results due to its use of mixed integer decision-dependent uncertainty modeling.

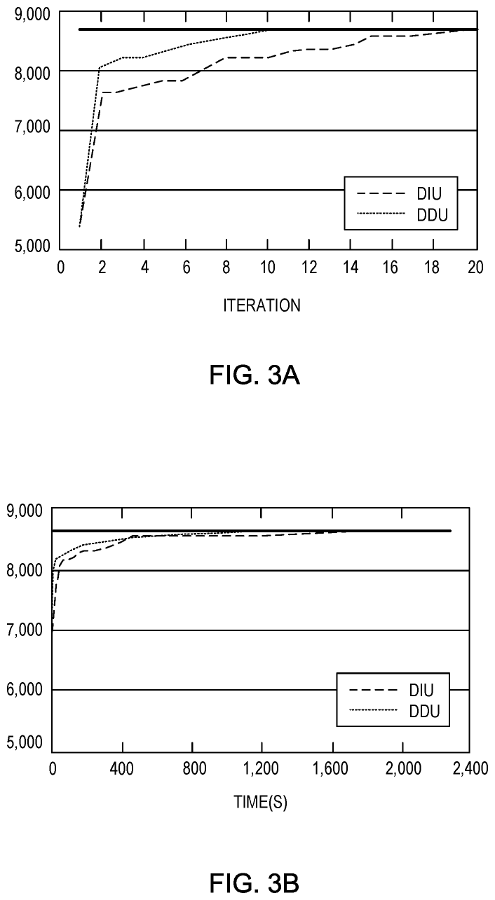

With reference to FIGS. 3A and 3B, the performance difference between the developed new tool (which solves two-stage RO DDU with MILPs) is shown in contrast to the classical method (which solves DIU). In some non-limiting embodiments or aspects, two-stage RO with DDU produces an optimal plan (by closing the gap between lower and upper bounds) with a smaller number of iterations and a much shorter computational time.

In some non-limiting embodiments or aspects, hardening and maintenance of power grid subject to N-k contingencies is provided.

In some non-limiting embodiments or aspects, power grid hardening and maintenance is essential to the resilience and reliability of the electrical power grid infrastructure. Note that modern power systems face a variety of potential threats, including natural disasters, cyber-attacks, physical attacks, and equipment outages. Hardening the power grid often involves physical protection (e.g., to bury power lines underground that is costly) to eliminate the likelihood and impact of disruptions, while maintenance typically involves routine inspections and repairs to ensure that the system is operating normally and efficiently. Hence, power grid hardening and maintenance is critical for ensuring the reliable delivery of electricity to customers, especially when demand is high or emergency situation may happen.

In some examples, given a budget and costs of hardening and maintenance activities, design and implementation of a cost-effective plan on hardening and maintenance is needed. The plan's effectiveness, however, is evaluated under various concerned threats. In the power industry, such threats are generalized to N-k contingencies (e.g., contingencies with up to k outages). In some examples, once a power line is hardened, it may be immune to any outage, and if it is maintained intensively, the outage probability for the power line is reduced significantly.

In such an example, the decision-making scheme for an optimal power grid hardening and maintenance plan may consider two types of decisions (e.g., hardening and maintenance decision before a N-k contingency, operational one for restoration after that contingency, etc.). In particular, the expected performance is important, and may include outage probabilities that are subject to the hardening or maintenance decisions.

The following mathematical formulation is provided:

$$max {\sum }_{i} ( {c}_{i} {x}_{i} + {p}_{i} {y}_{i} ) + ρ {max}_{P ∈ P ( x , y )} {E}_{P} \{ min {\sum }_{j} {d}_{j} {g}_{j} + M {\sum }_{k} {l}_{k} \}$$

where i, j, k are indices for power lines, generators, and nodes in the grid, respectively; variable (xᵢ, yᵢ) are binary hardening variables, continuous maintenance frequency variables; continuous variable P denotes a vector capturing the outage probabilities of all lines. Parameters cᵢ, pᵢ, dⱼ, and M denote the hardening cost, maintenance cost, generation cost per MW, and load shedding cost, respectively. Parameter ρ unifies those costs together.

In some non-limiting embodiments or aspects, the set P (x, y) includes each of the possible outage probabilities of power lines. For example, P (x, y) is a set determined by hardening decision x, and maintenance decision y, given that hardening a power line renders it outage-free and maintaining it with a high frequency may lead to a lower outage rate. Therefore, this is considered to be an actual DDU set. When there is no maintenance decision, P (x) may be reformulated into a DIU set that may be solved by classical methods. In such examples, E_{P} denotes the expected performance with respect to probability vector P.

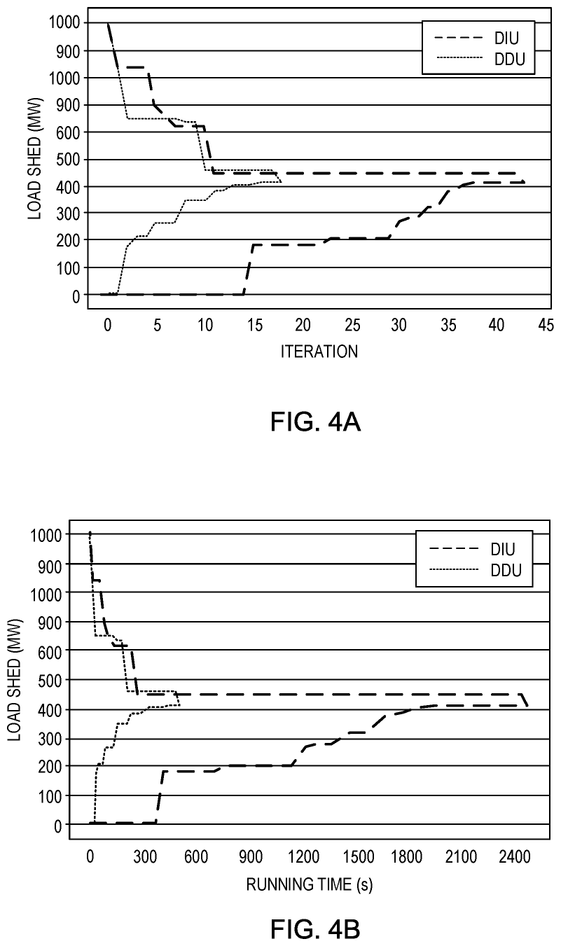

In some non-limiting embodiments or aspects, standard testbed IEEE RTS-24 power grid is used to illustrate the developed new tool. With reference to FIG. 4, a comparison of both the computational time and the number of iterations is shown, when only hardening decisions are involved. As shown, a case can be solved as both DDU and DIU respectively. However, as is clearly shown, the new tool using two-stage RO with DDU is significantly improved. Note the hardening budget is 3, considering up to N-5 contingencies with all non-hardening lines of equal outage rates.

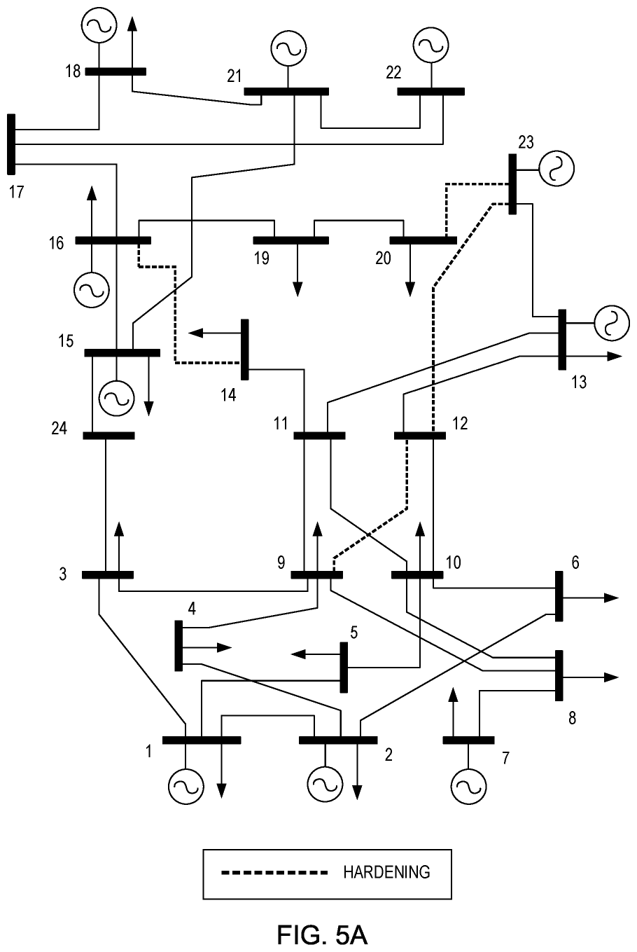

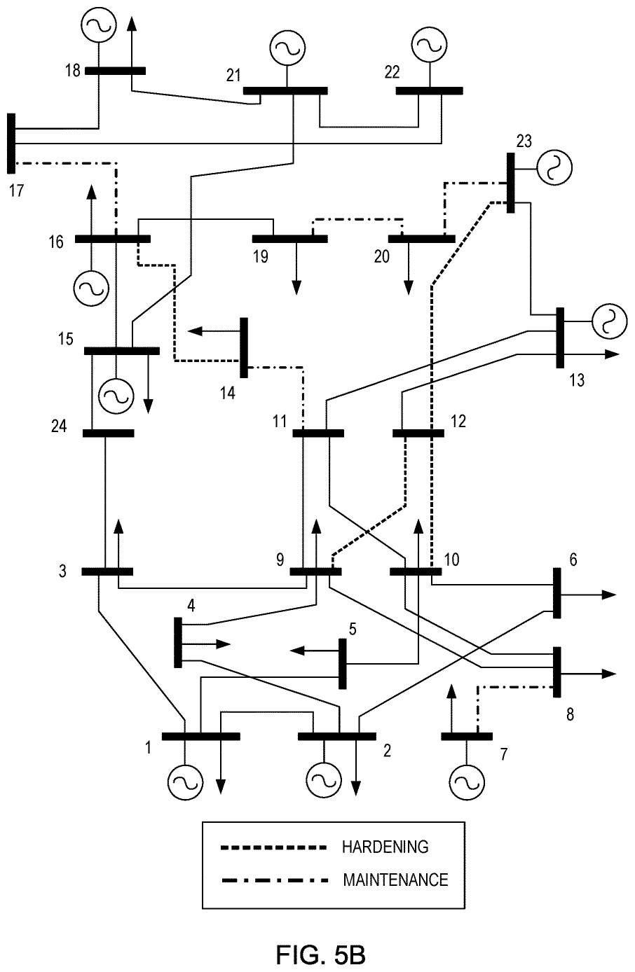

In some non-limiting embodiments or aspects, with reference to FIG. 5 and FIG. 6, the impact of hardening and maintenance is shown. FIG. 5 and FIG. 6 highlight an improvement with maintenance, rather than completely depending on costly hardening operations, a much more resilient power grid with lower cost is achieved. With reference to FIG. 5, in some non-limiting embodiments or aspects, the hardening budget is 4, with up to 423MW unsatisfied demand (i.e., load shedding) under a N-5 contingency. With reference to FIG. 6, in some non-limiting embodiments or aspects, the hardening budget is 3, maintenance budget is 5 (but splitable among all lines), with up to 412MW unsatisfied demand under a N-5 contingency. By maintaining 5 lines, an improvement of multiple millions of dollars for hardening a line may be saved while, the grid is also improved and becomes more reliable. In some non-limiting embodiments or aspects, a two-stage RO comprises a unit commitment (“UC”) problem within a power systems (i.e., a fundamental optimization problem in power system operation and scheduling). The UC problem determines the on/off status of generators in a power system to minimize power generation costs while meeting demand requirements. It is a fundamental optimization problem in power system operation and scheduling. Two-stage RO in UC determines the on/off status of generators to minimize power generation cost while satisfying demand. Two-stage RO is widely used to find solutions in UC to hedge against uncertainties, such as renewable energy output and load. The first-stage involves determining the on/off status of generators based on available information and possibly assumed values for uncertain parameters. The second-stage occurs after uncertain parameters are observed, where power generation levels and dispatch decisions are made to adapt to the realized conditions. Traditional two-stage RO with decision independent uncertainty can only deal with random uncertainties in UC problem, some uncertain factors are highly influenced by other conditions. Traditional two-stage RO typically deals with random uncertainties in UC problems. However, some uncertain factors, such as customer demand, may be highly influenced by other conditions, such as electricity prices. This interdependence between uncertain parameters and decision variables is known as DDU. For example, customer power demand is significantly affected by the electricity cost (e.g., price). If demand response can be modeled in two-stage RO for UC, generators can be scheduled in a way that can not only provide reliable power service, but also economically. In [1], robust UC model extends to consider uncertain demand endogenously depending on electricity price. By considering uncertain demand that depends endogenously on electricity prices, a time-of-use pricing may be determined and employed to determine peak and off-peak price rates and periods. Customers may adjust their load levels based on these price rates, affecting overall demand. In such an example, the model is solved using a parametric C&CG algorithm, which is a computational technique for efficiently solving parametric uncertainty. This model is well solved by parametric columns-and-constraint generation algorithm.

In some non-limiting embodiments or aspects, a two-stage RO addresses uncertainties in the assignment and scheduling problem within a healthcare domain, such as focusing on telemedicine assignments. In healthcare, resources (e.g., operating rooms, medical equipment, pharmaceuticals, etc.) are in high demand and need efficient scheduling and management. However, planning decisions in healthcare face uncertainties related to various factors, including the duration of services, the possibility of service providers (or receivers) not showing up (e.g., no-shows, etc.), or other unpredictable events. Two-stage RO may be utilized to solve telemedicine assignment problems, considering uncertainties related to service duration and no-show behaviors. The objective is to optimize the assignment of medical resources while accounting for these uncertainties. The uncertain factors, instead of modeling as random events without considering their correlation with scheduling decisions are modeled so that service duration is influenced by the type of service, and the rate of no-shows, which may vary throughout the day. Such correlations may be accounted for as decision-dependent uncertainty. In such examples, uncertain factors such as service duration and no-show behaviors may be modeled as decision-dependent uncertainty, as they are influenced by scheduling decisions (i.e., the optimization model should consider the relationship between uncertain factors and the scheduling decisions being made). In some cases, scenario generator 104 efficiently solves the robust telemedicine assignment problem using a parametric column-and-constraint generation algorithm. Scenario generator 104 efficiently solves the large-scale optimization problems with decision-dependent uncertainty, to generate reliable and efficient schedules and allowing medical centers to use two-stage RO and a parametric algorithm to address these challenges and generate reliable schedules for telemedicine assignments.

In some non-limiting embodiments or aspects, of two-stage RO for real-world applications, considering uncertainties and correlated factors in decision-making involves optimizing the allocation of berths and scheduling of quay cranes at ports to efficiently handle vessel arrivals, loading, unloading operations, and/or the like. Uncertainties in vessel arrival times and loading/unloading operation times pose challenges to the decision-making process. In some non-limiting embodiments or aspects, an application of two-stage RO involves a model of the berth allocation and quay crane scheduling problem while considering uncertain vessel arrival times. The approach aims to hedge against uncertainties and generate robust schedules that can adapt to varying conditions. The operation of freight systems at ports involves many correlated uncertainties. For example, a period of time a vessel can berth depends not only on its arrival time but also on berth availability, which in turn is influenced by the service time of previous vessels and quay crane scheduling. These correlations need to be accurately modeled to make effective decisions. In such an example, a decision-dependent approach is generated (e.g., RO system 106 generates a two-stage RO for the real-world application to accurately model correlated uncertainties. This approach considers the interdependencies between uncertain factors and scheduling decisions, enabling more realistic representations of the problem. The complexity of the freight operation system at ports poses problems for the use of advanced optimization techniques. For example, a parametric C&CG algorithm is mentioned as a suitable method for efficiently solving large-scale optimization problems with DDU.

In some non-limiting embodiments or aspects, other examples of applications of two-stage RO (e.g., production/inventory management for perishable products, pre-disaster location/storage of emergency commodities, station location/vehicle rebalancing in bike-sharing systems, etc.) demonstrate the improvements of two-stage RO in addressing uncertainty and optimizing decision-making processes across various domains.

In some non-limiting embodiments or aspects, production and inventory management for perishable products, pre-disaster location/storage of emergency commodities, and station location/vehicle rebalancing in bike-sharing systems, scenario generator 104 determines uncertainties by generating a set of scenarios that represent possible realizations of uncertain parameters.

In some non-limiting embodiments or aspects, scenario generator 104 may generate scenarios representing different demand patterns, shelf lives, and supply chain disruptions. These scenarios may comprise the variability and uncertainty associated with factors such as customer demand, product perishability, and supply chain reliability. By simulating various demand and supply scenarios, decision-makers can assess the robustness of their production and inventory management strategies.

In some non-limiting embodiments or aspects, scenario generator 104 may generate scenarios representing different disaster scenarios (e.g., earthquakes, hurricanes, floods, etc.), each scenario having varying levels of severity and impact. These scenarios may include uncertain factors such as the location and timing of disasters, population displacement, and infrastructure damage. By considering a range of possible disaster scenarios, scenario generator 104 develops robust plans for the location and storage of emergency commodities.

In some non-limiting embodiments or aspects, scenario generator 104 may generate scenarios representing different patterns of bike usage, user demand, and traffic conditions. These scenarios may capture the uncertainty associated with factors of usage such as user behavior, weather conditions, and transportation infrastructure. By simulating various usage scenarios, scenario generator 104 optimizes station locations and vehicle rebalancing strategies to ensure efficient operation of the bike-sharing system under different conditions (i.e., different or varied conditions comprising each of the different scenarios, etc.).

In some non-limiting embodiments or aspects, scenario generator 104 solves a problem for determining the impact of uncertainty on decision-making processes by generating and measuring a diverse set of scenarios (e.g., a wide range of scenarios, with a range of different uncertainties, different uncertainty values, etc.). By considering a range of possible outcomes, scenario generator 104 generates robust solutions, and thereby develops strategies that improve performance (e.g., perform optimally, well, measurably better, improved metrics, etc.) across different scenarios and are resilient to unexpected events.

In some non-limiting embodiments or aspects, scenario generator 104 improves the robustness and optimality of the solutions obtained through two-stage RO. For example, “optimality” or “optimal” refers to the quality of a decision or solution with respect to achieving the defined objectives of the optimization problem. In some examples, when addressing uncertainty, achieving optimality involves comprising not only finding a solution that performs well under expected or average conditions but also ensuring that the solution is robust against variations or deviations from those expected conditions.

In some non-limiting embodiments or aspects, in production and inventory management for perishable products, scenario generator 104 provides an optimal solution for determining the optimal levels of production, inventory, and distribution that minimize costs while meeting demand. In addition, scenario generator 104 generates a robust solution, protecting against fluctuations in demand, supply disruptions, or changes in market conditions.

In pre-disaster location and storage of emergency commodities, scenario generator 104 provides an optimal solution identifying the optimal locations for storage facilities and distribution centers to minimize response times and maximize the effectiveness of emergency relief efforts. The solution should also be robust against different disaster scenarios and uncertainties in the timing and severity of events.

In station location and vehicle rebalancing in bike-sharing systems, scenario generator 104 provides an optimal solution for determining the optimal locations for bike stations and the most efficient strategies for rebalancing bikes across stations to meet user demand. In addition, scenario generator 104 generates a robust solution, protecting against fluctuations in demand, traffic conditions, and operational constraints.

In some non-limiting embodiments or aspects, scenario generator 104 provides optimal improved solutions that are both efficient in expected conditions and robust in the face of uncertainties and variations, effectively balancing performance objectives with risk mitigation considerations.

In some non-limiting embodiments or aspects, the generation of cutting sets involves identifying and incorporating constraints or decision rules that improve the robustness and optimality of the solutions obtained through two-stage RO.

For example, scenario generator 104 generates, for production and inventory management for perishable products, one or more cutting sets. The one or more cutting sets in this scenario may include constraints or rules that enforce limits on inventory levels, production capacities, and delivery schedules. For example, constraints may be added to ensure that inventory levels do not exceed storage capacity or that production rates do not exceed available resources. Additionally, rules may be implemented to prioritize the allocation of resources to high-demand products or to manage inventory turnover effectively.

For example, scenario generator 104 generates, for pre-disaster location and storage of emergency commodities, one or more cutting sets. The one or more cutting sets may involve constraints related to the location and capacity of storage facilities, transportation networks, and distribution channels. For example, constraints may be added to ensure that emergency commodities are stored in strategically located facilities that are resilient to various disaster scenarios. Additionally, rules may be incorporated to optimize the allocation of resources and minimize response times during emergencies.

For example, scenario generator 104 generates, station location and vehicle rebalancing in bike-sharing systems, cutting sets. The one or more cutting sets for bike-sharing systems may include constraints or rules governing the placement of stations, the availability of bikes and docks at each station, and the routing of vehicles for rebalancing purposes. For example, constraints may be added to ensure that stations are located in areas with high demand and adequate infrastructure support. Rules may be implemented to optimize vehicle routing and rebalancing strategies to minimize operational costs and maximize service reliability.

In some non-limiting embodiments or aspects, scenario generator 104 generates the one or more cutting sets are generated based on the specific requirements and objectives of the optimization problem. For example, scenario generator 104 generates the optimization model by guiding the search for robust and efficient solutions that account for uncertainties and variability in the system.

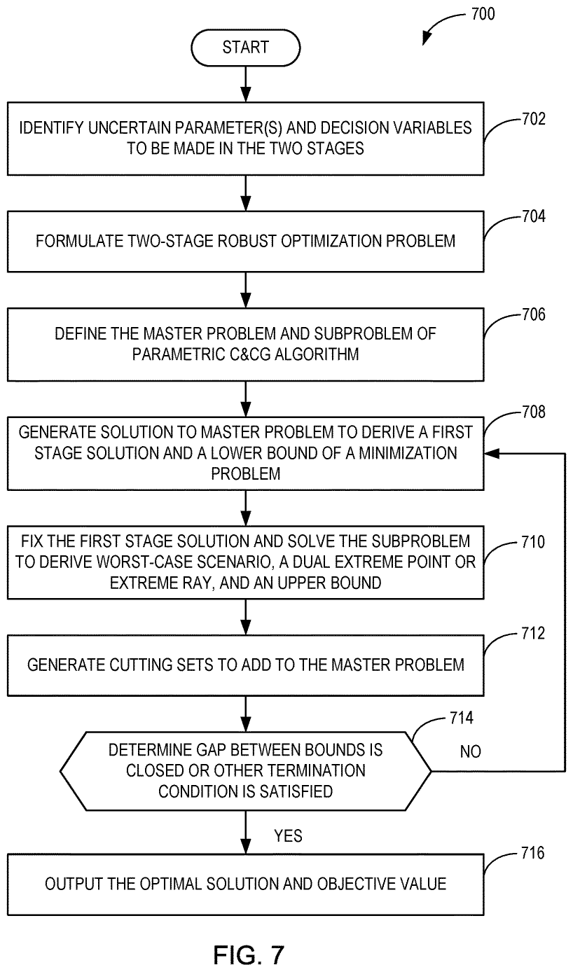

FIG. 7 illustrates a flowchart of a non-limiting embodiment or aspect of a process 700 for two-stage RO with decision dependent uncertainty. In some non-limiting embodiments or aspects, one or more of the steps of process 700 may be performed (e.g., completely, partially, and/or the like) by scenario generator 104 (e.g., one or more devices of scenario generator 104), RO system 106 (e.g., one or more devices of RO system 106), data optimizer 114 (e.g., one or more devices of data optimizer 114). In some non-limiting embodiments or aspects, one or more of the steps of process 700 may be performed (e.g., completely, partially, and/or the like) by another system, another device, another group of systems, or another group of devices, separate from or including the aforementioned devices, such as data source 102a-102n (e.g., one or more devices of data source 102a-102n), MILP program solver 108 (e.g., one or more devices of MILP program solver 108), simulation model 110 (e.g., one or more devices of simulation model 110), ML engine 112 (e.g., one or more devices of ML engine 112), and communication network 116 (e.g., one or more devices of communication network 116).

As shown in FIG. 7, at step 702, process 700 may include identifying uncertain parameters and decision variables to be made in the two stages. For example, in some non-limiting embodiments or aspects, RO System 106 identifies uncertain parameters and decision variables to be made in the two stages. For example, in a two-stage optimization problem, the first-stage involves making decisions that may be fixed before uncertainties are realized, while the second-stage involves making decisions after the uncertainties are revealed.

In some non-limiting embodiments or aspects, a two-stage RO with DDU solution may include at least one of a supply chain management system, a transportation planning system, an energy system, and/or the like. In some examples, a two-stage RO with DDU solution includes a potential impact of uncertainty on a decision, and/or the like.

In some non-limiting embodiments or aspects, RO system 106 generates a two-stage RO problem with DDU by determining a plurality of first-stage decision variables for solving a deterministic linear program. The first-stage problem may provide an objective function that represents the goal or objective that the decision-maker aims to achieve in the initial stage. For example, first-stage optimization comprises objective decisions (e.g., on energy investments, such as building new power plants, upgrading existing infrastructure, or implementing energy conservation measures, etc.). RO system 106 determines a first-stage optimization that minimizes a worst cost (e.g., a least favorable outcome, an unfavorable cost in view of the foreseeable circumstances, etc.) or maximizes a worst expected profit (e.g., a least favorable profit, unfavorable profit in view of the foreseeable circumstances, etc.) over each scenario of the optimization problem. The decision variables may include a type, a capacity, a location of the energy investments, and/or the like.

RO system 106 may determine one or more constraints (e.g., a resource availability, capacity constraint, operational constraint, relevant factor, etc.) that comprise the first-stage problem to represent limitations, requirements, or conditions that must be satisfied when solving the first-stage problem. In RO, the first-stage problem may incorporate uncertainty by considering uncertain parameters that affect the decision-making process. Solving the first-stage problem provides a solution including values assigned or associated with decision variables. The solution to the first-stage problem represents the initial decisions made by the decision-maker to optimize the system based on the information at hand.

RO system 106 determines a first-stage RO by defining an objective function for an optimization problem, including minimizing costs, maximizing profit, or minimizing lead times. For example, RO system 106 may form an RO model with expressions (e.g., mathematical algorithms, etc.) that represent one or more relationships between decision variables and constraints based on an objective function. In some examples, RO system 106 may obtain an objective function defined as a linear combination of decision variables, representing an aspect (e.g., cost, profit, etc.) to be optimized.

In some non-limiting embodiments or aspects, RO system 106 provides the first-stage decisions for a supply chain system such as determining production levels, facility capacities, transportation routes and/or the like, before the demand for products is known. A second-stage decision might involve adjusting inventory levels, transportation schedules, and allocation of resources based on realized demand and other uncertainties.

In some non-limiting embodiments or aspects, RO system 106 determines decision variables associated with production levels, inventory levels, transportation routes, facility capacities, and/or the like. For example, RO system 106 determines one or more constraints or limitations on the decision variables (e.g., constraints that represent the limitations and requirements of systems being represented by the objective function, a supply chain network, a power grid system, etc.), such as capacity constraints, demand constraints, lead time constraints, and/or the like.

In some non-limiting embodiments or aspects, RO system 106 generates decision variables as integer or continuous variables based on the nature of the problem. RO system 106 may solve the first-stage of a two-stage optimization problem with MILP solver 108. MILP solver 108 may optimize first-stage decisions by generating (e.g., determining, considering, etc.) each possible scenario and uncertainty. However, RO system 106 may not directly solve a second-stage problem or decision. Instead, one or more second-stage decisions are typically represented as part of the optimization problem constraints, forming a scenario-based optimization model.

In some non-limiting embodiments or aspects, first-stage decisions are optimized using the MILP solver. In some examples, first-stage decisions are optimized using the MILP solver before second-stage decisions may be determined using techniques such as recourse modeling, stochastic programming, and/or the like. These techniques involve solving separate optimization problems conditioned on different scenarios or realizations of uncertainties, often using linear or nonlinear programming solvers.

In some non-limiting embodiments or aspects, RO system 106 determines two-stage RO for DDU with a parametric C&CG. For example, parametric C&CG extends basic C&CG, when the uncertainty set is formed by a polyhedron and the recourse problem is formed by an LP. In such an example, an approximation quality may be quantitatively evaluated, as both lower and upper bounds of the objective function value generated during the execution of the algorithm.

In some non-limiting embodiments or aspects, a DIU set may be converted to a DDU set. For example, RO with a significantly improved computational performance is determined based on domain expertise, structural properties, and/or the like, for DDU sets that occur naturally, such as a mixed integer set to explicitly represent hidden fundamental connections between decisions and worst case scenarios. Converting DIU to a mixed integer DDU set may be performed to leverage the improved algorithms described herein for faster computations of large-scale problems (e.g., or instances, scenarios of large-scale problems, etc.).

In some non-limiting embodiments or aspects, data collection and processing includes collection of historical data (e.g., demand, pricing, supply, etc.). For example, RO system 106 or data optimizer 114 cleans, transforms, organizes, and/or the like, to place data for optimizing into a suitable format. In some non-limiting embodiments or aspects, RO system 106 may estimate an expected value and a variability of a plurality of uncertain parameters for one or more different scenarios of the first-stage decision.

In some non-limiting embodiments or aspects, first-stage optimization comprises making decisions (e.g., on energy investments, such as building new power plants, upgrading existing infrastructure, or implementing energy conservation measures, etc.). The objective of the first-stage optimization is to minimize a worst case (e.g., a least favorable outcome, unfavorable cost in view of the foreseeable circumstances, etc.) or maximize the worst expected profit (e.g., a least favorable profit, unfavorable profit in view of the foreseeable circumstances, etc.) over all scenarios. The decision variables can include the type, capacity, and location of the energy investments.

In some non-limiting embodiments or aspects, the actual values of the uncertain parameters are obtained, observed, or received. Based on the actual values, the scenario that best represents the observed values can be selected. In some examples, after the first-stage decisions are made, the actual values of the uncertain parameters, such as demand, become available in real-time. The system observes these values and selects the scenario that best represents the observed values.

As shown in FIG. 7, at step 704, process 700 may include formulating a two-stage RO problem. For example, in some non-limiting embodiments or aspects, RO system 106 determines a formulation of a two-stage RO problem. For example, RO system 106 may identify the decision problem and the uncertain parameters that affect the decision.

In some non-limiting embodiments or aspects, RO system 106 formulates a two-stage RO problem by determining a mathematical optimization model that incorporates two stages of decision-making while considering uncertainties in the system. In some examples, RO system 106 formulates a two-stage RO problem specifying decision variables, objective functions, constraints, uncertainty sets, and/or the like for forming both stages of the optimization problem.

RO system 106 determines one or more decision variables for a first-stage and a second-stage of decision-making. For example, RO system 106 determines the one or more decision variables that the decision-maker may control or adjust to achieve their objectives (e.g., based on the objective function being optimized, based on goals, based on criteria, and/or the like to be optimized at each decision-making point etc.). In a two-stage RO problem, decision variables are typically defined for both the first and second stages of decision-making.

RO system 106 determines an objective function. For example, RO system 106 determines an objective function that the decision-maker seeks to optimize. In a two-stage RO problem, separate objective functions may be included for each stage, each representing the goals or criteria to be optimized at each decision-making point (e.g., a first stage, a second stage, etc.).

In some non-limiting embodiments or aspects, RO system 106 determines one or more constraints that are satisfied in order to achieve a feasible solution. For example, RO system 106 determines constraints (e.g., representing a physical requirement, an operational requirement, another requirement of the system being optimized, etc.) that may influence the decision variables.

In some non-limiting embodiments or aspects, RO system 106 determines one or more uncertainty sets. For example, RO system 106 represents the possible realizations of uncertain parameters in the system by determining one or more uncertainty sets. In such an example, RO system 106 determines the one or more uncertainty sets to model a range of potential values that may represent the uncertain parameters. In such an example, RO system 106 may determine the one or more uncertainty sets to account for variability or to hedge against adverse outcomes.

An MILP solver is a software tool designed to solve optimization problems that involve both linear objective functions and linear constraints, with some or all decision variables restricted to integer values. MILP solvers are powerful tools for formulating and solving optimization problems with discrete decision variables, such as those encountered in many two-stage optimization problems. While MILP solvers do not explicitly handle uncertainty, they can be used in conjunction with other techniques, such as scenario generation or RO formulations, to address uncertainty in the optimization model.

In summary, both RO system 106 and MILP solvers play crucial roles in creating mathematical models for two-stage optimization problems under uncertainty and solving fundamental optimization models. They provide the necessary tools and algorithms to formulate and solve these complex problems, enabling decision-makers to generate robust and optimal solutions that account for uncertainty in the system.

In some non-limiting embodiments or aspects, decision variables are the parameters that the decision-maker may control or adjust to optimize a two-stage RO. The uncertain parameters may introduce unpredictability or variability into the decision-making environment. In such an example, RO system 106 may adjust interaction between decision variables and uncertain parameters to adapt the robust decision models to different scenarios and uncertainties. RO system 106 may adjust based on the object function to make decisions using decision variables that perform well across a range of possible values or scenarios of uncertain parameters.

Decision variables represent the key choices or actions that the decision-maker can take to optimize a certain objective. In this way, the goal of the optimization problem is to find the values of these variables that lead to the best possible outcome.

In some non-limiting embodiments or aspects, RO system 106 determines uncertainty based on decision variables in a manufacturing system. In such an example, the decision variable may include production levels (e.g., the quantity of each product to be manufactured, etc.), inventory levels (e.g., the amount of each product to be held in inventory), resource allocation (e.g., allocation to resources, such as labor, machines, materials, etc.) to different production tasks.

In some non-limiting embodiments or aspects, RO system 106 determines uncertainty based on decision variables in financial systems. In such an example, decision variables may include investment amounts (e.g., the amount of money to be invested in different assets or projects, etc.), loan amounts (e.g., an amount of a loan to be taken or extended, etc.), budget allocations (e.g., an allocation of budget to different departments or projects, etc.), and/or the like.

In some non-limiting embodiments or aspects, RO system 106 determines that the decision variables in the first-stage involves identifying the one or more parameters that a decision-maker may have control over when making initial decisions. In such an example, such decisions are made without complete knowledge of the uncertain parameters that will be revealed in the second-stage, and the goal is to make these decisions robust to a range of possible outcomes in the face of uncertainty.

In some non-limiting embodiments or aspects, RO system 106 performs mathematical optimization based on mixed integer structures that accurately describe physical systems characterized by discrete states, alternative choices, logic relationships or behavior discontinuities. For example, mixed integer structures can be used to build tight approximations for complicated functions that otherwise might be computationally infeasible. In some examples, an exact solution may include enumeration on all possible discrete choices.

In some non-limiting embodiments or aspects, a fixed set is determined to model the uncertainty (e.g., the concerned uncertainty, etc.) based on a decision-dependent set to capture non-fixed uncertainty that changes with respect to the choice of the decision maker. For example, DDU often occurs in our societal systems (e.g., consumers' demand, drivers' route selections, system maintenance, etc.) that are largely affected by price or tolls set by an operator of a system. For system maintenance, component reliability or failure rates may depend on maintenance decisions.

In some non-limiting embodiments or aspects, a first-stage problem is solved by choosing the decision variables that minimize the cost over each of a number of selected scenarios.

As shown in FIG. 7, at step 706, process 700 may include defining the master problem and subproblem of parametric C&CG algorithm. For example, in some non-limiting embodiments or aspects, RO system 106 defines the master problem and subproblem of parametric C&CG algorithm. For example, generating a first-stage optimization problem may include generating a first-stage decision before providing one or more uncertain parameters.

In some non-limiting embodiments or aspects, RO system 106 defines the parametric C&CG algorithm by iterating the master problem and subproblem (e.g., recourse problem, second-stage problem, etc.) to form a partitioning of the overall optimization problem into two distinct components (i.e., the master problem and the subproblem). The master problem and the subproblem provide a specific purpose in the optimization process.

In some non-limiting embodiments or aspects, defining the master problem and subproblem in the parametric C&CG algorithm involves partitioning the optimization problem into manageable components and specifying the objectives, decision variables, and constraints for each component to guide the search for an optimal solution.

In some non-limiting embodiments or aspects, a master problem represents the overarching optimization problem. The master problem forms a basis for the search for an optimal solution. In such an example, when determining the master problem, RO system 106 may provide determinations in the first-stage, which are determined without knowing the specific realizations of uncertain parameters. RO system 106 may solve the master problem by generating an initial solution based on an initial guess for the optimization process. The initial solution serves as a starting point for refining the solution through iterations, each iteration made to improve the initial solution (e.g., an iteration of the initial solution, etc.).

In some non-limiting embodiments or aspects, the subproblem refines the solution obtained in solving the master problem. For example, RO system 106 solves the subproblem by solving a simplified version of the first-stage RO problem, based on a reduced (e.g., streamlined, etc.) set of decision variables and/or constraints. By solving the subproblem, an improved solution may be generated by solving the master problem after incorporating additional information and/or refining the decision variables to align (e.g., to align better, etc.) with the objectives of the master problem.

The parametric C&CG algorithm causes an iteration between RO system 106 and scenario generator 104, so that iterating between solving the master problem and the subproblem generates an optimal solution to the overall optimization problem. In this example, the master problem provides an initial solution, which is then refined through successive iterations of the subproblem. In such an example, RO system 106 and scenario generator 104 continue an iterative process until a solution (e.g., a satisfactory solution, etc.) is obtained and meets desired optimization criteria.

As shown in FIG. 7, at step 708, process 700 may include generating the solution to the master problem to derive a first-stage solution and a lower bound of a minimization problem. For example, in some non-limiting embodiments or aspects, RO system 106 generates the solution to the master problem to derive a first-stage solution and a lower bound of a minimization problem.

In some non-limiting embodiments or aspects, RO system 106 generates the solution to the master problem to derive a first-stage solution and a lower bound of a minimization problem after defining the master problem and subproblem of the parametric C&CG algorithm.

In some non-limiting embodiments or aspects, the master problem and subproblem are determined so that solving the two-stage optimization problem is decomposed into manageable components. For example, RO system 106 decomposes the problem to eliminate the complexity of an overall problem. For example, dividing the problem into smaller parts to make it easier to develop and implement optimization algorithms.

In some non-limiting embodiments or aspects, dividing the master problem and subproblem improves a systematic optimization algorithm. The parametric C&CG algorithm typically follows an iterative process, such that the master problem provides initial solutions that are refined through successive iterations of the subproblem. Establishing the structure of these components helps in designing the iterative optimization process.

In some non-limiting embodiments or aspects, separating the master problem and subproblem enables the optimization algorithm to focus on generating initial solutions and refining them iteratively. This approach provides efficiency over a system attempting to solve the entire optimization problem in one step. By generating initial solutions from the master problem, RO system 106 may quickly derive insights into the problem and establish a baseline for further improvements.

In some non-limiting embodiments or aspects, RO system 106 derives a lower bound of the objective function value of the optimization problem. For example, RO system 106 defines the master problem, solves it and then solves a subproblem derived from the master solution. In such an example, the lower bound of the objective function provides information about the quality of solutions obtained during the optimization process. In addition, the lower bound may guide subsequent iterations of the algorithm towards improving solution quality.

In some non-limiting embodiments or aspects, determining the master problem and subproblem before generating the solution to the master problem allows for a structured and efficient approach to solving optimization problems. The information determined from the lower bound of the objective function provides improvements to the decomposition, algorithm design, efficient solution generation, and leads to improved optimization outcomes.

In some non-limiting embodiments or aspects, RO system 106 or scenario generator 104 includes a suitable MILP solver 108 to implement the formulated mathematical model. MILP solver 108 may obtain input including the objective function, decision variables, constraints, and/or the like, input into the MILP solver in a suitable format (e.g., algebraic modeling language, GAMS, an API, etc.). In such an example, MILP solver 108 is programmed or configured with relevant parameters and options to customize the solving process based on the problem characteristics and computational resources available.

In some non-limiting embodiments or aspects, MILP solver 108 generates an optimal solution (e.g., a substantially optimal solution, a near-optimal solution, etc.). MILP solver 108 may determine insights into the optimal production levels, inventory levels, transportation routes, facility capacities, and/or the like. MILP solver 108 determines the solution's performance in terms of the defined objectives and constraints. MILP solver 108 may perform sensitivity analysis to determine an impact based on changes in input parameters on the solution. MILP solver 108 identifies critical factors affecting the supply chain performance.

In some non-limiting embodiments or aspects, RO system 106 solves the first-stage problem by applying a chosen optimization technique to find one or more values of the decision variables that optimize the objective function while satisfying the constraints (e.g., finding both continuous and discrete values for decision variables, etc.).

In some non-limiting embodiments or aspects, RO system 106 determines from the solution obtained by solving the first-stage optimization problem, one or more initial decisions generated based on the available information, considering both continuous and discrete decision variables. The robustness of such decisions with respect to uncertainties is further addressed in the second-stage problem through recourse.

In some non-limiting embodiments or aspects, RO system 106 may generate a first-stage solution to a master problem to determine one or more optimal decisions for the first-stage of the optimization process. RO system 106 may determine the one or more optimal decisions based on available information and applied (e.g., assumed, predicted, etc.) values for the uncertain parameters. In such an example, the first-stage solution represents the initial decisions made by the decision-maker before observing the actual realization of uncertain parameters.

In some non-limiting embodiments or aspects, a lower bound represents the minimum possible objective function value that can be achieved. By solving the master problem, RO system 106 may derive a lower bound on the objective function value of the overall optimization problem. For example, the lower bound provides a benchmark for evaluating the quality of solutions obtained during the optimization process.

As shown in FIG. 7, at step 710, process 700 may include fixing the first-stage problem and solving the subproblem to derive a worst-case scenario, a dual extreme point or extreme ray, and an upper bound. For example, in some non-limiting embodiments or aspects, scenario generator 104 may fix the first-stage problem and solve the subproblem to derive a worst-case scenario, either a dual extreme point or an extreme ray, and an upper bound.

In some non-limiting embodiments or aspects, fixing the first-stage problem and solving the subproblem to derive a worst-case scenario, a dual extreme point or an extreme ray, and an upper bound. For example, in some non-limiting embodiments or aspects, scenario generator 104 may fix the first-stage problem and solve the subproblem to derive a worst-case scenario. The scenario generator 104 may fix the first-stage problem and solve the subproblem to derive a dual extreme point or an extreme ray. The scenario generator 104 may fix the first-stage problem and solve the subproblem to derive and an upper bound.

In some non-limiting embodiments or aspects, RO system 106 or scenario generator 104 may fix the first-stage problem. For example, RO system 106 may fix the first-stage problem by holding (e.g., halting, etc.) the decisions made in the first-stage of the optimization problem fixed or constant. For example, the values of the decision variables determined in the first-stage are not allowed to change during subsequent iterations of the optimization algorithm. In some non-limiting embodiments or aspects, the decisions made in the first-stage are fixed until RO system 106 optimizes the first-stage problem after refining the solution based on the second-stage solution.

In some non-limiting embodiments or aspects, solving the subproblem to derive a worst-case scenario, a dual extreme point or an extreme ray, and an upper bound further comprises RO system 106 determining a subproblem that is a component of the overall optimization problem. In such an example, RO system 106 determines a subproblem that focuses on refining the solution obtained from the first stage. For example, RO system 106 implements a second-stage solution that includes a simplified solution of the optimization problem. In some examples, a reduced set of decision variables or constraints is provided to scenario generator 104.

In some non-limiting embodiments or aspects, scenario generator 104 derives a worst-case scenario, a dual extreme point, or an extreme ray. For example, after a first-stage problem is fixed and the subproblem is solved, specific properties of the optimization problem may be derived to improve the first-stage problem. For example, scenario generator 104 may determine the worst-case scenario. For example, scenario generator 104 determines a scenario which represents the most unfavorable outcome of uncertain parameters. Alternatively, scenario generator 104 determines the dual extreme point (e.g., an extreme ray, etc.) which includes specific points or directions in the dual space of the optimization problem.

In some non-limiting embodiments or aspects, scenario generator 104 derives an upper bound. For example, in addition to deriving specific properties of the optimization problem, such as worst-case scenarios or extreme points, scenario generator 104 may also derive an upper bound on the objective function value. For example, an upper bound represents an estimate of the maximum achievable value of the objective function under the given constraints and uncertainty considerations.

In some non-limiting embodiments or aspects, scenario generator 104 solves the subproblem to derive worst-case scenarios, dual extreme points, extreme rays, and upper bounds to optimize at least a stage for finding the solution to a first-stage problem. scenario generator 104 obtains the solution obtained in the first-stage RO, determines the properties of the optimization problem associated with the first-stage RO. In such an example, scenario generator 104 provides insights into the quality and robustness of the solutions obtained.

In some non-limiting embodiments or aspects, scenario generator 104 may determine the second-stage decision variables by solving a set of linear programs. For example, solving each linear program in a set of linear programs corresponding to a second-stage scenario. In such an example, the objective function of the two-stage RO formulation comprises the expected value of the first-stage decision and a distance of a deviation (worse case) from the expected value. In this way, an optimal solution of a two-stage RO problem with decision-dependent uncertainty is determined which minimizes the worst-case cost over each possible realization of the uncertain parameters.

In some non-limiting embodiments or aspects, scenario generator 104 solves the subproblem (e.g., second stage problem, etc.) for each scenario of the set of linear programs addressing the uncertainties introduced in the first-stage by considering different possible scenarios or realizations of the uncertain parameters. In such an example, scenario generator 104 solves the subproblem so that one or more decisions made in solving the first-stage are adjusted or refined based on the actual outcomes of the uncertain parameters.

In some non-limiting embodiments or aspects, scenario generator 104 solving the second-stage optimization for each scenario, solves a second-stage optimization problem that represents a recourse (e.g., a corrective decision-making process, etc.) based on the outcomes of the first-stage and the realized values of the uncertain parameters.

In some non-limiting embodiments or aspects, scenario generator 104 solves the second-stage problems to provide adjustments or corrections for the decisions made in the first-stage. In some examples, the adjustments account for actual outcomes of the uncertain parameters.

In some non-limiting embodiments or aspects, scenario generator 104 aims to improve robustness and adaptability (e.g., to create decisions that are robust and adaptable to different scenarios, etc.). Based on solutions generated by scenario generator 104 across a range of possible scenarios (e.g., outcomes. etc.), the resilience of the decision-making process to uncertainty is improved. For example, scenario generator 104 solves the second-stage problem for each scenario to determine effectiveness of the decisions made in the first-stage and how they perform under different realizations of uncertain parameters. In this way, RO system 106 may refine decision-making in response to actual information to improve the robustness of the overall solution.

In some non-limiting embodiments or aspects, generating the critical scenarios includes scenario generation. For example, generating a set of scenarios that represent the possible values of the uncertain parameters. The scenarios can be generated using statistical methods, such as time-series analysis, or using simulations that take into account patterns, market conditions, and other relevant factors.

In some non-limiting embodiments or aspects, generating the critical scenarios includes generating a set of scenarios that represent the possible values of the uncertain parameters. The scenarios may be generated using historical data, expert opinions, or statistical methods. In addition, scenario generator 104 solves a subproblem in order to validate the optimization results against real-world scenarios and historical data to ensure the model's accuracy and reliability. In such an example, scenario generator 104 refines the mathematical model or solution approach based on insights (e.g., feedback, etc.) captured (e.g., determined, gained, etc.) during the validation process.

In some non-limiting embodiments or aspects, scenario generator 104 iterates through in the two-stage RO to incorporate one or more changes, additions, or updates and continuously improves the optimization solution.

In some non-limiting embodiments or aspects, scenario generator 104, when solving the second-stage problem for each scenario using parametric techniques, includes applying optimization methods that systematically consider variations in the values of uncertain parameters. Parametric techniques are used to determine how the solution to the optimization problem changes as the values of specific parameters are varied.

For example, scenario generator 104 generates multiple scenarios that represent different possible realizations of uncertain parameters. In some examples, scenario generator 104 generates the multiple scenarios with parametric techniques that introduce a parameter into the optimization problem determining how the solution changes as this parameter varies. In such an example, the uncertain parameters (e.g., variations in demand, resource availability) are treated as parameters, and parametric techniques are applied to address the variations.

Scenario generator 104 may form, for each scenario, a second-stage optimization problem. In such an example, the problem represents a corrective decision-making process based on the outcomes of the first-stage and the realized values of the uncertain parameters.

In some non-limiting embodiments or aspects, scenario generator 104 solves the second-stage problem parametrically. For example, scenario generator 104 (or RO system 106) generates a parametric that is applied to solve (e.g., when solving, etc.) a second-stage problem for each scenario. For example, scenario generator 104, when solving the optimization problem for different values of the uncertain parameters, effectively explores different optimizations to determine how a solution to the master problem varies with changes in parametric values. In such an example, the solutions obtained from solving the second-stage problem for each scenario using parametric techniques also provides insights into how the initial decisions made in the first-stage should be adjusted or corrected based on the actual outcomes of the uncertain parameters.

In such an example, parametric techniques enhance robustness of a decision-making process by systematically considering a range of possible scenarios. In this way, scenario generator 104 may develop decisions (e.g., a predetermined number of solutions related to each scenario being tested, etc.) that perform well across different parameter values, thereby, improving the adaptability, the sensitivity, and the resilience of the overall solution to uncertainty and provides changes in parameter values that make more informed and robust decisions in response to uncertainty.

In some non-limiting embodiments or aspects, solving the second-stage problem comprises selecting the decision variables that optimize the objective function based on the chosen scenario.

In some non-limiting embodiments or aspects, second-stage optimization comprises decision making based on actual operations (e.g., dispatching power plants, adjusting energy prices, or curtailment of renewable energy sources, etc.). The objective of the second-stage optimization is to optimize the operation of the energy system based on the chosen scenario. In the power grid example, the decision variables may include the variables such as a dispatch schedule, energy prices, or an amount of curtailment.

As shown in FIG. 7, at step 712, process 700 may include generating cutting sets to add to the master problem. For example, in some non-limiting embodiments or aspects, RO system 106 generates cutting sets to add to the master problem.

In some non-limiting embodiments or aspects, RO system 106 solves the two-stage RO formulation using a variety of techniques. As an example, a C&CG method for decision-dependent uncertainty based on a specific problem being addressed, a number of scenarios, and an amount of available computational resources.

In some non-limiting embodiments or aspects, optimizing a solution to the first-stage decision includes minimizing a worst-case cost over all possible realizations of the uncertain parameters in the second-stage problem. For example, generating optimal solutions and the corresponding objective values for each scenario comprises solving the second-stage problem. For example, solving the second-stage problem by selecting the decision variables which optimize the objective function based on the chosen scenario. In some examples, second-stage optimization includes making decisions based on operations. The objective of the second-stage optimization is to optimize the operation of the energy system based on the chosen scenario. The decision variables can include the dispatch schedule, the energy prices, and the amount of curtailment.

In some non-limiting embodiments or aspects, RO system 106 generates cutting sets to add to the master problem by providing at least one cutting plane.

In some non-limiting embodiments or aspects, RO system 106 generates and adds a cutting plane (e.g., a cutting set, etc.) to strengthen a formulation of an RO problem. In such an example, by adding additional constraints, known as cutting planes, to the problem iteratively, the cutting planes serve to tighten the feasible region of the problem. Thereby, leading to an improved solution quality, accuracy, and convergence properties. In some non-limiting embodiments or aspects, RO system 106 generates cutting sets (e.g., collections of constraints, etc.) that are derived based on the current solution to the optimization problem. In such an example, the cutting plane is generated based on properties of the problem and the solution obtained for eliminating or reducing the gap between the current solution and the optimal solution. Cutting sets may be generated using techniques such as the separation problem, which involves identifying violated constraints based on the current solution.

In some non-limiting embodiments or aspects, RO system 106 adds the cutting plane to the master problem. For example, RO system 106 incorporates the cutting planes as additional constraints in the master problem, thereby strengthening the formulation and guiding the optimization algorithm toward better solutions.

In some non-limiting embodiments or aspects, the iterative refinement of generating cutting planes and adding them to the master problem is performed for each second-stage solution. After adding the cutting planes, the optimization algorithm is re-solved to obtain a new solution. In such an example, if the solution does not meet certain optimality criteria, additional cutting sets may be generated based on the current solution and added to the master problem. This iterative process continues until a satisfactory solution is obtained. This approach helps improved solution accuracy, quality, and convergence properties.

In some non-limiting embodiments or aspects, RO system 106 formulates and solves the optimization problem under uncertainty. The solution incorporates RO considerations to ensure that the solutions obtained are resilient to variations in uncertain parameters.

In some non-limiting embodiments or aspects, scenario generator 104 generates scenarios that represent possible values of uncertain parameters. These scenarios are generated to evaluate the performance of potential solutions (e.g., scenarios, etc.) under different conditions and to assess robustness. In some non-limiting embodiments or aspects, scenario generator 104 may not directly determine cutting sets or constraints used in the optimization formulation.

As shown in FIG. 7, at step 714, process 700 may include determining a gap between a lower and an upper bound is closed or other termination conditions is satisfied. For example, in some non-limiting embodiments or aspects, scenario generator 104 determines that a gap between a lower bound and an upper bound is closed or other termination conditions is met. As an example, scenario generator 104 adjusts a second-stage decision according to feedback comprising the one or more uncertain parameters from the first-stage decision. In some examples, the one or more uncertain parameters are modeled as a plurality of possible scenarios in a second-stage problem, such that the first-stage decision is optimized against the plurality of possible scenarios.

In some non-limiting embodiments or aspects, process 700 may include repeating until the lower and upper bounds have converged. For example, in some non-limiting embodiments or aspects, scenario generator 104 may repeat steps 708 to 714 until the lower and upper bounds have converged.

In some non-limiting embodiments or aspects, RO system 106 determines a solution to the first-stage decision for a specified tolerance level of optimality. In some examples, RO system 106 generates one or more cutting planes from a sub-problem solution in the second-stage problem for determining one or more optimal values. RO system 106 may adjust the feasible region of the first-stage decision by dynamically adding one or more cutting planes to one or more linear constraints associated with the first-stage decision in a previous iteration. In response to determining an infeasible solution in the first-stage decision, adding cutting planes to the first-stage decision until a feasible solution is obtained, such that the solution to the first-stage decision is further defined by the plurality of cutting planes determined during each next iteration.

In some non-limiting embodiments or aspects, RO system 106 generates one or more optimality conditions in a parametric way expresses the one or more optimality conditions as a function of a parameter, such as the uncertain parameters in the second-stage problem or one or more decision variables of the first-stage decision, wherein a parameter space is large or continuous, for a more efficient computation of the one or more optimality conditions for different values of the parameter, a more efficient computation of a recourse problem for different values of the parameter, or a more efficient computation of the one or more cutting planes and the first-stage decision in each iteration, to significantly reduce a computational burden for calculating larger and more complex instances of the first-stage decision.

In some non-limiting embodiments or aspects, RO system 106 obtains, for each scenario, a plurality of feasible decisions based on the second-stage problem that depends on the one or more variables of the first-stage decision and one or more values of the uncertain parameters for each scenario, respectively, based on a solution to a second-stage problem.

In some non-limiting embodiments or aspects, RO system 106 combines the feasible region of the first-stage decision with a feasible region representing a plurality of feasible decisions in the second-stage problem for each new scenario, to obtain an updated feasible region representing linear constraints associated with the first-stage decision, wherein after each iteration of the second-stage problem the first-stage decision and the second-stage problem converge toward a respective optimal solution, such that the feasible region is decreased based on one or more additional linear constraints which narrow the feasible decisions of the second-stage problem thereby affecting an objective function of the first-stage decision by changing the solution during optimization of the first-stage decision.

In some non-limiting embodiments or aspects, the one or more cutting planes are parametric C&CG cuts added to the first-stage decision to ensure that an optimal solution is feasible in each scenario, wherein each of the one or more cutting planes corresponds to a scenario and represents a linear constraint dependent on at least one parameter of the scenario, the feasible region of the first-stage decision is adjusted to include a new space added by the one or more cutting planes, wherein adding a parametric C&CG to the first-stage decision changes the optimal solution to the first-stage decision when the one or more cutting planes represent a new linear constraint that the first-stage decision must satisfy in order to be feasible for a given scenario.

In some non-limiting embodiments or aspects, a parametric C&CG cut is binding to form an active constraint at the optimal solution and changes an optimal first-stage decision to satisfy a constraint.

In some non-limiting embodiments or aspects, a parametric C&CG cut is said to be binding if an optimal solution of the first-stage decision satisfies the binding cut and an associated scenario, and a feasible region of the first-stage decision influences an optimal selection of decision variables.

In some non-limiting embodiments or aspects, scenario generator 104 modifies a plurality of columns and a plurality of constraints to incorporate a dependence structure associated with the uncertain parameters. Additionally, scenario generator 104 solves a replicate of a recourse problem iteratively for each identified critical scenario. In such an example, a critical scenario may include one or more scenarios for which the first-stage decision changes due to a dependence of the uncertain parameters on the first-stage decision.

In some non-limiting embodiments or aspects, repeating until closing the lower and upper bounds includes evaluating a robustness of a solution. For example, evaluating a robustness of a solution based on performance characteristics, which may be observed scenarios and comparing them to the expected performance. For example, scenario generator 104 evaluates the performance of the decisions made in both stages by comparing the actual costs or profits to the costs or profits. Scenario generator 104 also evaluates the robustness of the decisions by analyzing the performance over all observed scenarios and comparing it to the expected performance.

In each iteration of the algorithm, the upper bound on the optimal objective function value is computed based on the current first-stage decision until the lower and upper bounds converge (e.g., the gap between the lower and upper bounds is reduced, small enough, satisfies a threshold associated with optimization of the objective function, etc.).

In some non-limiting embodiments or aspects, scenario generator 104 parameterizes one or more decisions in the second-stage problem based on a finite set of parameters to construct a solution for any value of a plurality of parameters. For example, one or more decisions in the second-stage problem can be parameterized based on a finite set of parameters to express a decision variable as a function of a set of parameters that may express any value within a certain range or domain. Thus, scenario generator 104 parameterizes a decision by expressing the production quantity as a function of a set of parameters, such as the mean and variance of the demand distribution and constructs a production plan that is feasible and optimal for any combination of demand mean and variance and may provide a robust solution that is valid for any value of the uncertain parameters to ensure a solution is both feasible and optimal under uncertainty.

In some non-limiting embodiments or aspects, scenario generator 104 identifies trade-offs involved in decision-making by adjusting the solution to a specific structure of the first-stage decision. In some examples, scenario generator 104 identifies trade-offs by providing available data for the specific structure of the first-stage decision.

In some non-limiting embodiments or aspects, the one or more feasible solutions for the first-stage decision satisfies one or more constraints within a range of the feedback received. In such an example, scenario generator 104 determining a set of possible actions for a decision. In some non-limiting embodiments or aspects, scenario generator 104 determines an optimal action to perform based on a decision-dependent uncertainty and feedback received. In such an example, a feasible region comprises all possible solutions that satisfy the one or more constraints of the first-stage decision.

In some examples, scenario generator 104 identifies the feasible region. In such an example, in response to determining the feasible region is empty, scenario generator 104 determines an optimization problem is infeasible, such that no feasible solution exists to satisfy the one or more constraints. In this case, further optimization may be performed to further optimize the first-stage solution.

In some non-limiting embodiments or aspects, determining a solution to the first-stage decision for a specified tolerance level of optimality, includes generating one or more cutting planes from a sub-problem solution in the second-stage problem for determining one or more optimal values. In this example, based on the cutting planes, scenario generator 104 adjusts the feasible region of the first-stage decision by dynamically adding one or more cutting planes to one or more linear constraints associated with the first-stage decision in a previous iteration. In addition, in response to determining an infeasible solution in the first-stage decision, scenario generator 104 adds cutting planes to the master problem until a feasible solution is obtained, such that the solution to the first-stage decision is further defined by the plurality of cutting planes determined during each next iteration (e.g., each subsequent iteration, etc.).

In some non-limiting embodiments or aspects, scenario generator 104 may generate one or more optimality conditions in a parametric way to express the one or more optimality conditions as a function of a parameter, such as the uncertain parameters in the second-stage problem or one or more decision variables of the first-stage decision. In this example, where a parameter space is large or continuous, for a more efficient computation of the one or more optimality conditions for different values of the parameter, a more efficient computation of a recourse problem for different values of the parameter, or a more efficient computation of the one or more cutting planes and the first-stage decision in each iteration, may significantly reduce a computational burden for calculating larger and more complex instances of the first-stage decision.

In some non-limiting embodiments or aspects, RO system 106 generates columns and constraints. For example, for two-stage RO with DDU, columns and constraints are components of the optimization problem formulation. For example, the columns refer to decision variables, such as, for representing the choices or decisions available to the decision-maker. For two-stage RO problems, columns may represent decisions made in both the first and second stages of the optimization.

In some non-limiting embodiments or aspects, the constraints refer to the restrictions or limitations imposed on the decision variables. As an example, the constraints define (e.g., represent, determine, etc.) a feasible region of the optimization problem.

In some non-limiting embodiments or aspects, since two-stage RO problems involve decision-making over two stages, decisions made in the first stage affect decisions made in the second stage. In such an example, problems are formulated to be robust against uncertainties by considering multiple scenarios of uncertain parameters.

In some examples, the uncertainty in the optimization problem is captured by considering multiple scenarios, each scenario representing a possible realization of uncertain parameters. Each of the scenarios may represent different states of the world, potential future outcomes, or variations in input data.

In some non-limiting embodiments or aspects, RO system 106 (or scenario generator 104) may generate columns and constraints. For example, RO system 106 systematically generates decision variables (i.e., columns) and constraints based on a given set of scenarios. In some examples, RO system 106 generates decision variables and constraints that are constructed to capture a decision-making process over two-stages of the optimization problem while accounting for uncertainty.

In some non-limiting embodiments or aspects, scenario generator 104 generates columns and constraints for solving two-stage RO problems based on a plurality of scenarios. For example, each scenario of the plurality of scenarios generated is separated at runtime during an iteration of the optimization process.

In some non-limiting embodiments or aspects, scenario generator 104 generates or adds a new column at runtime by iteratively adding a new column for each second-stage scenario. In addition, scenario generator 104 generates and adds a new constraint. In some examples, each new constraint is added to the original linear program to further optimize the solution. Additionally, a candidate solution is determined based on a first-stage decision (e.g., master problem, first-stage problem, etc.). By solving a plurality of sub-problems (one for each scenario), the worst-case cost for that scenario is determined, and if the candidate solution violates any of the sub-problems, new columns and constraints are added to the master problem to improve the solution.

As shown in FIG. 7, at step 716, process 700 may include outputting the optimal solution and objective value. For example, in some non-limiting embodiments or aspects, scenario generator 104 outputs the optimal solution and objective value.

In some non-limiting embodiments or aspects, scenario generator 104 may generate a feasible region based on a feedback loop configured between the first-stage decision and one or more uncertain parameters that define a space of possible decisions.

In some non-limiting embodiments or aspects, scenario generator 104 generates a plurality of linear constraints for the first-stage decision in a recourse function based on both a plurality of uncertain parameters and a plurality of variables of the first-stage decision, wherein a dependence of the recourse function (e.g., second-stage problem, etc.) on the uncertain parameters is separated from a dependence on the plurality of variables of the first-stage decision.

In some non-limiting embodiments or aspects, scenario generator 104 optimizes a solution to the first-stage decision that minimizes a worst-case cost over all possible realizations of the uncertain parameters in the second-stage problem. In such an example, the dependence of the second-stage function (e.g., recourse function, etc.) on the uncertain parameters is separated from the dependence on the first-stage decision variables to ensure that the robustness of the solution is not compromised by the uncertainty in the uncertain parameters. The linear constraints generated by the DDU approach help to ensure that the first-stage decision is made in a way that is robust to the uncertain parameters, while also taking into account the available information.

In some non-limiting embodiments or aspects, RO system 106 or scenario generator 104 outputs the optimal solution and objective value.

In some non-limiting embodiments or aspects, scenario generator 104 or RO system 106 outputs the optimal solution after determining which decisions are feasible or possible and which are not feasible or possible. For example, given one or more constraints, scenario generator 104 outputs the optimal solution and/or determines an optimal decision that minimizes a cost and satisfies the one or more constraints of the first-stage decision. In such an example, knowledge of the feasible region identifies an infeasibility or degeneracy to be addressed in order to obtain a feasible solution.

In some non-limiting embodiments or aspects, scenario generator 104 outputs the optimal solution by obtaining, for each scenario, a plurality of feasible decisions based on the second-stage problem that depends on the one or more variables of the first-stage decision and the one or more values of the uncertain parameters for each scenario, respectively, based on a solution to a second-stage problem. Additionally, the feasible region of the first-stage decision is combined with a feasible region representing a plurality of feasible decisions in the second-stage problem for each new scenario, to obtain an updated feasible region representing linear constraints associated with the first-stage decision, wherein after each iteration of the second-stage problem the first-stage decision and the second-stage problem converge toward a respective optimal solution, such that the feasible region is decreased based on one or more additional linear constraints which narrow the feasible decisions of the second-stage problem thereby affecting an objective function of the first-stage decision by changing the solution during optimization of the first-stage decision.

The results of the analysis are reported to the decision-makers in a format that is easy to understand and act upon. This can include visualizations of the energy system, reports on the performance of the decisions, and recommendations for future investments and operations.

Implement the solution: Implement the recommended solution and monitor its performance based on the performance of the decisions, and recommendations for future investment, energy, operation, and/or the like when for decision making.

Referring now to FIG. 8, shown is a diagram of example components of device 800 according to non-limiting embodiments. Device 800 may correspond to system 100. System 100 includes data source 102a-102n, scenario generator 104, RO system 106, MILP program solver 108, simulation model 110, ML engine 112, data optimizer 114, and communication network 116 of FIG. 1, as an example. In some non-limiting embodiments, such systems or devices may include at least one device 800 and/or at least one component of device 800. The number and arrangement of components shown are provided as an example. In some non-limiting embodiments, device 800 may include additional components, fewer components, different components, or differently arranged components than those shown in FIG. 1. Additionally, or alternatively, a set of components (e.g., one or more components) of device 800 may perform one or more functions described as being performed by another set of components of device 800.

As shown in FIG. 8, device 800 may include bus 802, processor 804, memory 806, storage component 808, input component 810, output component 812, and communication interface 814. Bus 802 may include a component that permits communication among the components of device 800. In some non-limiting embodiments, processor 804 may be implemented in hardware, firmware, or a combination of hardware and software. For example, processor 804 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 806 may include random access memory (RAM), read only memory (ROM), and/or another type of dynamic or static storage device (e.g., flash memory, magnetic memory, optical memory, etc.) that stores information and/or instructions for use by processor 804.

With continued reference to FIG. 8, storage component 808 may store information and/or software related to the operation and use of device 800. For example, storage component 808 may include a hard disk (e.g., a magnetic disk, an optical disk, a magneto-optic disk, a solid state disk, etc.) and/or another type of computer-readable medium. Input component 810 may include a component that permits device 800 to receive information, such as via user input (e.g., a touch screen display, a keyboard, a keypad, a mouse, a button, a switch, a microphone, etc.). Additionally, or alternatively, input component 810 may include a sensor for sensing information (e.g., a global positioning system (GPS) component, an accelerometer, a gyroscope, an actuator, etc.). Output component 812 may include a component that provides output information from device 800 (e.g., a display, a speaker, one or more light-emitting diodes (LEDs), etc.). Communication interface 814 may include a transceiver-like component (e.g., a transceiver, a separate receiver and transmitter, etc.) that enables device 800 to communicate with other devices, such as via a wired connection, a wireless connection, or a combination of wired and wireless connections. Communication interface 814 may permit device 800 to receive information from another device and/or provide information to another device. For example, communication interface 814 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 800 may perform one or more processes described herein. Device 800 may perform these processes based on processor 804 executing software instructions stored by a computer-readable medium, such as memory 806 and/or storage component 808. A computer-readable medium may include any non-transitory memory device. A memory device includes memory space located inside of a single physical storage device or memory space spread across multiple physical storage devices. Software instructions may be read into memory 806 and/or storage component 808 from another computer-readable medium or from another device via communication interface 814. When executed, software instructions stored in memory 806 and/or storage component 808 may cause processor 804 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

The invention claimed is:

1. A computer-implemented method for two-stage robust optimization (“RO”) with decision dependent uncertainty (“DDU”) decision-making, comprising:
generating a first-stage decision before determining one or more uncertain parameters of the first-stage decision;
adjusting a second-stage problem according to the one or more uncertain parameters, wherein the one or more uncertain parameters may be combined to represent a plurality of outcomes modeled as one or more possible scenarios in the second-stage problem, and the first-stage decision is optimized based on the one or more possible scenarios in the second-stage problem;
generating a feasible region in the first-stage decision based on at least one possible scenario of the one or more possible scenarios in the second-stage problem, the feasible region forming a boundary for the first-stage decision; and
providing a cutting set to narrow the feasible region of the first-stage decision to obtain an optimal solution that performs under a worst-case scenario.

2. The computer-implemented method of claim 1, wherein a two-stage RO formulation is represented by a set of mixed integer linear programs (“MILP”), and further comprises:
determining the one or more uncertain parameters associated with the first-stage decision by solving a deterministic MILP;
determining a plurality of second-stage parameters by solving a set of MILPs, each MILP of the set of MILPs corresponding to at least one of the one or more possible scenarios in the second-stage problem, wherein an objective function of the two-stage RO formulation comprises a cost of the first-stage decision and a cost of a worst-case scenario from the second-stage problem; and
optimizing a solution to the second-stage problem with decision-dependent uncertainty that minimizes a worst-case cost over all possible realizations of the uncertain parameters.

3. The computer-implemented method of claim 2, comprising:
generating one or more columns and one or more constraints for solving two-stage RO problems based on the one or more possible scenarios, each scenario of the one or more possible scenarios generated separately at runtime during optimization, comprising:
combining the one or more columns at runtime by iteratively adding a plurality of new columns corresponding to a new scenario of the one or more possible scenarios of the second-stage problem;
generating one or more new constraints for adding to the first-stage decision to further optimize;
determining a candidate solution based on the new scenario by solving the second-stage problem to determine the candidate solution for the worst-case cost of the new scenario of the second-stage problem;
determining the candidate solution violates at least one of the one or more possible scenarios; and
in response to determining the candidate solution violates at least one of the one or more possible scenarios,
generating new columns and constraints in the first-stage decision to improve the candidate solution.

4. The computer-implemented method of claim 3, comprising:
wherein generating the new columns and constraints may be computationally infeasible to precompute for the one or more possible scenarios, such that a solution is optimized to eliminate or reduce a use of computational resources,
wherein the second-stage problem is associated with a scenario of the one or more possible scenarios.

5. The computer-implemented method of claim 4, comprising:
solving the two-stage RO formulation based on the column and constraint for a specific problem being addressed, a number of scenarios, or an amount of available computational resources.

6. The computer-implemented method of claim 5, wherein the solution for the second-stage problem is associated with at least one of: a supply chain management system, a transportation planning system, or an energy system,
wherein the solution to a second-stage RO problem includes a set of constraints which depend on one or more uncertainty parameters of the first-stage decision, and
wherein the solution for a second-stage problem comprises a plurality of feasible regions associated with the second-stage problem that depend on a plurality of parameters associated with the first-stage decision and one or more values of the uncertain parameters, wherein combining the feasible region representing the first-stage decision with one or more feasible regions associated with the one or more possible scenarios in the second-stage problem generates a plurality of linear constraints, non-linear constraints, and an iteration that may be added to the feasible region to adjust the solution to the first-stage decision.

7. The computer-implemented method of claim 1, comprising:
estimating an expected value and a variability of a plurality of uncertain parameters for one or more different scenarios of the first-stage decision; and
optimizing a solution to the first-stage decision that minimizes a worst-case cost over each of the possible realizations of the uncertain parameters in the second-stage problem.

8. The computer-implemented method of claim 1, wherein characterizing the feasible region, further comprises:
determining which decisions are feasible or possible and which are not feasible or not possible, given one or more constraints for determining an optimal decision that minimizes a cost and satisfies the one or more constraints of the first-stage decision, wherein determining the feasible region identifies an infeasibility to be addressed in order to obtain a feasible solution.

9. The computer-implemented method of claim 8, wherein one or more feasible solutions for the first-stage decision satisfies the one or more constraints within a range based on feedback received, and further comprises:
determining a set of possible actions; and
determining an optimal action of the set of possible actions to perform based on a decision-dependent uncertainty and the feedback received.

10. The computer-implemented method of claim 9, wherein the feasible region comprises all possible solutions that satisfy the one or more constraints of the first-stage decision.

11. The computer-implemented method of claim 9, comprising:
identifying the feasible region; and
in response to determining the feasible region is empty,
determining an optimization problem is infeasible when no feasible solution exists to satisfy the one or more constraints.

12. The computer-implemented method of claim 1, comprising:
modifying a plurality of columns and a plurality of constraints to incorporate a dependence structure associated with the uncertain parameters; and
determining a recourse problem iteratively for each critical scenario, wherein a critical scenario includes one or more scenarios for which the first-stage decision changes due to a dependence of the uncertain parameters on the first-stage decision.

13. The computer-implemented method of claim 12, comprising:
parameterizing one or more scenarios in the second-stage problem based on a finite set of parameters to construct a solution for each value of a plurality of parameters; and
identifying trade-offs involved in decision-making by adjusting the solution to a specific structure of the first-stage decision; and
providing available data for the specific structure of the first-stage decision.

14. The computer-implemented method of claim 1, wherein a solution to the first-stage decision is configured to determine a particular tolerance level of an optimal solution, comprises:
adding cutting planes to one or more linear constraints associated with the first-stage decision until a feasible solution is obtained, such that the solution to the first-stage decision is further defined by the plurality of cutting planes determined during an iteration of the second-stage problem, wherein the one or more cutting planes are parametric column-and-constraint generation (“C&CG”) cuts added to the first-stage decision.

15. The computer-implemented method of claim 14, wherein a parameter space is continuous.

16. The computer-implemented method of claim 15, wherein after the iteration of the second-stage problem, the first-stage decision and the second-stage problem converge toward a respective optimal solution.

17. A system, comprising:
at least one processor configured to:
generate a first-stage decision before determining one or more uncertain parameters of the first-stage decision;
adjust a second-stage problem according to the one or more uncertain parameters, wherein the one or more uncertain parameters may be combined to represent a plurality of outcomes modeled as one or more possible scenarios in the second-stage problem, and the first-stage decision is optimized based on the one or more possible scenarios in the second-stage problem;
generate a feasible region in the first-stage decision based on at least one possible scenario of the one or more possible scenarios in the second-stage problem, the feasible region forming a boundary for the first-stage decision; and
provide a cutting set to narrow the feasible region of the first-stage decision to obtain an optimal solution that performs under a worst case scenario.

18. The system of 17, wherein the at least one processor is further configured to:
determine the one or more uncertain parameters associated with the first-stage decision by solving a deterministic mixed integer linear program (“MILP”);
determine a plurality of second-stage parameters by solving a set of MILPs, each MILP of the set of MILPs corresponding to at least one of the one or more possible scenarios in the second-stage problem, wherein an objective function of the two-stage RO formulation comprises a cost of the first-stage decision and a value of the uncertain parameters of a worst-case scenario; and
optimize a solution to the second-stage problem with decision-dependent uncertainty that minimizes a worst-case cost over all possible realizations of the uncertain parameters.

19. The system of claim 18, wherein the at least one processor is further configured to:
generate one or more columns and one or more constraints for solving two-stage RO problems based on the one or more possible scenarios, each scenario of the one or more possible scenarios generated separately at runtime during optimization, comprising:
combine the one or more columns at runtime by iteratively adding a plurality of new columns corresponding to a new scenario of the one or more possible scenarios of the second-stage problem;
generate one or more new constraints for adding to the first-stage decision to further optimize;
determine a candidate solution based on the new scenario by solving the second-stage problem to determine the candidate solution for the worst-case cost of the new scenario of the second-stage problem;
determine the candidate solution violates at least one of the one or more possible scenarios; and
in response to determining the candidate solution violates at least one of the one or more possible scenarios,
the at least one processor is further configured to generate new columns and constraints in the first-stage decision to improve candidate solution.

20. A computer program product comprising at least one non-transitory computer-readable medium including one or more instructions that, when executed by at least one processor, cause at least one processor to:
generate a first-stage decision before determining one or more uncertain parameters of the first-stage decision;
adjust a second-stage problem according to the one or more uncertain parameters, wherein the one or more uncertain parameters may be combined to represent a plurality of outcomes modeled as one or more possible scenarios in the second-stage problem, and the first-stage decision is optimized based on the one or more possible scenarios in the second-stage problem;
generate a feasible region in the first-stage decision based on at least one possible scenario of the one or more possible scenarios in the second-stage problem, the feasible region forming a boundary for the first-stage decision; and
provide a cutting set to narrow the feasible region of the first-stage decision to obtain an optimal solution that performs under a worst case scenario.
